(19) United States
(12) Patent Application Publication
(10) Pub. No.: US 2026/0357159 A1
(43) Pub. Date: Nov. 12, 2026

(54) Detergents and Cleaning Compositions with Stabilized Enzyme

(71) Applicant: Symrise AG, Holzminden (DE)

(72) Inventors: Tony BARTOLINI, Herblay-sur-Seine (FR); Anne-Laure AZAIS, Poissy (FR)

(21) Appl. No.: 19/124,272

(22) PCT Filed: Oct. 25, 2023
(86) PCT No.: PCT/EP2023/079714

§ 371 Date: Apr. 24, 2025

(30) Foreign Application Priority Data
Oct. 25, 2022 (WO) PCT/EP2022/079758

(51) Int. Cl. C11D 3/386; C11D 1/14; C11D 1/22; C11D 1/62; C11D 1/66; C11D 1/72; C11D 1/90; C11D 1/94; C11D 3/20; C11D 3/33; C11D 3/36

(52) U.S. Cl. CPC C11D 3/38663; C11D 1/94; C11D 3/2044; C11D 3/2068; C11D 3/2072; C11D 3/33; C11D 3/361; C11D 3/38618; C11D 3/38627; C11D 3/38636; C11D 3/38645; C11D 1/143; C11D 1/146; C11D 1/22; C11D 1/62; C11D 1/662; C11D 1/72; C11D 1/90

(57) ABSTRACT

The present invention relates to enzymatic detergents and cleaning compositions comprising specific enzyme stabilizing agents and having improved enzyme stability. More specifically, the present invention relates to detergents and cleaning compositions that comprise an enzyme and an effective amount of a specific type of a enzyme stabilizing agent, such as alkanediols having a carbon chain of 5 to 14 carbon atoms, glyceryl caprylate, 4-hydroxyacetophenone, ethyl hexyl glycerin, tropolone, or a mixture of said enzyme stabilizing agents, and a surfactant, and the use of said detergents and cleaning compositions for the preparation of a detergent and cleaning product for household, institutional and industrial application. Additionally, the present invention relates to the use of specific enzyme stabilizing substances as defined herein for stabilizing an enzyme in a detergent and cleaning composition. Moreover, the present invention relates to a method of stabilizing an enzyme in a detergent and cleaning composition by adding an effective amount of a specific type of enzyme stabilizing agent, such as alkanediols having a carbon chain of 5 to 14 carbon atoms, glyceryl caprylate, 4-hydroxyacetophenone, ethyl hexyl glycerin, tropolone, or a mixture of said enzyme stabilizing agents, to said detergent and cleaning composition. Finally, the present invention relates to an enzyme composition comprising a specific type of enzyme stabilizing agent.

### TECHNICAL FIELD

The present invention refers generally to the field of detergents and cleaning compositions. In particular, it relates to enzymatic detergents and cleaning compositions comprising specific hydroxyl compounds and having improved enzyme stability.

More specifically, the present invention relates to detergents and cleaning compositions that comprise an enzyme and an effective amount of 1,2-heptanediol and/or 2,3-heptanediol or a specific type of enzyme stabilizing agents, such as alkanediols having a carbon chain of 5 to 14 carbon atoms, glyceryl caprylate, 4-hydroxyacetophenone, ethyl hexyl glycerin, tropolone, or a mixture of said enzyme stabilizing agents, and a surfactant, and the use of said detergents and cleaning compositions for the preparation of a detergent and cleaning product for household, institutional and industrial application. Additionally, the present invention relates to the use of specific enzyme stabilizing substances as defined herein for stabilizing an enzyme in a detergent and cleaning composition. Finally, the present invention relates to a method of stabilizing an enzyme in a detergent and cleaning composition by adding an effective amount of a specific enzyme stabilizing agent, such as alkanediols having a carbon chain of 5 to 14 carbon atoms, glyceryl caprylate, 4-hydroxyacetophenone, ethyl hexyl glycerin, tropolone, or a mixture of said enzyme stabilizing agents, to said detergent and cleaning composition.

### BACKGROUND ART

Detergents and cleaning compositions, in particular cleaning compositions for laundry and textile cleaning, dishwashing and the like are composed predominantly of surfactants or a mixture of surfactants, whose main task is to remove water-insoluble substances like dirt and grease from surfaces such as fabric, clothes, dishes, wares, etc., and hard surfaces such as metals, plastics, glass, ceramics, etc. Other than surfactant, modern detergent and cleaning formulations consist of builders, chelating agents, co-builders, other polymer additives used for specific washing or cleaning effects such as soil release and anti-redeposition, dye transfer inhibition and rheology modification, and enzyme stabilizers. In addition to said ingredients, one or more enzymes as a further active substance with cleaning action are added to the detergents and cleaning compositions.

Enzymes have been employed in detergents and cleaning compositions since early 20^{th} century. Enzymes can be used to increase the performance of washing or cleaning agents. Enzymes are known as effective chemicals for use with detergents and other cleaning agents to break down soils. Enzymes break down soils, make them more soluble, and enable surfactants to remove them from a surface to provide enhanced cleaning of a substrate. Specifically, enzymes can provide desirable activity for removal of, for example, protein-based, carbohydrate-based, or triglyceride-based stains from substrates. As a result, enzymes have been used for various cleaning applications in order to digest or degrade soils such as grease, oils (e.g. vegetable oils or animal fat), protein, carbohydrate, or the like. For example, enzymes may be added as a component of a composition for fabric care, cleaning textile, ware washing, cleaning-in-place, cleaning drains, cleaning floor, cleaning carpet, cleaning medical or dental instrument, cleaning meat cutting tool, cleaning hard surface, for personal care, or the like.

However, the use of enzymes in such detergents and cleaning compositions has proven difficult due to stability problems.

A protein and/or enzyme can be damaged during storage, for example, by inactivation, denaturation or disintegration, for example by physical influences, oxidation or proteolytic cleavage.

The stability problems suffered are exacerbated over time and with storage or transport conditions above standard ambient temperature (25 °C), in particular temperatures above 35 °C.

Most of the enzymes used are susceptible against ingredients contained in the detergent and cleaning composition resulting in a loss of enzyme performance. Enzymes tend to be affected by surfactants and bleachers in the formulation. In addition, proteases also hydrolyse themselves (autoproteolysis) and all other proteins, particularly enzymes. This takes place especially during the cleaning process, i.e. in the hydrous washing liquor, when comparatively favourable reaction conditions are present. This also takes place during the storage of said composition, for which reason extended storage times also entail a certain loss of protease activity and the activities of the other enzyme. This is especially problematic in gel-like or liquid and hydrous recipes, because they prove the reaction medium and hydrolysis reagent with the water.

In the past, numerous methods for improving stabilization of enzymes for storage have been employed. For example, borate-based stabilization systems have been used in attempt to address the stability of enzyme formulations.

However, the use of said stabilization systems has some drawbacks. First, borate-including compositions are under scrutiny and regulations have been proposed limiting their incorporation and they may be excluded entirely. Second, the borate-based compositions did not provide the desired level of stability. Boric acid derivatives, independently of their stabilizing effect, have crucial disadvantage: many of these, such as borate, form undesired by-products with other washing and/or cleaning agent ingredients, so that they are no longer available in the relevant agents for the desired purpose or are even left behind as an impurity on the item to be cleaned.

Other attempts to stabilize enzymes in detergents and cleaning compositions has included the use of ingredients such as amine oxides and/or alkyl polyglucosides, that have undesirous effects. These ingredients are problematic since they are foaming. In many cleaning contexts, including in particular, medical and dental instrument cleaning, there is a need for the detergents and cleaning compositions to minimize foam, so that the surface being cleaned remains visible.

The loss of enzyme performance in a detergent and cleaning composition results in a loss of cleaning performance.

The detergent and cleaning industry is permanently searching for ingredients which can resolve these negative aspects.

Thus, there is still an ongoing need for substances with the ability for improving enzyme stability in detergents and cleaning compositions.

Accordingly, it is therefore an object of the present invention to provide multi-use enzyme containing detergents and cleaning compositions with a superior enzyme stability within the detergents and cleaning compositions, and, thus, with an improved cleaning performance.

Furthermore, it is an object of the present invention to provide enzyme containing detergents and cleaning compositions that provide better enzyme stabilization compared to detergents and cleaning compositions comprising a usual enzyme stabilizer.

It is another object of the present invention to provide substances, which are capable of stabilizing an enzyme or an enzyme mixture in detergents and cleaning compositions.

Finally, it is another object of the present invention, to provide a method of stabilizing an enzyme in detergents and cleaning compositions.

Finally, it is a further object of the present invention to provide for an enzyme composition comprising an enzyme and an enzyme stabilizing agent.

Surprisingly, it has been found that the addition of an effective amount of a specific type of an enzyme stabilizing agent, such as alkanediols having a carbon chain of 5 to 14 carbon atoms, glyceryl caprylate, 4-hydroxyacetophenone, ethyl hexyl glycerin, tropolone, or a mixture of said enzyme stabilizing agents, as defined herein, to a detergent and cleaning composition comprising an enzyme or a mixture of enzymes, has a positive influence on the enzymatic performance in that they significantly retard the rate of enzyme deactivation by efficiently stabilizing the enzyme or the enzyme mixture. The enzyme(s) in these detergents and cleaning compositions show(s) a superior stability during storage, thus keeping performance overtime. More specifically, the enzymatic detergents and cleaning compositions demonstrate stability after storage for at least 2 weeks and at temperatures over standard ambient temperature (25 °C), in particular temperatures above 35 °C.

Additionally, based on the improved enzymes' stability, the enzymes can function longer and therefore provide more cleaning efficacy through effective removing soil and/or stain.

Conversely, also because of the superior stability of the enzyme, the amount of enzyme and other ingredients, such as enzyme stabilizers, for increasing the enzyme's effectiveness in these detergents and cleaning compositions can be reduced to achieve a similar cleaning effect, i.e. without loss of cleaning performance.

### SUMMARY OF THE INVENTION

The present invention was made in view of the disadvantages described above. To solve the above-mentioned drawbacks, the present invention provides an enzyme containing detergent and cleaning composition having improved enzyme stability.

In order to accomplish the above problem, the present invention provides in a first aspect for a detergent and cleaning composition, comprising or consisting of:
(a) at least one enzyme or an enzyme formulation, comprising at least one enzyme;
(b) at least one enzyme stabilizing agent selected from the group consisting of
   (b^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol;
   (b^{II}) glyceryl caprylate;
   (b^{III}) 4-hydroxyacetophenone;
   (b^{IV}) ethyl hexyl glycerin;
   (b^{V}) tropolone; and
   any mixture thereof;
(c) more than 3% by weight of a surfactant, based on the total weight of the composition; and
(d) at least one further enzyme stabilizer which is different from the enzyme stabilizing agent (b).

In particular, the present invention relates to a detergent and cleaning composition, comprising or consisting of:
(a) at least one enzyme or an enzyme formulation, comprising at least one enzyme;
(b) at least one enzyme stabilizing agent selected from the group consisting of
(b^{I}) at least one linear alkanediol having a carbon chain of 6 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol;
(b^{II}) glyceryl caprylate;
(b^{III}) 4-hydroxyacetophenone;
(b^{IV}) ethyl hexyl glycerin;
(b^{V}) tropolone; and
any mixture thereof;
(c) more than 3% by weight of a surfactant, based on the total weight of the composition; and
(d) at least one further enzyme stabilizer which is different form the enzyme stabilizing agent (b).

In a further aspect, the present invention provides for the use of the detergent and cleaning composition as, or for the preparation of a detergent and cleaning product.

In a further aspect, the present invention provides for a detergent and cleaning product.

In a still further aspect, the present invention provides for the use of at least one enzyme stabilizing agent selected from the group consisting of:
(b^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol;
(b^{II}) glyceryl caprylate;
(b^{III}) 4-hydroxyacetophenone;
(b^{IV}) ethyl hexyl glycerin;
(b^{V}) tropolone; and
any mixture thereof;
for stabilizing an enzyme in a detergent and cleaning composition.

In another aspect, the present invention provides for a method of stabilizing an enzyme in a detergent and cleaning composition, comprising the steps of
(i) providing a detergent and cleaning composition comprising an enzyme; and
(ii) adding thereto an effective amount of at least one enzyme stabilizing agent selected from the group consisting of:
   (b^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol;
   (b^{II}) glyceryl caprylate;
   (b^{III}) 4-hydroxyacetophenone;
   (b^{IV}) ethyl hexyl glycerin;
   (b^{V}) tropolone; and
   any mixture thereof.

In a final aspect, the present invention provides for an enzyme composition, comprising or consisting of
(A) at least one enzyme;
(B) at least one enzyme stabilizing agent selected from the group consisting of
   (B^{I}) a mixture comprising at least one first linear alkanediol having a carbon chain of 5 to 14 carbon atoms and one or more second linear alkanediol having a carbon chain of 5 to 14 carbon atoms which is different from the first linear alkanediol;
   (B^{II}) glyceryl caprylate;
   (B^{III}) 4-hydroxyacetophenone;
   (B^{IV}) ethyl hexyl glycerin;
   (B^{V}) tropolone; and
   any mixture thereof; and
(C) at least one further enzyme stabilizer which is different from the enzyme stabilizing agent (B).

The present invention is specified in the appended claims. The invention itself, and its preferred variants, other objects and advantages, are however also apparent from the following detailed description in conjunction with the accompanying examples and figures.

All percentages are by weight unless otherwise indicated.

Numeric ranges recited within the specification and given in the form “x to y” include the values defining the range and include each integer within the defined range. When multiple preferred numeric ranges are specified in this format, all ranges created by combining the various endpoints are also included.

In the context of the present invention, the term “comprising” means that the named components are essential, but other components may be added and is still embraced by the present invention.

The term “consisting of” as used according to the present invention means that the total amount of components (a) to (d) in a composition adds up to 100% by weight, based on the total weight of the composition, and signifies that the subject matter is closed-ended and can only include the limitations that are expressly recited.

Whenever reference is made to “comprising” it is intended to cover both meanings as alternatives, that is the meaning can be either “comprising” or “consisting of”, unless the context dictates otherwise.

In the context of the present invention, the term “at least one . . . ” means that the detergent and cleaning composition according to the present invention can comprise either one or a mixture of two, three, four, five, six or even more different of the respective components following said term.

The term “and/or” expresses that a linkage exists, or an alternative is provided.

The term “optionally” means that the subsequently described component may but need not to be present in the detergent and cleaning composition, and that the description includes variants, where the compound is included or variants, where the compound is absent.

The term “stability” in the context of the present invention means resistance or the degree of resistance to change, unfolding, disintegration, denaturation or activity loss. Non-limiting examples of stability include storage stability and reflects the stability of a polypeptide, such as an enzyme, as a function of time, e.g. how much performance is retained when said polypeptide is kept in a detergent or cleaning formulation. The stability is influenced by many factors, such as presence of chelators, pH, temperature, detergent composition, e.g. amount of builders, surfactants, etc.

The term “boosting” in the context of the present invention means “improving”, “enhancing”, “increasing”. Correspondingly, a “boosting agent” is either a single agent or a mixture of agents capable of “improving”, “enhancing”, “increasing” certain features or properties as defined herein, and in particular the stability of an enzyme in the detergent and cleaning composition according to the present invention. With a constant enzyme stability, a stable cleaning power of the detergent and cleaning composition can be provided.

As used herein, the term “alkyl” refers to saturated hydrocarbons having one or more carbon atoms, including straight-chain alkyl groups (such as methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, etc.), cyclic alkyl groups (or cycloalkyl or alicyclic or carbocyclic groups) (such as cyclopropyl, cyclopentyl, cyclohexyl, cycloheptyl, cyclooctyl, etc.), branched-chain alkyl groups (such as isopropyl, tert-butyl, sec-butyl, isobutyl, etc.) and alkyl substituted alkyl groups (such as cycloalkyl-substituted alkyl groups).

Unless otherwise specified, the term “alkyl” includes both unsubstituted alkyls and substituted alkyls. As used herein, the term “substituted alkyls” refers to alkyl groups having substituents, replacing one or more hydrogens on one or more carbons of the hydrocarbon backbone. Such substituents may include, for example, alkenyl, alkynyl, halogen, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialykaminocarbonyl, alkylthiocarbonyl, alkoxyl, phosphate, phosphonate, cyano, amino, imino, sulfhydryl, alkylthio, arylthiol, thiocarboxylate, sulfates, alkylsulfinyl, sulfonates, nitro, etc.

### DETAILED DESCRIPTION OF THE INVENTION

In a first aspect, the present invention relates to a detergent and cleaning composition, comprising or consisting of
(a1) at least one enzyme or an enzyme formulation, comprising at least one enzyme;
(b1) 1,2-heptanediol;
(c1) more than 3% by weight of a surfactant, based on the total weight of the composition; and
(d1) at least one further enzyme stabilizer.

Alternatively, the present invention relates in a first aspect to a detergent and cleaning composition, comprising or consisting of
(a2) at least one enzyme or an enzyme formulation, comprising at least one enzyme;
(b2) 2,3-heptanediol;
(c2) more than 3% by weight of a surfactant, based on the total weight of the composition; and
(d2) at least one further enzyme stabilizer.

In a further alternative, the present invention relates in a first aspect to a detergent and cleaning composition, comprising or consisting of
(a3) at least one enzyme or an enzyme formulation, comprising at least one enzyme;
(b3) a mixture comprising 1,2-heptanediol and 2,3-heptanediol;
(c3) more than 3% by weight of a surfactant, based on the total weight of the composition; and
(d3) at least one further enzyme stabilizer.

Alternatively, in another aspect, the present invention relates to a detergent and cleaning composition, comprising or consisting of
(a) at least one enzyme or an enzyme formulation, comprising at least one enzyme;
(b) at least one enzyme stabilizing agent selected from the group consisting of
   (b^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol;
   (b^{II}) glyceryl caprylate;
   (b^{III}) 4-hydroxyacetophenone;
   (b^{IV}) ethyl hexyl glycerin;
   (b^{V}) tropolone; and any mixture thereof;
(c) more than 3% by weight of a surfactant, based on the total weight of the composition; and
(d) at least one further enzyme stabilizer which is different from the enzyme stabilizing agent (b).

In particular, the present invention relates to a detergent and cleaning composition, comprising or consisting of
(a) at least one enzyme or an enzyme formulation, comprising at least one enzyme;
(b) at least one enzyme stabilizing agent selected from the group consisting of
   (b^{I}) at least one linear alkanediol having a carbon chain of 6 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol;
   (b^{II}) glyceryl caprylate;
   (b^{III}) 4-hydroxyacetophenone;
   (b^{IV}) ethyl hexyl glycerin;
   (b^{V}) tropolone; and
   any mixture thereof;
(b) more than 3% by weight of a surfactant, based on the total weight of the composition; and
(c) at least one further enzyme stabilizer which is different from the enzyme stabilizing agent (b).

In an even more preferred variant, the at least one linear alkanediol in the detergent and cleaning composition according to the present invention has a carbon chain length of 7 to 12 carbon atoms, more preferred a carbon chain length from 7 to 11 carbon atoms, still more preferred a carbon chain length from 7 to 10 carbon atoms, most preferred a carbon chain length from 7 to 9 carbon atoms. Most preferred the linear alkanediol in the detergent and cleaning composition has a carbon chain length of 7 or 8 carbon atoms.

The term “detergent and cleaning composition” as contemplated herein, is understood to mean all products that are suitable and commonly used for washing or cleaning. Detergents and cleaning compositions are composed predominantly of surfactants or a mixture of surfactants. Other than surfactant, the detergents and cleaning compositions normally consists of builders and chelating agents, co-builders and other polymer additives used for specific effects such as soil release, anti-redeposition, dye transfer inhibition, rheology modification. Detergents and cleaning compositions refer to compositions that find use in the removal of undesired compounds from items to be cleaned, such as textiles (such as fabrics, clothes), dishes, floors, hard surfaces (such as metals, plastics and ceramics). These deposits might be caused by soils or stains, germs and other contaminants. Detergents are the most commonly used cleaning compositions for textiles. The detergents and cleaning compositions may be used for both household cleaning, institutional cleaning and industrial cleaning. The detergents and cleaning compositions also includes disinfectants that kills all vegetative cells including recognized pathogenic microorganism. The detergents and cleaning compositions can be used by the detergent composition itself or by a detergent product or by a use solution thereof.

The detergents and cleaning compositions according to the first and second aspect of the present invention are preferably used for removing stain and/or soil from textile, fabrics, laundry, dishes, ware, medical and dental instruments, hard surfaces, etc.

Within the scope of the present invention the terms “cleaning” and “washing” are used synonymously and refer to the reduction and/or removal of deposits, i.e. the removal of undesired compounds from items to be cleaned, on tableware/dishes and other kitchen utensils such as cutlery/silverware, pots, pans, bakeware and the like.

These deposits might be formed by stains caused by tea, chocolate, coffee, grass, red wine, grass/mud, fruit juice, blood, tomato puree, unused motor oil, salad dressing balsamic, cooked beef fat, French squeezy mustard, make-up, and the like or by soils caused by grease, starch based soils such as rice, pasta, protein based soils such as egg yolk, chocolate, mayonnaise, lipstick starch based soil, and the like and other remaining on the surfaces. Deposits are thus any form of unwanted residues of impureness, of dirt, food, grease etc.

The term “substrate” in the context of the present invention includes fabrics, textiles, laundry, dishes, ware, any hard surfaces, medical and dental instruments, and the like which can be contaminated with stain and/or soil and can be treated by a washing or cleaning process.

As used herein, the term “fabric cleaning” includes detergents and cleaning compositions or products designed for cleaning stained and/or soiled material. Such compositions or products include but are not limited to, laundry detergent compositions, fabric softening compositions, fabric enhancing compositions, fabric freshening compositions, laundry prewash, laundry pre-treat, laundry additives, spray products, dry cleaning agents or compositions, laundry rinse additive, wash additive, post-rinse fabric treatment, ironing aids, unit dose formulations, delayed delivery formulations, detergent contained on or in a porous substrate or nonwoven sheet, substrate having fibres preferably said fibres including active agents, and other suitable forms that may be apparent to one skilled in the art.

As used herein, the term “fabric care” relates to various fabric benefits including smoothness, shape maintenance, resilience, colour preservation, pilling control and others.

The term “dish” or “ware” as used herein, refers to a solid surface, such as a counter top, tile, floor, wall, panel, window, plumbing fixture, kitchen and bathroom furniture, appliance, engine, circuit board, and dish. Hard surfaces may include for example, health care surfaces, such as surfaces of medical or dental instruments, medical or dental devices, electronic apparatus employed for monitoring patient health, and floors, walls or fixtures of structures in which health care occurs, and food processing surfaces, such as a surface of a took, a machine, equipment, a structure, or the like, that is employed as part of a food processing, preparation or storage activity. The term “ware” in the context of the present invention refers to items such as eating and cooking utensils, dishes, and other hard surfaces such as showers, sinks, toilets bathtubs, countertops, windows, mirrors, and floors.

The term “surface” as used herein, refers to a solid surface, such as a counter top, tile, floor, wall, panel, window, plumbing fixture, kitchen and bathroom furniture, appliance, engine, circuit board, and dish. Hard surfaces may include for example, health care surfaces, such as surfaces of medical or dental instruments, medical or dental devices, electronic apparatus employed for monitoring patient health, and floors, walls or fixtures of structures in which health care occurs, and food processing surfaces, such as a surface of a tool, a machine, equipment, a structure, or the like, that is employed as part of a food processing, preparation or storage activity.

The “enzyme stabilizing agent” (b) as used herein is a substance which stabilizes the enzyme in a detergent and cleaning composition during storage for at least 2 weeks and at temperatures above standard ambient temperature (25 °C), in particular temperatures above 35 °C. Said agent is different to the “further enzyme stabilizer” (d) commonly known in the art and which is used in addition to the enzyme stabilizing agent in order to provide a further enzyme stabilizing effect.

Surprisingly, it was found that the addition of an enzyme stabilizing agent as specified herein or a mixture of said enzyme stabilizing agents to a detergent and cleaning composition stabilize the enzyme in the detergents and cleaning composition during storage. In this way, the enzymatic performance and thus the cleaning performance of such a detergent and cleaning composition can be kept stable.

Based on this advantageous effect, the detergents and cleaning compositions according to the present invention provides for both, enzyme stability during storage for at least 2 weeks and at temperatures above standard ambient temperature (25 °C), in particular temperatures above 35 °C, and improved cleaning performance.

### Enzyme or Enzyme Formulation/Component (a1, a2, a3, a)

The enzymatic detergent and cleaning composition according to the present invention comprises at least one enzyme or an enzyme formulation, comprising at least one enzyme, as component (a1, a2, a3, a) that provide cleaning performance, by removing stain and/or soil, and/or fabric care benefits.

Enzymes are known as effective chemicals for use with detergents and other cleaning agents to break down soils. Enzymes break down soils, make them more soluble, and enable surfactants to remove them from a surface to provide enhanced cleaning of a substrate. Specifically, enzymes can provide desirable activity for removal of, for example, protein-based, carbohydrate-based, or triglyceride-based stains from substrates. In addition, enzymes also help to improve wash results at lower temperatures. As a result, enzymes have been used for various cleaning applications in order to digest or degrade soils such as grease, oils (e.g. vegetable oils or animal fat), protein, carbohydrate, or the like. For example, enzymes may be added as a component of a composition for laundry, textiles, ware washing, cleaning-in-place, cleaning drains, floors, carpets, medical or dental instruments, meat cutting tools, hard surfaces, personal care, or the like.

Enzymes suitable for the detergents and cleaning compositions can act by degrading or altering one or more types of soil residues encountered on an instrument or device thus removing the soil or making the soil more removable by a surfactant or other component of the cleaning composition. Both degradation and alteration of soil residues can improve detergency by reducing the physicochemical forces that bind the soil to the instrument or device being cleaned, e.g., the soil becomes more water soluble. For example, one or more proteases can cleave complex, macro molecular protein structures present in soil residues into simpler short chain molecules which are, of themselves, more readily desorbed from surfaces, solubilized or otherwise more easily removed by detersive solutions containing said proteases.

Detersive enzymes according to the present invention have a cleaning, destaining, desoiling, or otherwise beneficial effect as a component of a detergent and cleaning composition for instruments, devices, or equipment, such as medical or dental instruments, devices, or equipment; or for laundry, textiles, warewashing, cleaning-in-place, drains, carpets, meat cutting tools, hard surfaces, personal care, or the like.

Enzymes that can be used in the detergent and cleaning composition according to the present invention include enzymes that provide desirable activity for removal of protein-based, carbohydrate-based, or lipide-based (fat or oil-based) stains and/or soils from substrates; for cleaning, destaining, despoiling, and sanitizing presoaks, such as presoaks for medical and dental instruments, devices, and equipment; presoaks for flatware, cooking ware, and table ware; or presoaks for meat cutting equipment; for machine warewashing; for laundry and textile cleaning and destaining; for carpet cleaning and destaining; for cleaning-in-place (CIP) and destaining-in-place; for cleaning and destaining food processing surfaces and equipment; for drain cleaning; presoaks for cleaning; and the like.

Suitable enzymes used according to the first aspect and second aspect of the present invention are selected from the group consisting of proteases, amylases, lipases, cellulases, cutinases, gluconases, peroxidases, pectinases, mannanases, esterases, hemicellulases, xylanases, phospholipases, pectate lyases, keratinases, reductases, nucleases (including Dnase and/or Rnase), phenoloxidases, lipoxygenases, ligninases, pullulanases, tannases, pentosanases, malanases, ß-glucanases, arabinosidases, hyaluronidases, chondroitinases, oxidoreductases, and any mixture thereof.

More preferred, the enzyme in the detergent and cleaning compositions according to the present invention is selected from the group consisting of proteases, amylases, lipases, cellulases, mannanases, pectate lyases, and any mixture thereof.

The enzymes used according to the present invention are of any suitable origin, such as vegetable, animal, bacterial, fungal or yeast origin.

Proteases: Any protease or mixture of proteases, from any source, can be used in the detergents and cleaning compositions, provided that the selected enzyme is stable in the desired pH range (between about 6 and about 9). For example, the protease enzymes can be derived from a plant, an animal, or a microorganism such as a yeast, a mould, or a bacterium. Preferred protease enzymes include, but are not limited to, the enzymes derived from Bacillus subtilis, Bacillus licheniformis and Streptomyces griseus. Protease enzymes derived from B. subtilis are most preferred. The protease can be purified or a component of a microbial extract, and either wild type or variant (either chemical or recombinant). Exemplary proteases are commercially available under the following trade names Alcalase®, Blaze®, Savinase®, Esperase®, Progress UNO™, Liquanase® and Pristine®, each available from Novozymes; and Preferenz® P and Excellenz® P, each available from DUPONT/IFF.

Amylases: Any amylase or mixture of amylases, from any source, can be used in the detergents and cleaning compositions, provided that the selected enzyme is stable in the desired pH range (between about 6 and about 9). For example, the amylase enzymes can be derived from a plant, an animal, or a microorganism such as a yeast, a mold, or a bacterium. Preferred amylase enzymes include, but are not limited to, those derived from a Bacillus, such as B. licheniformis, B. amyloliquefaciens, B. subtilis, or B. stearothermophilus. Amylase enzymes derived from B. subtilis are most preferred. The amylase can be purified or a component of a microbial extract, and either wild type or variant (either chemical or recombinant). Preferred amylases are commercially available under the trade names Stainzyme® and Amplify®, each available from Novozymes; and Preferenz® S, available from DUPONT/IFF.

Lipases: Any lipase or mixture of lipases, from any source, can be used in the detergents and cleaning compositions, provided that the selected enzyme is stable in the desired pH range (between about 6 and about 9). For example, the lipase enzymes can be derived from a plant, an animal, or a microorganism such as a fungus or a bacterium. Preferred protease enzymes include, but are not limited to, the enzymes derived from a Pseudomonas, such as Pseudomonas stutzeri ATCC 19.154, or from a Humicola, such as Humicola lanuginosa (typically produced recombinantly in Aspergillus oryzae). The lipase can be purified or a component of a microbial extract, and either wild type or variant (either chemical or recombinant). Preferred lipases are commercially available under the trade names Lipex®, available from Novozymes; and Preferenz® L, available from DUPONT/IFF.

Cellulases: Any cellulase or mixture of cellulases, from any source, can be used in the detergents and cleaning compositions, provided that the selected enzyme is stable in the desired pH range (between about 6 and about 9). For example, the cellulase enzymes can be derived from a plant, an animal, or a microorganism such as a fungus or a bacterium. Preferred cellulase enzymes include, but are not limited to, those derived from Humicola insolens, Humicola strain DSM1800, or a cellulase 212-producing fungus belonging to the genus Aeromonas and those extracted from the hepatopancreas of a marine mollusk, Dolabella Auricula Solander. The cellulase can be purified or a component of a microbial extract, and either wild type or variant (either chemical or recombinant). Preferred cellulases are commercially available under the trade names Celluclean® and Carezyme®, each available from Novozymes; and Revitalenz®, available from DUPONT/IFF.

Preferred enzyme selections depend upon the conditions of final utility, including the physical product form, use pH, use temperature, and soil types to be degraded or altered and are influenced by factors such as pH-activity and/or stability optima, thermostability, and stability to active detergents, builders and the like. The enzyme can be chosen to provide optimum activity and stability for any given set of utility conditions. In this respect, bacterial or fungal enzymes are preferred.

Protease enzymes, amylase enzymes and lipase enzymes are the most used enzymes in detergents and cleaning compositions. The protease enzymes are particularly advantageous for cleaning soils containing protein, e.g. egg, milk, meat residue, or the like. The amylase enzymes are particularly advantageous for removing starch-based soils, such as pasta and rice. The lipase enzymes are particularly advantageous for cleaning soils including fat/grease.

As one skilled in the art shall ascertain, enzymes are designed to work with specific types of soils. For example, according to an embodiment of the invention, ware wash applications may use a protease enzyme as it is effective at the high temperatures of the ware wash machines and is effective in reducing protein-based soils. Protease enzymes are particularly advantageous for cleaning soils containing protein, such as blood, cutaneous scales, mucus, grass, food (e.g. egg, milk, spinach, meat residue, tomato sauce), or the like.

According to the invention, the enzyme composition may be varied based on the particular cleaning application and the types of soils in need of cleaning. For example, the temperature of a particular cleaning application will impact the enzymes selected for an enzyme composition according to the invention. Ware wash applications, for example, clean substrates at temperatures in excess of approximately 60 °C, or in excess of approximately 70 °C, or between approximately 65 °C to 80 °C, and enzymes such as proteases are desirable due to their ability to retain enzymatic performance at such elevated temperatures. Laundry applications, for example, clean laundry at temperatures in excess of approximately 40 °C, or in excess of approximately 50 °C, or between approximately 65 °C to 90 °C, and enzymes such as proteases are desirable due to their ability to retain enzymatic performance at such elevated temperatures.

Preferably, the at least one enzyme in the detergent and cleaning composition is selected from the group consisting of a protease, an amylase, a lipase, a gluconase, a cellulase, a peroxidase, or a mixture thereof.

In some variants, the enzyme in the detergent and cleaning composition is a protease, an amylase, a lipase, a cellulase, a gluconase, a peroxidase, a mannanase, or any mixture thereof.

Preferably the enzyme in the detergent and cleaning composition is a mixture of protease, an amylase, a lipase, a cellulase and/or pectate lyase.

Preferred detersive enzymes in the detergent and cleaning composition include a hydrolase such as a protease, an amylase, a lipase, or a combination thereof.

Preferably, the enzyme in the detergent and cleaning composition is a protease, amylase, lipase, cellulose, peroxidase, gluconase, or any mixture thereof.

In a still more preferred variant, the enzyme in the detergent and cleaning composition disclosed here is a protease, amylase, lipase, or any mixture thereof.

Still more preferred, the enzyme in the detergent and cleaning composition is a protease, an amylase, or a mixture thereof.

Still more preferred, the enzyme in the detergent and cleaning composition is a protease, a lipase, or a mixture thereof.

Still more preferred, the enzyme in the detergent and cleaning composition is selected from an amylase, a lipase, or a mixture thereof.

In some other embodiments, the enzyme in the detergent and cleaning composition is a protease.

In yet some other variant, the enzyme in the detergent and cleaning composition is an amylase.

In yet some other variant, the enzyme in the detergent and cleaning composition is a lipase.

In yet some other variant, the enzyme in the detergent and cleaning composition is a cellulase.

Preferred enzymes in detergents and cleaning compositions according to the present invention for cleaning medical or dental devices or instruments include a protease, an amylase, a cellulase, a lipase, or a combination thereof.

Preferred enzymes in detergents and cleaning compositions according to the present invention for food processing surfaces and equipment include a protease, a lipase, an amylase, a gluconase, or a combination thereof.

Preferred enzymes in detergent and compositions according to the present invention for laundry or textiles include a protease, a cellulase, a lipase, a peroxidase, or a combination thereof.

Preferred enzymes in detergent and compositions for carpets include a protease, an amylase, or a combination thereof.

Preferred enzymes in detergents and cleaning compositions according to the present invention for meat cutting tools include a protease, a lipase, or a combination thereof.

Preferred enzymes in detergents and cleaning compositions according to the present invention for hard surfaces include a protease, an amylase, a lipase, or a combination thereof.

Preferred enzymes in detergents and cleaning compositions according to the present invention for drains include a protease, an amylase, a lipase, or a combination thereof.

For a stain remover, the enzymes are preferably selected from the group consisting of protease, amylase, lipase, mannanase, pectate lyase.

For a fabric softener, the enzymes are preferably cellulases.

In order to increase the bleaching effect, oxidoreductases are optionally added to the detergent and cleaning composition according to the first and second aspect of the present invention.

The oxidoreductases are selected from the group consisting of oxidases, oxygenases, catalases, peroxidases, such as halo-, chloro-, bromo-, lignin-, glucose- or manganese-peroxidases, dioxygenases or laccases, such as phenoloxidases and polyphenoloxidases, and any mixture thereof.

Commercial enzymes are obtainable in liquid or dried form (i.e. puck, powder, etc.), are sold as raw aqueous solutions or in assorted purified, processed and compounded forms established in the prior art, and include about 0.1% to about 80% by weight active enzyme generally in combination with stabilizers, buffers, cofactors, impurities and inert vehicles. The actual active enzyme content depends upon the method of manufacture and is not critical; assuming the detergent and cleaning composition has the desired enzymatic performance.

This includes for example the solid enzyme preparations obtained by granulation, extrusion or lyophilization or, particularly in the case of liquid or gel-like agents, solutions of the enzymes, advantageously as concentrated as possible, low in water and/or with added stabilizers. Alternatively, the enzymes can be encapsulated both for the solid and for the liquid administration form, for example by spray drying or extrusion of the enzyme solution together with a preferably natural polymer, or in the form of capsules, for example those in which the enzymes are enclosed, such as in a solidified gel, or in those of the core-shell type, in which an enzyme-containing core is coated with a protective layer that is impermeable to water, air, and/or chemicals. Further active substances, for example stabilizers, emulsifiers, pigments, bleaches or dyes, can additionally be applied in superimposed layers. Such capsules are applied using methods known per se, for example by vibratory or roll granulation or in fluidized bed processes. Advantageously, such granulates are low in dust, for example as a result of the application of polymeric film formers and are storage-stable on account of the coating. Furthermore, it is possible to package two or more enzymes together so that a single granulate exhibits multiple enzyme performance.

In a variant according to the present invention, the enzyme is added to the detergent and cleaning composition as a single enzyme.

In some other variants, the enzyme added to the detergent and cleaning composition is preferably an enzyme cocktail of two, three, four or even more different enzymes. Typically, for laundry detergents an enzyme cocktail contains from two (preferably protease and amylase) to six enzymes. For dishwashing detergents a typical enzyme cocktail contains two enzymes (preferably protease and amylase).

Still more preferred, the enzyme(s) is/are added to the detergent and cleaning composition as enzyme formulation in mixture with an enzyme stabilizer, preferably in combination with one or more enzyme stabilizing agent(s) (b1, b2, b3, b) as defined herein and/or in mixture with one or more commonly used enzyme stabilizers, such as enzyme stabilizers (d1, d2, d3, d) as described below, optionally buffers, and the like.

Preferred combinations of an enzyme and a specific type of an enzyme stabilizing agent (b), such as alkanediols having a carbon chain of 5 to 14 carbon atoms, glyceryl caprylate, 4-hydroxyacetophenone, ethyl hexyl glycerin, tropolone, or a mixture of said enzyme stabilizing agents, are described in detail below.

### Enzyme Stabilizing Agent/Component (b1, b2, b3, b)

The enzymatic detergent and cleaning composition according to the present invention further includes at least one enzyme stabilizing agent as component (b1, b2, b3, b).

In a preferred variant, the enzymatic detergent and cleaning composition according to the present invention includes a mixture of enzyme stabilizing agents.

Enzyme stabilizing agents within the meaning of the present invention are (b^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol; (b^{II}) glyceryl caprylate; (b^{III}) 4-hydroxyacetophenone; (b^{IV}) ethyl hexyl glycerin; (b^{V}) tropolone; and any mixture of said enzyme stabilizing agents.

Said enzyme stabilizing agents were found to efficiently stabilize enzymes in a detergent and cleaning composition, and thus retard the rate of enzyme deactivation during storage. In this way, the cleaning performance of the detergent and cleaning composition is maintained over time.

### Alkanediols (b1, b2, b3, b^{I})

The component (b) in the enzymatic detergent and cleaning composition according to the first aspect of the present invention is either 1,2-heptanediol (b1) or 2,3-heptanediol (b2), or a mixture comprising both heptanediols, i.e. 1,2-heptanediol plus 2,3-heptanediol (b3).

1,2-Heptanediol belongs to the category of alkanediols and is a straight chain alkanediol with the general formula:

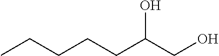

It has a carbon chain with 7 carbon atoms and the two functional OH groups of the alkanediol are in alpha,beta position and chemically bonded to the C1 and C2 carbon atoms in the alkanediol chain.

2,3-Heptanediol belongs to the category of alkanediols and is a straight chain alkanediol with the general formula:

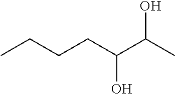

It has a carbon chain with 7 carbon atoms and the two functional OH groups of the alkanediol are in beta,gamma position and chemically bonded to the C2 and C3 carbon atoms in the alkanediol chain.

Alternatively, the enzyme stabilizing component (b) in the detergent and cleaning composition according to another aspect of the present invention is selected from the group consisting of
(b^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol.

Alkanediols are glycols, i.e. any of a class of organic compounds belonging to the alcohol family; in the molecule of a glycol, two hydroxyl (—OH) groups are attached to different carbon atoms of a carbon chain.

Straight chain 1,2-alkanediols have been used for more than 15 years as multifunctional actives. Short chain 1,2-alkanediols are amphiphilic compounds and thus, like 1,2-pentanediol, 1,2-hexanediol and 1,2-heptanediol, are soluble both in water and oils. In contrast, 1,2-octanediol is a solid and tends to precipitate or recrystallize in oily solutions as well as in water at 0.5%. On the other hand, 1,2-decanediol is a solid and soluble only in oils. Apart from moisturizing, some 1,2-alkanediols are used as viscosity modifiers.

The enzyme stabilizing agent (b) of the detergent and cleaning composition according to the other aspect of the present invention is in a first alternative at least one linear alkanediol having a carbon chain of 5 to 14 carbon atoms.

Preferably, the at least one linear alkanediol has a carbon chain of 6 to 14 carbon atoms.

More preferred, the linear alkanediol has a carbon chain of 7 to 14 carbon atoms, more preferred a carbon chain of 7 to 12 carbon atoms, still more preferred a carbon chain of 7 to 11 carbon atoms, and even more preferred a carbon chain of 7 to 10 carbon atoms. Most preferred the at least one linear alkanediol has a carbon chain of 7 to 9 carbon atoms. Most preferred the at least one linear alkanediol has a carbon chain of 7 or 8 carbon atoms.

Moreover, in a second alternative of this other aspect, the enzyme stabilizing component (b) may include a first linear alkanediol in combination with a second linear alkanediol, preferably at least one first linear alkanediol having a carbon chain of 5 to 14 carbon atoms (preferably a carbon chain of 6 to 14 carbon atoms, more preferred a carbon chain of 7 to 14 carbon atoms, more preferred a carbon chain of 7 to 12 carbon atoms, still more preferred a carbon chain of 7 to 11 carbon atoms and even more preferred a carbon chain of 7 to 10 carbon atoms, and most preferred a carbon chain of 7 to 9 carbon atoms and most preferred a carbon chain of 7 or 8 carbon atoms) and at least one second linear alkanediol having a carbon chain of 5 to 14 carbon atoms (preferably a carbon chain of 6 to 14 carbon atoms, more preferred a carbon chain of 7 to 14 carbon atoms, more preferred a carbon chain of 7 to 12 carbon atoms, still more preferred a carbon chain of 7 to 11 carbon atoms and even more preferred a carbon chain of 7 to 10 carbon atoms, and most preferred a carbon chain of 7 to 9 carbon atoms and most preferred a carbon chain of 7 or 8 carbon atoms). Therefore, the invention also entails a mixture comprising a first and a second alkanediol as described herein.

Since the first linear alkanediol of the invention can be selected from the same lists and types of compounds as the linear alkanediol according to the first alternative of the other aspect, in the following, reference is made to the linear alkanediol in general, which can also be the first linear alkanediol. In mixtures of first and second linear alkanediols, where these are specifically different, the specific terms “first” and “second” will be used to distinguish the two alkanediol components.

As used in this document, the phrase “at least one linear alkanediol” or “at least one first linear alkanediol” means that the composition can comprise one linear alkanediol having a carbon chain of 5 to 14 carbon atoms or can comprise one first linear alkanediol having a carbon chain of 5 to 14 carbon atoms or can comprise more than one linear alkanediol or can comprise more than one linear alkanediol or more than one first linear alkanediol having a carbon chain of 5 to 14 carbon atoms, i.e. two, three, four or more different linear alkanediols or first linear alkanediols having a carbon chain of 5 to 14 carbon atoms.

The at least one linear alkanediol or the at least one first linear alkanediol according to the present invention consists of a chain of 5 to 14 carbon atoms (preferably a carbon chain of 6 to 14 carbon atoms, more preferred a carbon chain of 7 to 14 carbon atoms, more preferred a carbon chain of 7 to 12 carbon atoms, still more preferred a carbon chain of 7 to 11 carbon atoms and even more preferred a carbon chain of 7 to 10 carbon atoms, and most preferred a carbon chain of 7 to 9 carbon atoms and most preferred a carbon chain of 7 or 8 carbon atoms) joined to each other by single covalent bonds with two OH functional groups attached to two different carbon atoms in the chain.

The at least one linear alkanediol or the at least one first linear alkanediol having a carbon chain of 5 to 14 carbon atoms in the detergent and cleaning composition according to another aspect of the present invention is selected from the group consisting of pentanediol, hexanediol, heptanediol, octanediol, nonanediol, decanediol, undecanediol, dodecanediol, tridecanediol, and tetradecanediol.

In a preferred variant, the at least one linear alkanediol or the at least one first linear alkanediol has a carbon chain of 5 to 13 carbon atoms and is selected from the group consisting of pentanediol, hexanediol, heptanediol, octanediol, nonanediol, decanediol, undecanediol, dodecanediol, and tridecanediol.

In a more preferred variant, the at least one linear alkanediol or the at least one first linear alkanediol has a carbon chain of 5 to 10 carbon atoms and is selected from the group consisting of pentanediol, hexanediol, heptanediol, octanediol, nonanediol, and decanediol.

In a more preferred variant, the at least one linear alkanediol or the at least one first linear alkanediol is selected from the group consisting of alkanediols having a lower number of carbon atoms of 5 to 8, i.e. pentanediol, hexanediol, heptanediol, octanediol, and any mixture thereof, or is selected from the group consisting of alkanediols having a number of carbon atoms of 6 to 8, i.e. hexanediol, heptanediol, octanediol, and any mixture thereof, or is selected from the group consisting of alkanediols having a number of carbon atoms of 7 and 8, i.e. heptanediol, octanediol, and any mixture thereof.

In a preferred variant, the at least one linear or the at least one first linear alkanediol has a carbon chain of 6 to 14 carbon atoms in the detergent and cleaning composition according to the present invention and is selected from the group consisting of hexanediol, heptanediol, octanediol, nonanediol, decanediol, undecanediol, dodecanediol, tridecanediol, and tetradecanediol.

In a preferred variant, the at least one linear or the at least one first linear alkanediol has a carbon chain of 7 to 14 carbon atoms in the detergent and cleaning composition according to the present invention and is selected from the group consisting of heptanediol, octanediol, nonanediol, decanediol, undecanediol, dodecanediol, tridecanediol, and tetradecanediol.

In a further preferred variant, the at least one linear or the at least one first linear alkanediol has a carbon chain of 7 to 12 carbon atoms in the detergent and cleaning composition according to the present invention and is selected from the group consisting of heptanediol, octanediol, nonanediol, decanediol, undecanediol, and dodecanediol.

In a more preferred variant, the at least one linear or the at least one first linear alkanediol has a carbon chain of 7 to 10 carbon atoms in the detergent and cleaning composition according to the present invention and is selected from the group consisting of heptanediol, octanediol, nonanediol, and decanediol.

In a most preferred variant, the at least one linear or the at least one first linear alkanediol has a carbon chain of 7 to 9 carbon atoms in the detergent and cleaning composition according to the present invention and is selected from the group consisting of heptanediol, octanediol, and nonanediol.

In a most preferred variant, the at least one linear or the at least one first linear alkanediol has a carbon chain of 7 or 8 carbon atoms in the detergent and cleaning composition according to the present invention and is selected from the group consisting of heptanediol, octanediol, and nonanediol.

In a still more preferred variant, the at least one linear alkanediol or the at least one first linear alkanediol is selected from the group consisting of alkanediols having a higher number of carbon atoms of 9 to 14, i.e. nonanediol, decanediol, undecanediol, dodecanediol, tridecanediol, tetradecanediol and any mixture thereof, or is selected from the group consisting of alkanediols having a number of carbon atoms of 9 to 13, i.e. nonanediol, decanediol, undecanediol, dodecanediol, tridecanediol, and any mixture thereof or is selected from the group consisting of alkanediols having a number of carbon atoms of 9 to 12, i.e. nonanediol, decanediol, undecanediol, dodecanediol, and any mixture thereof, or is selected from the group consisting of alkanediols having a number of carbon atoms of 9 to 11, i.e. nonanediol, decanediol, undecanediol, and any mixture thereof, or is selected from the group consisting of alkanediols having a number of carbon atoms of 9 and 10, i.e. nonanediol, decanediol, and any mixture thereof.

In a still more preferred variant, the at least one linear alkanediol or the at least one first linear alkanediol is either pentanediol, hexanediol, heptanediol or octanediol, or any mixture thereof.

In a still more preferred variant, the at least one linear alkanediol or the at least one first linear alkanediol is either heptanediol, octanediol, nonanediol, decanediol, undecanediol or dodecanediol, or any mixture thereof.

In a still more preferred variant, the at least one linear alkanediol or the at least one first linear alkanediol is either nonanediol, decanediol, undecanediol or dodecanediol, or any mixture thereof.

In a most preferred variant, the at least one linear alkanediol or the at least first linear alkanediol is heptanediol.

In a second alternative, the detergent and cleaning composition according to another aspect of the present invention comprises as enzyme stabilizing agent a mixture comprising at least one first linear alkanediol having a carbon chain of 5 to 14 carbon atoms (preferably a carbon chain of 6 to 14 carbon atoms, more preferred a carbon chain of 7 to 14 carbon atoms, more preferred a carbon chain of 7 to 12 carbon atoms, still more preferred a carbon chain of 7 to 11 carbon atoms and even more preferred a carbon chain of 7 to 10 carbon atoms, and most preferred a carbon chain of 7 to 9 carbon atoms and most preferred a carbon chain of 7 or 8 carbon atoms) and one or more second linear alkanediol having a carbon chain of 5 to 14 carbon atoms (preferably a carbon chain of 6 to 14 carbon atoms, more preferred a carbon chain of 7 to 14 carbon atoms, more preferred a carbon chain of 7 to 12 carbon atoms, still more preferred a carbon chain of 7 to 11 carbon atoms and even more preferred a carbon chain of 7 to 10 carbon atoms, and most preferred a carbon chain of 7 to 9 carbon atoms and most preferred a carbon chain of 7 or 8 carbon atoms) which is/are different from the first linear alkanediol.

This means that the enzyme stabilizing agent is an alkanediol mixture comprising at least one first linear alkanediol having a carbon chain of 5 to 14 carbon atoms and one or more, i.e. two, three, four or more, second linear alkanediols having a carbon chain of 5 to 14 carbon atoms. In this alternative, the first linear alkanediol can be any of the alkanediols as described herein for the linear alkanediol in general and in particular for the first alternative of the other aspect.

For example, the mixture can include one first linear alkanediol and one, two, three or more second linear alkanediols; or the mixture can include two first linear alkanediols and one, two, three or more second linear alkanediols, etc. with the proviso, that in each mixture, the first linear alkanediols and the second linear alkanediols are different from each other.

The second linear alkanediol preferably consists of a chain of 5 to 14 carbon atoms joined to each other by single covalent bonds with two OH functional groups attached to two different carbon atoms in the chain.

The at least one second linear alkanediol having a carbon chain of 5 to 14 carbon atoms in the detergent and cleaning composition according to the other aspect of the present invention is selected from the group consisting of pentanediol, hexanediol, heptanediol, octanediol, nonanediol, decanediol, undecanediol, dodecanediol, tridecanediol and tetradecanediol.

In a preferred variant, the at least one second linear alkanediol has a carbon chain of 5 to 13 carbon atoms and is selected from the group consisting of pentanediol, hexanediol, heptanediol, octanediol, nonanediol, decanediol, undecanediol, dodecanediol, and tridecanediol.

In a more preferred variant, the at least one second linear alkanediol has a carbon chain of 5 to 10 carbon atoms and is selected from the group consisting of pentanediol, hexanediol, heptanediol, octanediol, nonanediol, and decanediol.

In a preferred variant, the at least one second linear alkanediol has a carbon chain of 6 to 14 carbon atoms in the detergent and cleaning composition according to the other aspect of the present invention and is selected from the group consisting of hexanediol, heptanediol, octanediol, nonanediol, decanediol, undecanediol, dodecanediol, tridecanediol, and tetradecanediol.

In a preferred variant, the at least one second linear alkanediol has a carbon chain of 7 to 14 carbon atoms in the detergent and cleaning composition according to the other aspect of the present invention and is selected from the group consisting of heptanediol, octanediol, nonanediol, decanediol, undecanediol, dodecanediol, tridecanediol, and tetradecanediol.

In a further preferred variant, the at least one second linear alkanediol has a carbon chain of 7 to 12 carbon atoms in the detergent and cleaning composition according to the other aspect of the present invention and is selected from the group consisting of heptanediol, octanediol, nonanediol, decanediol, undecanediol, and dodecanediol.

In a more preferred variant, the at least one second linear alkanediol has a carbon chain of 7 to 11 carbon atoms in the detergent and cleaning composition according to the other aspect of the present invention and is selected from the group consisting of heptanediol, octanediol, nonanediol, decanediol and undecanediol.

In a more preferred variant, the at least one second linear alkanediol has a carbon chain of 7 to 10 carbon atoms in the detergent and cleaning composition according to the other aspect of the present invention and is selected from the group consisting of heptanediol, octanediol, nonanediol, and decanediol.

In a most preferred variant, the at least one second linear alkanediol has a carbon chain of 7 to 9 carbon atoms in the detergent and cleaning composition according to the other aspect of the present invention and is selected from the group consisting of heptanediol, octanediol, and nonanediol.

In a most preferred variant, the at least one second linear alkanediol has a carbon chain of 7 or 8 carbon atoms in the detergent and cleaning composition according to the other aspect of the present invention and is selected from the group consisting of heptanediol and octanediol.

In a more preferred variant, the at least one second linear alkanediol is selected from the group consisting of pentanediol, hexanediol, heptanediol, octanediol and nonanediol, most preferably hexanediol, heptanediol, octanediol and nonanediol.

The phrase “different from each other means” that the first linear alkanediols and the second linear alkanediols in the mixture are either different with regard to the length of their carbon chain, i.e. number of the carbon atoms, or with regard to their constitutional isomerism.

Likewise, the number of the carbon atoms of the first linear alkanediols and the second linear alkanediols in the mixture can also be same. For example, the first linear alkanediol and the second linear alkanediol have a carbon chain of 7 carbon atoms, but the first linear alkanediol and the second linear alkanediol are different with regard to their constitutional isomerism or with regard to their stereoisomerism.

If both the first and the second alkanediol is for example heptanediol, then the second linear alkanediol heptanediol is a different constitutional isomer or stereoisomer from the first linear alkanediol, according to the second alternative of the second aspect.

In a preferred variant, the detergent and cleaning composition according to the second aspect of the present invention comprises a mixture comprising at least one first linear alkanediol having a carbon chain of 5 to 14 carbon atoms and one or more second linear alkanediol having a carbon chain of 5 to 14 carbon atoms wherein the number of the carbon atoms of the first and the second alkanediol is either same or different.

If both, the first and the second alkanediol have the same number of carbon atoms, such an alkanediol combination is herein also referred to as “homo alkanediol mixture” or “homo combination”. For example, the first linear alkanediol and the second linear alkanediol have a carbon chain of 7 carbon atoms, but the first linear alkanediol and the second linear alkanediol are different with regard to their constitutional isomerism or in regard to their stereoisomerism.

If the first and the second alkanediol have a different number of carbon atoms, such an alkanediol combination is herein also referred to as “hetero alkanediol mixture” or “hetero combination”. For example, the first linear alkanediol has a carbon chain of 7 carbon atoms and the second linear alkanediol has a carbon chain of 8 carbon atoms. However, beyond that, the first linear alkanediol and the second linear alkanediol can be different in regard to their constitutional isomerism or with regard to their stereoisomerism.

In a preferred variant the present invention relates to a detergent and cleaning composition, wherein the at least one linear alkanediol or the first linear alkanediol is selected from the group consisting of pentanediol, hexanediol, heptanediol, octanediol, nonanediol, decanediol, undecanediol, dodecanediol, tridecanediol, and tetradecanediol; and/or the second linear alkanediol is selected from the group consisting of pentanediol, hexanediol, heptanediol, octanediol, nonanediol, decanediol, undecanediol, dodecanediol, tridecanediol and tetradecanediol.

Particular preferred is an enzyme stabilizing agent mixture, wherein the at least first linear alkanediol is selected from an alkanediol having a lower number of carbon atoms from 5 to 8 and wherein the one or more second alkanediol is selected from an alkanediol having a higher number of carbon atoms from 9 to 14.

Most preferred is an enzyme stabilizing agent mixture, wherein the at least first linear alkanediol is selected from the group consisting of pentanediol, hexanediol, heptanediol, octanediol, and any mixture thereof, and the one or more second alkanediol is selected from the group consisting of nonanediol, decanediol, undecanediol, dodecanediol, tridecanediol, and any mixture thereof.

The term “alkanediol” within the context of the present invention also includes its constitutional isomers or position isomers. Constitutional isomers are compounds that have the same molecular formula and different connectivity. Position isomers, a particular form of constitutional isomerism, are structural isomers that can be viewed as differing only on the position of a functional group on a parent structure, which in this case, in particular, is the position of the two alcohol functions.

Depending on the number of the carbon atoms of the carbon chain of the alkanediol, there are various position isomers of the alkanediol: (x,x+1) constitutional isomers; (x,x+2) constitutional isomers; (x,x+3) constitutional isomers; etc. and alpha,omega constitutional isomers when the alcohol functions are at the terminal ends of the carbon chain, wherein x stands for the number of the carbon atom in the alkanediol chain, to which the OH groups of the alkanediol are chemically bonded. For example: if x is 1, the two OH groups of the alkanediol are chemically bonded to the C1 and C2 carbon atoms in the alkanediol chain; if x is 2, the two OH groups of the alkanediol are chemically bonded to the C2 and C3 carbon atoms in the alkanediol chain, etc.

In the (x,x+1) constitutional isomers, the two OH functional groups are vicinal attached to two different adjacent carbon atoms in the chain. In the (x,x+2) constitutional isomers, the two OH functional groups are attached to two different carbon atoms in the chain where the two carbon atoms are separated by one C atom. In the (x,x+3) constitutional isomers, the two OH functional groups are attached to two different carbon atoms in the chain where the two carbon atoms are separated by two C atoms. In the alpha,omega constitutional isomers, the two functional groups are attached to the first C atom and to the terminal C atom.

In a preferred variant of the detergent and cleaning composition according to the present invention, the linear alkanediol having a carbon chain of 5 to 14 carbon atoms, is preferably a vicinal (x,x+1) diol, selected from the group consisting of a 1,2-diol, 2,3-diol, 3,4-diol, 4,5-diol, further (x,x+1) diols, and mixtures thereof, preferably an alpha,beta-1,2-constitutional isomer.

In a more preferred variant of the detergent and cleaning composition according to the present invention, the first linear alkanediol and/or the second linear alkanediol having a carbon chain of 5 to 14 carbon atoms is a vicinal (x,x+1) diol, selected from the group consisting of a 1,2-diol, 2,3-diol, 3,4-diol, 4,5-diol, further (x,x+1) diols, and mixtures thereof, preferably an alpha, beta-1,2-constitutional isomer.

Preferably, the first linear alkanediol and/or the second inar alkanediol having a carbon chain of 5 to 14 carbon atoms are selected from 1,2-diols and/or 2,3-diols.

Thus, according to a preferred variant of the detergent and cleaning composition according to the present invention, the at least one linear alkanediol, the first linear alkanediol and/or the second linear alkanediol is an (x,x+1) constitutional isomer, wherein x stands for the number of the carbon atom in the alkanediol chain, to which the OH groups of the alkanediol are chemically bonded, in particular a 1,2-alkanediol, a 2,3-alkanediol, a 3,4-alkanediol, or mixtures thereof, preferably a 1,2-alkanediol or a 2,3-alkanediol.

In a further preferred variant of the detergent and cleaning composition according to the present invention, the linear alkanediol having a carbon chain of 5 to 14 carbon atoms, is preferably a non-vicinal (x,x+2) diol, selected from the group consisting of a 1,3-diol, 2,4-diol, 3,5-diol, further (x,x+2) diols, and mixtures thereof, preferably an alpha,gamma-1,3-constitutional isomer.

According to the present invention, vicinal (x,x+1) diols are most preferred, such as alpha,beta or beta,gamma or gamma,delta etc.

In a still more preferred variant of the detergent and cleaning composition according to the present invention, the linear alkanediol and in particular the first linear alkanediol and/or the second linear alkanediol, is a 1,2-alkanediol, a 2,3-alkanediol, a 3,4-alkanediol, or mixtures thereof, more preferred 2,3-alkanediol.

The 1,2-alkanediols of the linear alkanediol, in particular the first linear alkanediol having a carbon chain of 5 to 14 carbon atoms and/or the second linear alkanediol having a carbon chain of 5 to 14 carbon atoms, can preferably be those as represented by the following formulae:

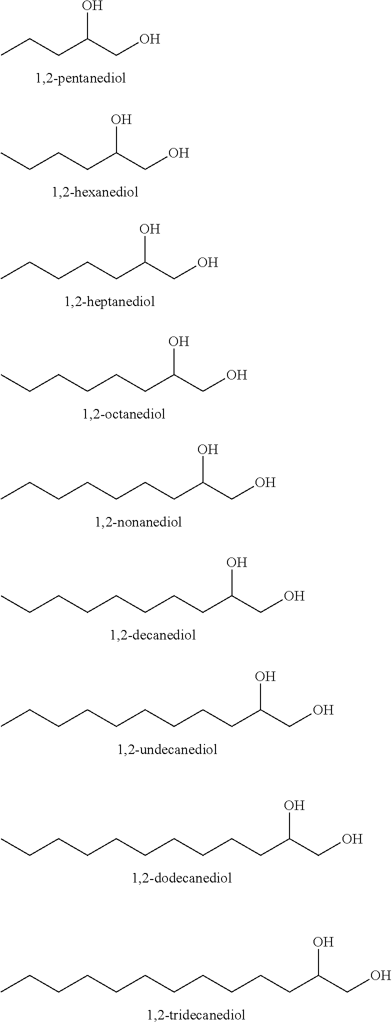

The 2,3-alkanediols of the linear alkanediol of the invention, in particular the first linear alkanediol having a carbon chain of 5 to 14 carbon atoms and/or the second linear alkanediol having a carbon chain of 5 to 14 carbon atoms, can preferably be those as represented by the following formulae:

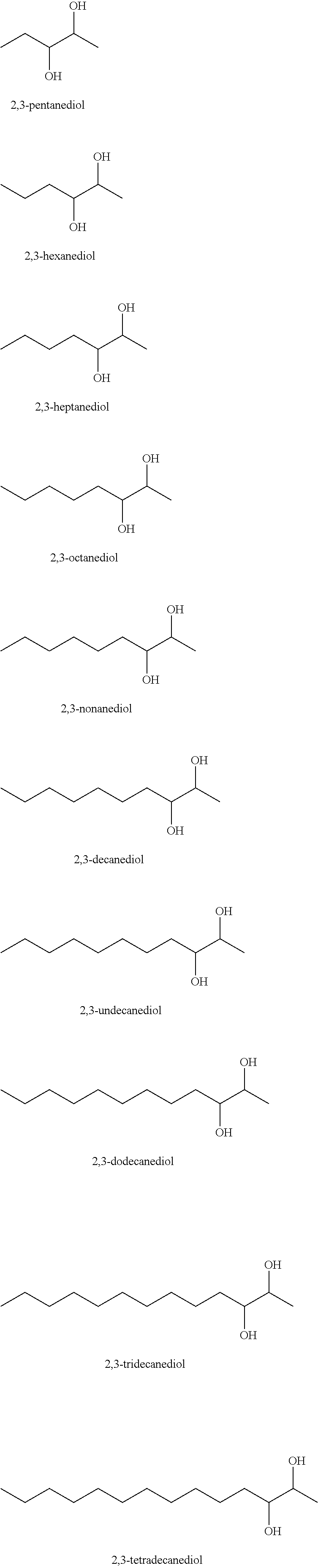

The 3,4-alkanediols of the linear alkanediol, preferably the first linear alkanediol having a carbon chain of 5 to 14 carbon atoms and/or the second linear alkanediol having a carbon chain of 5 to 14 carbon atoms, can preferably be those as represented by the following formulae:

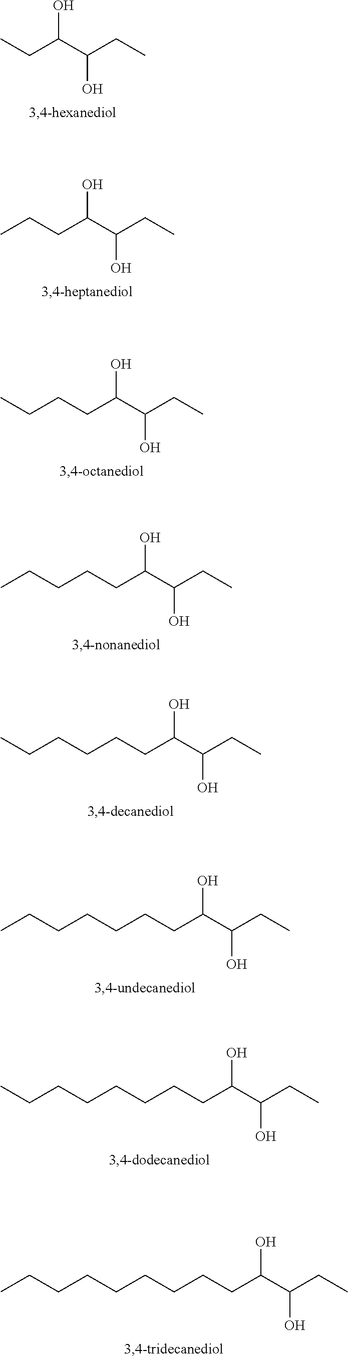

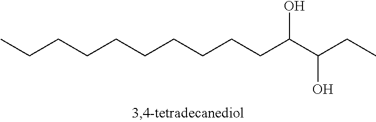 [SMILES: CCCCCCCCCCC(O)C(O)CC]

In a preferred variant of the detergent and cleaning composition according to the present invention, the linear alkanediol or the first linear alkanediol is selected from the group consisting of:
1,2-pentanediol, 2,3-pentanediol, 3,4-pentanediol,
1,2-hexanediol, 2,3-hexanediol, 3,4-hexanediol,
1,2-heptanediol, 2,3-heptanediol, 3,4-heptanediol,
1,2-octanediol, 2,3-octanediol, 3,4-octanediol,
1,2-nonanediol, 2,3-nonanediol, 3,4-nonanediol,
1,2-decanediol, 2,3-decanediol, 3,4-decanediol,
1,2-undecanediol, 2,3-undecanediol, 3,4-undecanediol,
1,2-dodecanediol, 2,3-dodecanediol, 3,4-dodecanediol,
1,2-tridecanediol, 2,3-tridecanediol, 3,4-tridecanediol,
1,2-tetradecanediol, 2,3-tetradecanedioll, 3,4-tetradecanediol,
   and any mixture thereof.

In a further preferred variant of the detergent and cleaning composition according to the present invention, the linear alkanediol or the first linear alkanediol is selected from the group consisting of:
1,2-hexanediol, 2,3-hexanediol, 3,4-hexanediol,
1,2-heptanediol, 2,3-heptanediol, 3,4-heptanediol,
1,2-octanediol, 2,3-octanediol, 3,4-octanediol,
1,2-nonanediol, 2,3-nonanediol, 3,4-nonanediol,
1,2-decanediol, 2,3-decanediol, 3,4-decanediol,
1,2-undecanediol, 2,3-undecanediol, 3,4-undecanediol,
1,2-dodecanediol, 2,3-dodecanediol, 3,4-dodecanediol,
1,2-tridecanediol, 2,3-tridecanediol, 3,4-tridecanediol,
1,2-tetradecanediol, 2,3-tetradecanedioll, 3,4-tetradecanediol,
   and any mixture thereof.

In a further preferred variant of the detergent and cleaning composition according to the present invention, the linear alkanediol or the first linear alkanediol is selected from the group consisting of:
1,2-heptanediol, 2,3-heptanediol, 3,4-heptanediol,
1,2-octanediol, 2,3-octanediol, 3,4-octanediol,
1,2-nonanediol, 2,3-nonanediol, 3,4-nonanediol,
1,2-decanediol, 2,3-decanediol, 3,4-decanediol,
1,2-undecanediol, 2,3-undecanediol, 3,4-undecanediol,
1,2-dodecanediol, 2,3-dodecanediol, 3,4-dodecanediol,
1,2-tridecanediol, 2,3-tridecanediol, 3,4-tridecanediol,
1,2-tetradecanediol, 2,3-tetradecanedioll, 3,4-tetradecanediol,
and any mixture thereof.

Even more preferred, the linear alkanediol or the first linear alkanediol is selected from the group consisting of:
1,2-heptanediol, 2,3-heptanediol, 3,4-heptanediol,
1,2-octanediol, 2,3-octanediol, 3,4-octanediol,
1,2-nonanediol, 2,3-nonanediol, 3,4-nonanediol,
1,2-decanediol, 2,3-decanediol, 3,4-decanediol,
1,2-undecanediol, 2,3-undecanediol, 3,4-undecanediol,
1,2-dodecanediol, 2,3-dodecanediol, 3,4-dodecanediol,
and any mixture thereof.

Further preferred, the linear alkanediol or the first linear alkanediol is selected from the group consisting of:
1,2-heptanediol, 2,3-heptanediol, 3,4-heptanediol,
1,2-octanediol, 2,3-octanediol, 3,4-octanediol,
1,2-nonanediol, 2,3-nonanediol, 3,4-nonanediol,
1,2-decanediol, 2,3-decanediol, 3,4-decanediol,
1,2-undecanediol, 2,3-undecanediol, 3,4-undecanediol,
and any mixture thereof.

Further preferred, the linear alkanediol or the first linear alkanediol is selected from the group consisting of:
1,2-heptanediol, 2,3-heptanediol, 3,4-heptanediol,
1,2-octanediol, 2,3-octanediol, 3,4-octanediol,
1,2-nonanediol, 2,3-nonanediol, 3,4-nonanediol,
1,2-decanediol, 2,3-decanediol, 3,4-decanediol,
and any mixture thereof.

Most preferred, the linear alkanediol or the first linear alkanediol is selected from the group consisting of:
1,2-heptanediol, 2,3-heptanediol, 3,4-heptanediol,
1,2-octanediol, 2,3-octanediol, 3,4-octanediol,
1,2-nonanediol, 2,3-nonanediol, 3,4-nonanediol,
and any mixture thereof.

Most preferred, the linear alkanediol or the first linear alkanediol is selected from the group consisting of:
1,2-heptanediol, 2,3-heptanediol, 3,4-heptanediol,
1,2-octanediol, 2,3-octanediol, 3,4-octanediol,
and any mixture thereof.

According to a preferred variant, in the detergent and cleaning composition according to the present invention the linear alkanediol or the first linear alkanediol is selected from the group consisting of 1,2-pentanediol, 2,3-pentanediol, 1,2-hexanediol, 2,3-hexanediol, 1,2-heptanediol, 2,3-heptanediol, 1,2-octanediol, 2,3-octanediol, 1,2-nonanediol, 2,3-nonanediol, 1,2-decanediol, 2,3-decanediol, 1,2-undecanediol, 2,3-undecanediol, 1,2-dodecanediol, 2,3-dodecanediol, 1,2-tridecanediol, 2,3-tridecanediol, 1,2-tetradecanediol, 2,3-tetradecanediol, and any mixture thereof.

According to a further preferred variant, in the detergent and cleaning composition according to the present invention the linear alkanediol or the first linear alkanediol is selected from the group consisting of 1,2-hexanediol, 2,3-hexanediol, 1,2-heptanediol, 2,3-heptanediol, 1,2-octanediol, 2,3-octanediol, 1,2-nonanediol, 2,3-nonanediol, 1,2-decanediol, 2,3-decanediol, 1,2-undecanediol, 2,3-undecanediol, 1,2-dodecanediol, 2,3-dodecanediol, 1,2-tridecanediol, 2,3-tridecanediol, 1,2-tetradecanediol, 2,3-tetradecanediol, and any mixture thereof.

According to a further preferred variant, in the detergent and cleaning composition according to the present invention the linear alkanediol or the first linear alkanediol is selected from the group consisting of 1,2-heptanediol, 2,3-heptanediol, 1,2-octanediol, 2,3-octanediol, 1,2-nonanediol, 2,3-nonanediol, 1,2-decanediol, 2,3-decanediol, 1,2-undecanediol, 2,3-undecanediol, 1,2-dodecanediol, 2,3-dodecanediol, 1,2-tridecanediol, 2,3-tridecanediol, 1,2-tetradecanediol, 2,3-tetradecanediol, and any mixture thereof.

According to a more preferred variant, in the detergent and cleaning composition according to the present invention the linear alkanediol or the first linear alkanediol is selected from the group consisting of 1,2-heptanediol, 2,3-heptanediol, 1,2-octanediol, 2,3-octanediol, 1,2-nonanediol, 2,3-nonanediol, 1,2-decanediol, 2,3-decanediol, 1,2-undecanediol, 2,3-undecanediol, 1,2-dodecanediol, 2,3-dodecanediol, and any mixture thereof.

According to a more preferred variant, in the detergent and cleaning composition according to the present invention the linear alkanediol or the first linear alkanediol is selected from the group consisting of 1,2-heptanediol, 2,3-heptanediol, 1,2-octanediol, 2,3-octanediol, 1,2-nonanediol, 2,3-nonanediol, 1,2-decanediol, 2,3-decanediol, 1,2-undecanediol, 2,3-undecanediol, and any mixture thereof.

According to an even more preferred variant, in the detergent and cleaning composition according to the present invention the linear alkanediol or the first linear alkanediol is selected from the group consisting of 1,2-heptanediol, 2,3-heptanediol, 1,2-octanediol, 2,3-octanediol, 1,2-nonanediol, 2,3-nonanediol, 1,2-decanediol, 2,3-decanediol, and any mixture thereof.

According to a most preferred variant, in the detergent and cleaning composition according to the present invention the linear alkanediol or the first linear alkanediol is selected from the group consisting of 1,2-heptanediol, 2,3-heptanediol, 1,2-octanediol, 2,3-octanediol, 1,2-nonanediol, 2,3-nonanediol, and any mixture thereof.

According to a most preferred variant, in the detergent and cleaning composition according to the present invention the linear alkanediol or the first linear alkanediol is selected from the group consisting of 1,2-heptanediol, 2,3-heptanediol, 1,2-octanediol, 2,3-octanediol, and any mixture thereof.

Of the aforesaid linear alkanediols or the first linear alkanediols, the following (x,x+1) constitutional isomers are preferred: 1,2-pentanediol, 2,3-pentanediol, 1,2-hexanediol, 2,3-hexanediol, 1,2-heptanediol, 2,3-heptanediol, 2,3-octanediol, 2,3-nonanediol, 2,3-decanediol, 2,3-undecanediol, 2,3-dodecanediol, 2,3-tridecanediol or mixtures thereof. Said alkanediols are liquid at a purity of 90 to 99%.

Of the aforesaid liquid alkanediols 1,2-pentanediol, 2,3-pentanediol, 1,2-hexanediol, 2,3-hexanediol, 1,2-heptanediol, 2,3-heptanediol, 2,3-octanediol, 2,3-nonanediol, or mixtures of said liquid alkanediols are particularly preferred.

In a further preferred variant of the detergent and cleaning composition according to the present invention, the linear alkanediol or the first linear alkanediol is selected from the group consisting of:
1,2-pentanediol, 2,3-pentanediol,
1,2-hexanediol, 2,3-hexanediol,
1,2-heptanediol, 2,3-heptanediol,
1,2-octanediol, 2,3-octanediol,
and any mixture thereof.

In a further preferred variant of the detergent and cleaning composition according to the present invention, the linear alkanediol or the first linear alkanediol is selected from the group consisting of:
1,2-hexanediol, 2,3-hexanediol,
1,2-heptanediol, 2,3-heptanediol,
1,2-octanediol, 2,3-octanediol,
1,2-nonaediol, 2,3-nonanediol,
1,2-decanediol, 2,3-decanediol,
1,2-undecanediol, 2,3-undecanediol,
1,2-dodecanediol, 2,3-dodecanediol,
1,2-tridecantediol, 2,3-tridecanediol,
1,2-tetradecanediol, 2,3-tetradecanediol,
and any mixture thereof.

More preferred, in the detergent and cleaning composition according to the second aspect of the present invention, the linear alkanediol or the first linear alkanediol is selected from the group consisting of 1,2-pentanediol, 2,3-pentanediol, and mixtures thereof, or is selected from the group consisting of 1,2-heptanediol, 2,3-heptanediol, and mixtures thereof. However, the linear alkanediol or the first linear alkanediol can also preferably be selected from the group consisting of 1,2-octanediol, 2,3-octanediol, and mixtures thereof.

Even more preferred, in the detergent and cleaning composition according to the present invention, the linear alkanediol or the first linear alkanediol is an alpha,beta or a beta,gamma diol as either 1,2-heptanediol or 2,3-heptandediol or a mixture thereof. However, the linear alkanediol or the first linear alkanediol can also preferably be an alpha,beta or a beta,gamma diol as either 1,2-octanediol or 2,3-octanediol or a mixture thereof. A mixture comprising 1,2-heptanediol and 2,3-octanediol or a mixture comprising 1,2-octanediol and 2,3-heptanediol is also possible.

Most preferred, the linear alkanediol or the first linear alkanediol is 1,2-pentanediol or 2,3-pentanediol or 1,2-hexanediol or 2,3-hexanediol or 1,2-heptanediol or 2,3-heptanediol or 1,2-octanediol or 2,3-octanediol or 1,2-nonanediol or 2,3-nonanediol.

Likewise, in a further preferred variant of the detergent and cleaning composition according to the present invention, the linear alkanediol or the first linear alkanediol is selected from the group consisting of 1,2-nonanediol, 2,3-nonanediol, 1,2-decanediol, 2,3-decanediol, 1,2-undecanediol, 2,3-undecanediol, 1,2-dodecanediol, 2,3-dodecanediol, and any mixture thereof.

More preferred, in the detergent and cleaning composition according to the present invention, the linear alkanediol or the first linear alkanediol is selected from the group consisting of 1,2-nonanediol, 2,3-nonanediol, and mixtures thereof, or can also be preferably selected from the group consisting of 1,2-decanediol, 2,3-decanediol, and mixtures thereof, or can also be preferably selected from the group consisting of 1,2-undecanediol, 2,3-undecanediol, and mixtures thereof.

In a more preferred variant, the at least one linear alkanediol or the at least one first linear alkanediol is selected from the group consisting of 1,2-alkanediols having a number of carbon atoms of 6 to 14, i.e. 1,2-hexanediol, 1,2-heptanediol, 1,2-octanediol, 1,2-nonanediol, 1,2-decanediol, 1,2-undecanediol, 1,2-dodecanediol, 1,2-tridecanediol, 1,2-tetradecanediol, and any mixture thereof, or is selected from the group consisting of 1,2-alkanediols having a number of carbon atoms of 7 to 14, i.e. 1,2-heptanediol, 1,2-octanediol, 1,2-nonanediol, 1,2-decanediol, 1,2-undecanediol, 1,2-dodecanediol, 1,2-tridecanediol, 1,2-tetradecanediol, and any mixture thereof, or is selected from the group consisting of 1,2-alkanediols having a number of carbon atoms of 7 to 12, i.e. 1,2-heptanediol, 1,2-octanediol, 1,2-nonanediol, 1,2-decanediol, 1,2-undecanediol, 1,2-dodecanediol, and any mixture thereof, or is selected from the group consisting of 1,2-alkanediols having a number of carbon atoms of 7 to 11, i.e. 1,2-heptanediol, 1,2-octanediol, 1,2-nonanediol, 1,2-decanediol, 1,2-undecanediol, and any mixture thereof, or is selected from the group consisting of 1,2-alkanediols having a number of carbon atoms of 7 to 10, i.e. 1,2-heptanediol, 1,2-octanediol, 1,2-nonanediol, 1,2-decanediol, and any mixture thereof, or is selected form the group consisting of 1,2-alkanediols having a number of carbon atoms of 7 to 9, i.e. 1,2-heptanediol, 1,2-octanediol, 1,2-nonanediol, and any mixture thereof, or is selected form the group consisting of 1,2-alkanediols having a number of carbon atoms of 7 and 8, i.e. 1,2-heptanediol, 1,2-octanediol, and any mixture thereof.

It was found that these 1,2-alkanediols show particular pronounced enzyme stabilizing properties. Said alkanediols are thus efficient for use as enzyme stabilizing agents in detergents and cleaning compositions comprising an enzyme. The improved enzyme stability in the detergents and cleaning compositions in turn results in a better cleaning performance, even when the composition is stored.

In a more preferred variant, the at least one linear alkanediol or the at least one first linear alkanediol is selected from the group consisting of 1,2-alkanediols having a lower number of carbon atoms of 5 to 8, i.e. 1,2-pentanediol, 1,2-hexanediol, 1,2-heptanediol, 1,2-octanediol, and any mixture thereof, or is selected from the group consisting of 1,2-alkanediols having a number of carbon atoms of 6 to 8, i.e. 1,2-hexanediol, 1,2-heptanediol, 1,2-octanediol, and any mixture thereof, or is selected from the group consisting of 1,2-alkanediols having a number of carbon atoms of 7 and 8, i.e. 1,2-heptanediol, 1,2-octanediol, and any mixture thereof.

In a still more preferred variant, the at least one linear alkanediol or the at least one first linear alkanediol is either 1,2-pentanediol or 1,2-hexanediol or 1,2-heptanediol or 1,2-octanediol, or any mixture thereof.

In a most preferred variant, the at least one linear alkanediol or the at least first linear alkanediol is 1,2-heptanediol.

It was found that these alkanediols show particular pronounced enzyme stabilizing properties. 1,2-Alkanediols having a lower number of carbon atoms are thus efficient for use as enzyme stabilizing agents in detergents and cleaning compositions comprising an enzyme. The improved enzyme stability in the detergents and cleaning compositions results in a better cleaning performance.

In a still more preferred variant, the at least one linear alkanediol or the at least one first linear alkanediol is selected from the group consisting of 1,2-alkanediols having a higher number of carbon atoms of 9 to 14, i.e. 1,2-nonanediol, 1,2-decanediol, 1,2-undecanediol, 1,2-dodecanediol, 1,2-tridecanediol, 1,2-tetradecanediol, and any mixture thereof, or is selected from the group consisting of 1,2-alkanediols having a number of carbon atoms of 9 to 13, i.e. 1,2-nonanediol, 1,2-decanediol, 1,2-undecanediol, 1,2-dodecanediol, 1,2-tridecanediol, and any mixture thereof, or is selected from the group consisting of 1,2-alkanediols having a number of carbon atoms of 9 to 12, i.e. 1,2-nonanediol, 1,2-decanediol, 1,2-undecanediol, 1,2-dodecanediol, and any mixture thereof, or is selected from the group consisting of 1,2-alkanediols having a number of carbon atoms of 9 to 11, i.e. 1,2-nonanediol, 1,2-decanediol, 1,2-undecanediol, and any mixture thereof, or is selected from the group consisting of 1,2-alkanediols having a number of carbon atoms of 9 and 10, i.e. 1,2-nonanediol, 1,2-decanediol, and any mixture thereof.

In a still more preferred variant, the at least one linear alkanediol or the at least one first linear alkanediol is either 1,2-nonanediol or 1,2-decanediol or 1,2-undecanediol or 1,2-dodecanediol, or any mixture thereof.

According to a preferred variant, the at least one linear alkanediol or the at least one first linear alkanediol is selected from the group consisting of 1,2-alkanediols having a higher number of carbon atoms, and more specifically more than 10 carbon atoms, i.e. 1,2-undecanediol, 1,2-dodecanediol, 1,2-tridecanediol, or 1,2-tetradecanediol.

It was found that these alkanediols show pronounced enzyme stabilizing properties. 1,2-Alkanediols having a higher number of carbon atoms, and more specifically more than 10 carbon atoms, are thus efficient for use as enzyme stabilizing agents in detergents and cleaning compositions comprising an enzyme. The improved enzyme stability in the detergents and cleaning compositions results in a better cleaning performance.

In a more preferred variant, the at least one linear alkanediol or the at least one first linear alkanediol is selected from the group consisting of 2,3-alkanediols having a number of carbon atoms of 6 to 14, i.e. 2,3-hexanediol, 2,3-heptanediol, 2,3-octanediol, 2,3-nonanediol, 2,3-decanediol, 2,3-undecanediol, 2,3-dodecanediol, 2,3-tridecanediol, 2,3-tetradecanediol, and any mixture thereof, or is selected from the group consisting of 2,3-alkanediols having a number of carbon 7 to 14, i.e. 2,3-heptanediol, 2,3-octanediol, 2,3-nonanediol, 2,3-decanediol, 2,3-undecanediol, 2,3-dodecanediol, 2,3-tridecanediol, 2,3-tetradecanediol, and any mixture thereof, or is selected from the group consisting of 2,3-alkanediols having a number of carbon atoms of 7 to 12, i.e. 2,3-heptanediol, 2,3-octanediol, 2,3-nonanediol, 2,3-decanediol, 2,3-undecanediol, 2,3-dodecanediol, and any mixture thereof, or is selected from the group consisting of 2,3-alkanediols having a number of carbon atoms of 7 to 11, i.e. 2,3-heptanediol, 2,3-octanediol, 2,3-nonanediol, 2,3-decanediol, 2,3-undecanediol, and any mixture thereof, or is selected from the group consisting of 2,3-alkanediols having a number of carbon atoms of 7 to 10, i.e. 2,3-heptanediol, 2,3-octanediol, 2,3-nonanediol, 2,3-decanediol, and any mixture thereof, or is selected form the group consisting of 2,3-alkanediols having a number of carbon atoms of 7 to 9, i.e. 2,3-heptanediol, 2,3-octanediol, 2,3-nonanediol, and any mixture thereof, or is selected form the group consisting of 2,3-alkanediols having a number of carbon atoms of 7 and 8, i.e. 2,3-heptanediol, 2,3-octanediol, and any mixture thereof.

It was found that said 2,3-alkanediols show particular pronounced enzyme stabilizing properties. Said alkanediols are thus efficient for use as enzyme stabilizing agents in detergents and cleaning compositions comprising an enzyme. The improved enzyme stability in the detergents and cleaning compositions in turn results in a better cleaning performance after storage, compared to a detergents and cleaning composition without the addition of such alkanediols.

In a still more preferred variant, the linear alkanediol or the first linear alkanediol is selected from the group consisting of 2,3-alkanediols having a lower number of carbon atoms of 5 to 8, i.e. 2,3-pentanediol, 2,3-hexanediol, 2,3-heptanediol, 2,3-octanediol, and any mixture thereof, or is selected from the group consisting of 2,3-alkanediols having a number of carbon atoms of 6 to 8, i.e. 2,3-hexanediol, 2,3-heptanediol, 2,3-octanediol, and any mixture thereof, or is selected from the group consisting of 2,3-alkanediols having a number of carbon atoms of 7 and 8, i.e. 1,2-heptanediol, 1,2-octanediol, and any mixture thereof.

In a still more preferred variant, the at least one linear alkanediol or the at least one first linear alkanediol is either 2,3-pentanediol or 2,3-hexanediol or 2,3-heptanediol or 2,3-octanediol or any mixture thereof.

In a most preferred variant, the at least one linear alkanediol or the at least first linear alkanediol is 2,3-heptanediol.

It was found that these alkanediols show particular pronounced enzyme stabilizing properties. 2,3-Alkanediols having a lower number of carbon atoms are thus efficient for use as enzyme stabilizing agents in detergents and cleaning compositions comprising an enzyme. The improved enzyme stability in the detergents and cleaning compositions results in a better cleaning performance.

In a still more preferred variant, the at least one linear alkanediol or the at least one first linear alkanediol is selected from the group consisting of 2,3-alkanediols having a higher number of carbon atoms of 9 to 14, i.e. 2,3-nonanediol, 2,3-decanediol, 2,3-undecanediol, 2,3-dodecanediol, 2,3-tridecanediol, 2,3-tetradecanediol, and any mixture thereof, or is selected from the group consisting of 2,3-alkanediols having a number of carbon atoms of 9 to 13, i.e. 2.3-nonanediol, 2,3-decanediol, 2,3-undecanediol, 2,3-dodecanediol, 2,3-tetradecanediol, and any mixture thereof, or is selected from the group consisting of 2,3-alkanediols having a number of carbon atoms of 9 to 12, i.e. 2.3-nonanediol, 2,3-decanediol, 2,3-undecanediol, 2,3-dodecanediol, and any mixture thereof, or is selected from the group consisting of 2,3-alkanediols having a number of carbon atoms of 9 to 11, i.e. 2,3-nonanediol, 2,3-decanediol, 2,3-undecanediol, and any mixture thereof, or is selected from the group consisting of 2,3-alkanediols having a number of carbon atoms of 9 and 10, i.e. 2,3-nonanediol, 2,3-decanediol, and any mixture thereof.

In a still more preferred variant, the at least one linear alkanediol or the at least one first linear alkanediol is either 2,3-nonanediol, 2,3-decanediol, 2,3-undecanediol or 2,3-dodecanediol, or any mixture thereof.

According to a preferred variant, the at least one linear alkanediol or the at least one first linear alkanediol is selected from the group consisting of 2,3-alkanediols having a higher number of carbon atoms, and more specifically more than 10 carbon atoms, i.e. 2,3-undecanediol, 2,3-dodecanediol, 2,3-tridecanediol, or 2,3-tetradecanediol.

It was found that these alkanediols show better enzyme stabilizing properties. 2,3-Alkanediols having a higher number of carbon atoms, and more specifically more than 10 carbon atoms, are thus efficient for use as enzyme stabilizing agents in detergents and cleaning compositions comprising an enzyme. The improved enzyme stability in the detergents and cleaning compositions results in a better cleaning performance.

In a preferred variant of the detergent and cleaning composition according to the present invention, the second linear alkanediol is selected from the group consisting of:
1,2-pentanediol, 2,3-pentanediol, 3,4-pentanediol,
1,2-hexanediol, 2,3-hexanediol, 3,4-hexanediol,
1,2-heptanediol, 2,3-heptanediol, 3,4-heptanediol,
1,2-octanediol, 2,3-octanediol, 3,4-octanediol,
1,2-nonanediol, 2,3-nonanediol, 3,4-nonanediol,
1,2-decanediol, 2,3-decanediol, 3,4-decanediol,
1,2-undecanediol, 2,3-undecanediol, 3,4-undecanediol,
1,2-dodecanediol, 2,3-dodecanediol, 3,4-dodecanediol,
1,2-tridecanediol, 2,3-tridecanediol, 3,4-tridecanediol,
1,2-tetradecanediol, 2,3-tetradecanediol, 3,4-tetradecanediol,
and any mixture thereof.

In a further preferred variant of the detergent and cleaning composition according to the present invention, the second linear alkanediol is selected from the group consisting of:
1,2-hexanediol, 2,3-hexanediol, 3,4-hexanediol,
1,2-heptanediol, 2,3-heptanediol, 3,4-heptanediol,
1,2-octanediol, 2,3-octanediol, 3,4-octanediol,
1,2-nonanediol, 2,3-nonanediol, 3,4-nonanediol,
1,2-decanediol, 2,3-decanediol, 3,4-decanediol,
1,2-undecanediol, 2,3-undecanediol, 3,4-undecanediol,
1,2-dodecanediol, 2,3-dodecanediol, 3,4-dodecanediol,
1,2-tridecanediol, 2,3-tridecanediol, 3,4-tridecanediol,
1,2-tetradecanediol, 2,3-tetradecanediol, 3,4-tetradecanediol,
and any mixture thereof.

In a further preferred variant of the detergent and cleaning composition according to the present invention, the second linear alkanediol is selected from the group consisting of:
1,2-heptanediol, 2,3-heptanediol, 3,4-heptanediol,
1,2-octanediol, 2,3-octanediol, 3,4-octanediol,
1,2-nonanediol, 2,3-nonanediol, 3,4-nonanediol,
1,2-decanediol, 2,3-decanediol, 3,4-decanediol,
1,2-undecanediol, 2,3-undecanediol, 3,4-undecanediol,
1,2-dodecanediol, 2,3-dodecanediol, 3,4-dodecanediol,
1,2-tridecanediol, 2,3-tridecanediol, 3,4-tridecanediol,
1,2-tetradecanediol, 2,3-tetradecanediol, 3,4-tetradecanediol,
and any mixture thereof.

Even more preferred, the second linear alkanediol is selected from the group consisting of:
1,2-heptanediol, 2,3-heptanediol, 3,4-heptanediol,
1,2-octanediol, 2,3-octanediol, 3,4-octanediol,
1,2-nonanediol, 2,3-nonanediol, 3,4-nonanediol,
1,2-decanediol, 2,3-decanediol, 3,4-decanediol,
1,2-undecanediol, 2,3-undecanediol, 3,4-undecanediol,
1,2-dodecanediol, 2,3-dodecanediol, 3,4-dodecanediol,
and any mixture thereof.

Further preferred, the second linear alkanediol is selected from the group consisting of:
1,2-heptanediol, 2,3-heptanediol, 3,4-heptanediol,
1,2-octanediol, 2,3-octanediol, 3,4-octanediol,
1,2-nonanediol, 2,3-nonanediol, 3,4-nonanediol,
1,2-decanediol, 2,3-decanediol, 3,4-decanediol,
1,2-undecanediol, 2,3-undecanediol, 3,4-undecanediol,
and any mixture thereof.

Further preferred, the second linear alkanediol is selected from the group consisting of:
1,2-heptanediol, 2,3-heptanediol, 3,4-heptanediol,
1,2-octanediol, 2,3-octanediol, 3,4-octanediol,
1,2-nonanediol, 2,3-nonanediol, 3,4-nonanediol,
1,2-decanediol, 2,3-decanediol, 3,4-decanediol,
and any mixture thereof.

Most preferred, the second linear alkanediol is selected from the group consisting of:
1,2-heptanediol, 2,3-heptanediol, 3,4-heptanediol,
1,2-octanediol, 2,3-octanediol, 3,4-octanediol,
1,2-nonanediol, 2,3-nonanediol, 3,4-nonanediol,
and any mixture thereof.

Most preferred, the second linear alkanediol is selected from the group consisting of:
1,2-heptanediol, 2,3-heptanediol, 3,4-heptanediol,
1,2-octanediol, 2,3-octanediol, 3,4-octanediol,
and any mixture thereof.

According to a preferred variant, in the detergent and cleaning composition according to the present invention the second linear alkanediol is selected from the group consisting of 1,2-pentanediol, 2,3-pentanediol, 1,2-hexanediol, 2,3-hexanediol, 1,2-heptanediol, 2,3-heptanediol, 1,2-octanediol, 2,3-octanediol, 1,2-nonanediol, 2,3-nonanediol, 1,2-decanediol, 2,3-decanediol, 1,2-undecanediol, 2,3-undecanediol, 1,2-dodecanediol, 2,3-dodecanediol, 1,2-tridecanediol, 2,3-tridecanediol, and any mixture thereof.

According to a preferred variant, in the detergent and cleaning composition according to the present invention the second linear alkanediol is selected from the group consisting of 1,2-hexanediol, 2,3-hexandiol, 1,2-heptanediol, 2,3-heptanediol, 1,2-octanediol, 2,3-octanediol, 1,2-nonanediol, 2,3-nonanediol, 1,2-decanediol, 2,3-decanediol, 1,2-undecanediol, 2,3-undecanediol, 1,2-dodecanediol, 2,3-dodecanediol, 1,2-tridecanediol, 2,3-tridecanediol, 1,2-tetradecanediol, 2,3-tetradecanediol, and any mixture thereof.

According to a preferred variant, in the detergent and cleaning composition according to the present invention the second linear alkanediol is selected from the group consisting of 1,2-heptanediol, 2,3-heptanediol, 1,2-octanediol, 2,3-octanediol, 1,2-nonanediol, 2,3-nonanediol, 1,2-decanediol, 2,3-decanediol, 1,2-undecanediol, 2,3-undecanediol, 1,2-dodecanediol, 2,3-dodecanediol, 1,2-tridecanediol, 2,3-tridecanediol, 1,2-tetradecanediol, 2,3-tetradecanediol, and any mixture thereof.

According to a more preferred variant, in the detergent and cleaning composition according to the present invention the second linear alkanediol is selected from the group consisting of 1,2-heptanediol, 2,3-heptanediol, 1,2-octanediol, 2,3-octanediol, 1,2-nonanediol, 2,3-nonanediol, 1,2-decanediol, 2,3-decanediol, 1,2-undecanediol, 2,3-undecanediol, 1,2-dodecanediol, 2,3-dodecanediol, and any mixture thereof.

According to a more preferred variant, in the detergent and cleaning composition according to the present invention the second linear alkanediol is selected from the group consisting of 1,2-heptanediol, 2,3-heptanediol, 1,2-octanediol, 2,3-octanediol, 1,2-nonanediol, 2,3-nonanediol, 1,2-decanediol, 2,3-decanediol, 1,2-undecanediol, 2,3-undecanediol, and any mixture thereof.

According to an even more preferred variant, in the detergent and cleaning composition according to the present invention the second linear alkanediol is selected from the group consisting of 1,2-heptanediol, 2,3-heptanediol, 1,2-octanediol, 2,3-octanediol, 1,2-nonanediol, 2,3-nonanediol, 1,2-decanediol, 2,3-decanediol, and any mixture thereof.

According to a most preferred variant, in the detergent and cleaning composition according to the present invention the second linear alkanediol is selected from the group consisting of 1,2-heptanediol, 2,3-heptanediol, 1,2-octanediol, 2,3-octanediol, 1,2-nonanediol, 2,3-nonanediol, and any mixture thereof.

According to a most preferred variant, in the detergent and cleaning composition according to the present invention the second linear alkanediol is selected from the group consisting of 1,2-heptanediol, 2,3-heptanediol, 1,2-octanediol, 2,3-octanediol, and any mixture thereof.

Of the aforesaid second linear alkanediols, the following (x,x+1) constitutional isomers are preferred: 1,2-pentanediol, 2,3-pentanediol, 1,2-hexanediol, 2,3-hexanediol, 1,2-heptanediol, 2,3-heptanediol, 2,3-octanediol, 2,3-nonanediol, 2,3-decanediol, 2,3-undecanediol, 2,3-dodecanediol, or 2,3-tridecanediol. Said alkanediols are liquid at a purity of 90 to 99%.

Of the aforesaid liquid alkanediols 1,2-pentanediol, 2,3-pentanediol, 1,2-hexanediol, 2,3-hexanediol, 1,2-heptanediol, 2,3-heptanediol, 2,3-octanediol, 2,3-nonanediol or mixtures of said liquid alkanediols are particularly preferred.

In a further preferred variant of the detergent and cleaning composition according to the present invention, the second linear alkanediol is selected from the group consisting of:
1,2-pentanediol, 2,3-pentanediol,
1,2-hexanediol, 2,3-hexanediol,
1,2-heptanediol, 2,3-heptanediol,
1,2-octanediol, 2,3-octanediol,
1,2-nonanediol, 2,3-nonanediol,
1,2-decanediol, 2,3-decanediol,
1,2-undecanediol, 2,3-undecanediol,
1,2-dodecanediol, 2,3-dodecanediol,
1,2-tridecanediol, 2,3-tridecanediol,
1,2-tetradecanediol, 2,3-tetradecanediol,
and any mixture thereof.

More preferred, in the detergent and cleaning composition according to the present invention, the second linear alkanediol is selected from the group consisting of 1,2-pentanediol, 2,3-pentanediol, and mixtures thereof, or is selected from the group consisting of 1,2-heptanediol, 2,3-heptanediol, and mixtures thereof. However, the second linear alkanediol can also preferably be selected from the group consisting of 1,2-octanediol, 2,3-octanediol, and mixtures thereof.

Even more preferred, in the detergent and cleaning composition according to the present invention, the second linear alkanediol is an alpha,beta or a beta,gamma diol as either 1,2-pentanediol or 2,3-pentanediol or a mixture thereof. However, the second linear alkanediol can also preferably be an alpha,beta or a beta,gamma diol as either 1,2-hexanediol or 2,3-hexanediol or a mixture thereof. A mixture comprising 1,2-pentanediol and 2,3-hexanediol or a mixture comprising 2,3-pentanediol and 1,2-hexanediol is also possible.

Most preferred, the second linear alkanediol is 1,2-pentanediol or 2,3-pentanediol or 1,2-hexanediol or 2,3-hexanediol or 1,2-heptanediol or 2,3-heptanediol, or 2,3-octanediol or 2,3-nonanediol.

Likewise, in a further preferred variant of the detergent and cleaning composition according to the present invention, the second linear alkanediol is selected from the group consisting of 1,2-nonanediol, 2,3-nonanediol, 1,2-decanediol, 2,3-decanediol, 1,2-undecanediol, 2,3-undecanediol, 1,2-dodecanediol, 2,3-dodecanediol, and any mixture thereof.

More preferred, in the detergent and cleaning composition according to the present invention, the second linear alkanediol is selected from the group consisting of 1,2-nonanediol, 2,3-nonanediol, and mixtures thereof, or can also be preferably selected form the group consisting of 1,2-decanediol, 2,3-decanediol, and mixtures thereof, or can also be preferably selected from the group consisting of 1,2-undecanediol, 2,3-undecanediol, and mixtures thereof.

In a more preferred variant, the at least one second linear alkanediol is selected from the group consisting of 1,2-alkanediols having a number of carbon atoms of 6 to 14, i.e. 1,2-hexanediol, 1,2-heptanediol, 1,2-octanediol, 1,2-nonanediol, 1,2-decanediol, 1,2-undecanediol, 1,2-dodecanediol, 1,2-tridecanediol, 1,2-tetradecanediol, and any mixture thereof, or is selected from the group consisting of 1,2-alkanediols having a number of carbon atoms of 7 to 14, i.e. 1,2-heptanediol, 1,2-octanediol, 1,2-nonanediol, 1,2-decanediol, 1,2-undecanediol, 1,2-dodecanediol, 1,2-tridecanediol, 1,2-tetradecanediol, and any mixture thereof, or is selected from the group consisting of 1,2-alkanediols having a number of carbon atoms of 7 to 12, i.e. 1,2-heptanediol, 1,2-octanediol, 1,2-nonanediol, 1,2-decanediol, 1,2-undecanediol, 1,2-dodecanediol, and any mixture thereof, or is selected from the group consisting of 1,2-alkanediols having a number of carbon atoms of 7 to 11, i.e. 1,2-heptanediol, 1,2-octanediol, 1,2-nonanediol, 1,2-decanediol, 1,2-undecanediol, and any mixture thereof, or is selected from the group consisting of 1,2-alkanediols having a number of carbon atoms of 7 to 10, i.e. 1,2-heptanediol, 1,2-octanediol, 1,2-nonanediol, 1,2-decanediol, and any mixture thereof, or is selected form the group consisting of 1,2-alkanediols having a number of carbon atoms of 7 to 9, i.e. 1,2-heptanediol, 1,2-octanediol, 1,2-nonanediol, and any mixture thereof, or is selected form the group consisting of 1,2-alkanediols having a number of carbon atoms of 7 and 8, i.e. 1,2-heptanediol, 1,2-octanediol, and any mixture thereof.

It was found that these 1,2-alkanediols show particular pronounced enzyme stabilizing properties. Said alkanediols are thus efficient for use as enzyme stabilizing agents in detergents and cleaning compositions comprising an enzyme. The improved enzyme stability in the detergents and cleaning compositions in turn results in a better cleaning performance, even when the composition is stored.

In a more preferred variant, the second linear alkanediol is selected from the group consisting of 1,2-alkanediols having a lower number of carbon atoms of 5 to 8, i.e. 1,2-pentanediol, 1,2-hexanediol, 1,2-heptanediol, 1,2-octanediol, and any mixture thereof, or is selected from the group consisting of 1,2-alkanediols having a number of carbon atoms of 6 to 8, i.e. 1,2-hexanediol, 1,2-heptanediol, 1,2-octanediol, and any mixture thereof, or is selected from the group consisting of 1,2-alkanediols having a number of carbon atoms of 7 and 8, i.e. 1,2-heptanediol, 1,2-octanediol, and any mixture thereof.

In a still more preferred variant, the second linear alkanediol is either 1,2-pentanediol or 1,2-hexanediol or 1,2-heptanediol or 1,2-octanediol or any mixture thereof. In a still more preferred variant, the second linear alkanediol is either 1,2-heptanediol or 1,2-octanediol or any mixture thereof.

In a most preferred variant, the second linear alkanediol is 1,2-heptanediol.

It was found that these alkanediols show particular pronounced enzyme stabilizing properties. 1,2-Alkanediols having a lower number of carbon atoms are thus efficient for use as enzyme stabilizing agents in detergents and cleaning compositions comprising an enzyme. The improved enzyme stability in the detergents and cleaning compositions results in a better cleaning performance.

In a still more preferred variant, the second linear alkanediol is selected from the group consisting of 1,2-alkanediols having a higher number of carbon atoms of 9 to 14, i.e. 1,2-nonanediol, 1,2-decanediol, 1,2-undecanediol, 1,2-dodecanediol, 1,2-tridecanediol, 1,2-tetradecanediol, and any mixture thereof, or is selected from the group consisting of 1,2-alkanediols having a number of carbon atoms of 9 to 13, i.e. 1,2-nonanediol, 1,2-decanediol, 1,2-undecanediol, 1,2-dodecanediol, 1,2-tridecanediol, and any mixture thereof, or is selected from the group consisting of 1,2-alkanediols having a number of carbon atoms of 9 to 12, i.e. 1,2-nonanediol, 1,2-decanediol, 1,2-undecanediol, 1,2-dodecanediol, and any mixture thereof, or is selected from the group consisting of 1,2-alkanediols having a number of carbon atoms of 9 to 11, i.e. 1,2-nonanediol, 1,2-decanediol, 1,2-undecanediol, and any mixture thereof, or is selected from the group consisting of 1,2-alkanediols having a number of carbon atoms of 9 and 10, i.e. 1,2-nonanediol, 1,2-decanediol, and any mixture thereof.

In a still more preferred variant, the second linear alkanediol is either 1,2-nonanediol or 1,2-decanediol or 1,2-undecanediol or 1,2-dodecanediol or any mixture thereof.

According to a preferred variant, the second linear alkanediol is selected from the group consisting of 1,2-alkanediols having a higher number of carbon atoms, and more specifically more than 10 carbon atoms, i.e. 1,2-undecanediol, 1,2-dodecanediol, 1,2-tridecanediol, or 1,2-tetradecanediol.

It was found that these alkanediols show better enzyme stabilizing properties. 1,2-Alkanediols having a higher number of carbon atoms, and more specifically more than 10 carbon atoms, are thus efficient for use as enzyme stabilizing agents in detergents and cleaning compositions comprising an enzyme. The improved enzyme stability in the detergents and cleaning compositions results in a better cleaning performance.

In a more preferred variant, the at least one second linear alkanediol is selected from the group consisting of 2,3-alkanediols having a number of carbon atoms of 6 to 14, i.e. 2,3-hexanediol, 2,3-heptanediol, 2,3-octanediol, 2,3-nonanediol, 2,3-decanediol, 2,3-undecanediol, 2,3-dodecanediol, 2,3-tridecanediol, 2,3-tetradecanediol, and any mixture thereof, or is selected from the group consisting of 2,3-alkanediols having a number of carbon atoms of 7 to 14, i.e. 2,3-heptanediol, 2,3-octanediol, 2,3-nonanediol, 2,3-decanediol, 2,3-undecanediol, 2,3-dodecanediol, 2,3-tridecanediol, 2,3-tetradecanediol, and any mixture thereof, or is selected from the group consisting of 2,3-alkanediols having a number of carbon atoms of 7 to 12, i.e. 2,3-heptanediol, 2,3-octanediol, 2,3-nonanediol, 2,3-decanediol, 2,3-undecanediol, 2,3-dodecanediol, and any mixture thereof, or is selected from the group consisting of 2,3-alkanediols having a number of carbon atoms of 7 to 11, i.e. 2,3-heptanediol, 2,3-octanediol, 2,3-nonanediol, 2,3-decanediol, 2,3-undecanediol, and any mixture thereof, or is selected from the group consisting of 2,3-alkanediols having a number of carbon atoms of 7 to 10, i.e. 2,3-heptanediol, 2,3-octanediol, 2,3-nonanediol, 2,3-decanediol, and any mixture thereof, or is selected form the group consisting of 2,3-alkanediols having a number of carbon atoms of 7 to 9, i.e. 2,3-heptanediol, 2,3-octanediol, 2,3-nonanediol, and any mixture thereof, or is selected form the group consisting of 2,3-alkanediols having a number of carbon atoms of 7 and 8, i.e. 2,3-heptanediol, 2,3-octanediol, and any mixture thereof.

It was found that said 2,3-alkanediols show particular pronounced enzyme stabilizing properties. Said alkanediols are thus efficient for use as enzyme stabilizing agents in detergents and cleaning compositions comprising an enzyme. The improved enzyme stability in the detergents and cleaning compositions in turn results in a better cleaning performance after storage, compared to detergents and cleaning compositions without the addition of such alkanediols.

In a still more preferred variant, the second linear alkanediol is selected from the group consisting of 2,3-alkanediols having a lower number of carbon atoms of 5 to 8, i.e. 2,3-pentanediol, 2,3-hexanediol, 2,3-heptanediol, 2,3-octanediol, and any mixture thereof, or is selected from the group consisting of 2,3-alkanediols having a number of carbon atoms of 6 to 8, i.e. 2,3-hexanediol, 2,3-heptanediol, 2,3-octanediol, and any mixture thereof, or is selected from the group consisting of 2,3-alkanediols having a number of carbon atoms of 7 and 8, i.e. 1,2-heptanediol, 1,2-octanediol, and any mixture thereof.

In a still more preferred variant, the second linear alkanediol is either 2,3-pentanediol or 2,3-hexanediol or 2,3-heptanediol or 2,3-octanediol or any mixture thereof. In a still more preferred variant, the second linear alkanediol is either 2,3-heptanediol or 2,3-octanediol or any mixture thereof.

In a most preferred variant, the second linear alkanediol is 2,3-heptanediol.

It was found that these alkanediols show particular pronounced enzyme stabilizing properties. 2,3-Alkanediols having a lower number of carbon atoms are thus efficient for use as enzyme stabilizing agents in detergents and cleaning compositions comprising an enzyme. The improved enzyme stability in the detergents and cleaning compositions results in a better cleaning performance.

In a still more preferred variant, the second linear alkanediol is selected from the group consisting of 2,3-alkanediols having a higher number of carbon atoms of 9 to 14, i.e. 2,3-nonanediol, 2,3-decanediol, 2,3-undecanediol, 2,3-dodecanediol, 2,3-tridecanediol, 2,3-tetradecanediol, and any mixture thereof, or is selected from the group consisting of 2,3-alkanediols having a number of carbon atoms of 9 to 13, i.e. 2.3-nonanediol, 2,3-decanediol, 2,3-undecanediol, 2,3-dodecanediol, 2,3-tridecanediol, and any mixture thereof, or is selected from the group consisting of 2,3-alkanediols having a number of carbon atoms of 9 to 12, i.e. 2.3-nonanediol, 2,3-decanediol, 2,3-undecanediol, 2,3-dodecanediol, and any mixture thereof, or is selected from the group consisting of 2,3-alkanediols having a number of carbon atoms of 9 to 11, i.e. 2,3-nonanediol, 2,3-decanediol, 2,3-undecanediol, and any mixture thereof, or is selected from the group consisting of 2,3-alkanediols having a number of carbon atoms of 9 and 10, i.e. 2,3-nonanediol, 2,3-decanediol, and any mixture thereof.

In a still more preferred variant, the second linear alkanediol is either 2,3-nonanediol or 2,3-decanediol or 2,3-undecanediol or 2,3-dodecanediol or any mixture thereof.

According to a preferred variant, the second linear alkanediol is selected from the group consisting of 2,3-alkanediols having a higher number of carbon atoms, and more specifically more than 10 carbon atoms, i.e. 2,3-undecanediol, 2,3-dodecanediol, 2,3-tridecanediol, or 2,3-tetradecanediol.

It was found that these alkanediols show better enzyme stabilizing properties. 2,3-Alkanediols having a higher number of carbon atoms, and more specifically more than 10 carbon atoms are thus efficient for use as enzyme stabilizing agents in detergents and cleaning compositions comprising an enzyme. The improved enzyme stability in the detergents and cleaning compositions results in a better cleaning performance.

In a further preferred variant, in the detergent and cleaning composition according to the present invention the at least one linear alkanediol or the first linear alkanediol is selected from the group consisting of 1,2-pentanediol, 2,3-pentanediol, 1,2-hexanediol, 2,3-hexanediol, 1,2-heptanediol, 2,3-heptanediol, 1,2-octanediol, 2,3-octanediol, 1,2-nonanediol, 2,3-nonanediol, 1,2-decanediol, 2,3-decanediol, 1,2-undecanediol, 2,3-undecanediol, 1,2-dodecanediol, 2,3-dodecanediol, 1,2-tridecanediol, 2,3-tridecanediol, 1,2-tetradecanediol, 2,3-tetradecanediol, and any mixture thereof; and/or the second linear alkanediol is selected from the group consisting of 1,2-pentanediol, 2,3-pentanediol, 1,2-hexanediol, 2,3-hexanediol, 1,2-heptanediol, 2,3-heptanediol, 1,2-octanediol, 2,3-octanediol, 1,2-nonanediol, 2,3-nonanediol, 1,2-decanediol, 2,3-decanediol, 1,2-undecanediol, 2,3-undecanediol, 1,2-dodecanediol, 2,3-dodecanediol, 1,2-tridecanediol, 2,3-tridecanediol, 1,2-tetradecanediol, 2,3-tetradecanediol, and any mixture thereof.

In a more preferred variant, the detergent and cleaning composition according to the present invention which comprises a mixture or a combination comprising at least one first linear alkanediol and one or more second linear alkanediol thus includes any one of the following mixtures/combinations:
1,2-pentanediol in combination with one of 1,2-hexanediol, 1,2-heptanediol, 1,2-octanediol, 1,2-nonanediol, 1,2-decanediol, 1,2-undecanediol, 1,2-dodecanediol, 1,2-tridecanediol, or 1,2-tetradecanediol; or
1,2-hexanediol in combination with one of 1,2-pentanediol, 1,2-heptanediol, 1,2-octanediol, 1,2-nonanediol, 1,2-decanediol, 1,2-undecanediol, 1,2-dodecanediol, 1,2-tridecanediol, or 1,2-tetradecanediol; or
1,2-heptanediol in combination with one of 1,2-pentanediol, 1,2-hexanediol, 1,2-octanediol, 1,2-nonanediol, 1,2-decanediol, 1,2-undecanediol, 1,2-dodecanediol, 1,2-tridecanediol, or 1,2-tetradecanediol; or
1,2-octanediol in combination with one of 1,2-pentanediol, 1,2-hexanediol, 1,2-heptanediol, 1,2-nonanediol, 1,2-decanediol, 1,2-undecanediol, 1,2-dodecanediol, 1,2-tridecanediol, or 1,2-tetradecanediol; or
1,2-nonanediol in combination with one of 1,2-pentanediol, 1,2-hexanediol, 1,2-heptanediol, 1,2-octanediol, 1,2-decanediol, 1,2-undecanediol, 1,2-dodecanediol, 1,2-tridecanediol, or 1,2-tetradecanediol; or
1,2-decanediol in combination with one of 1,2-pentanediol, 1,2-hexanediol, 1,2-heptanediol, 1,2-octanediol, 1,2-nonanediol, 1,2-undecanediol, 1,2-dodecanediol, 1,2-tridecanediol, or 1,2-tetradecanediol; or
1,2-undecanediol in combination with one of 1,2-pentanediol, 1,2-hexanediol, 1,2-heptanediol, 1,2-octanediol, 1,2-nonanediol, 1,2-decanediol, 1,2-dodecanediol, 1,2-tridecanediol, or 1,2-tetradecanediol; or
1,2-dodecanediol in combination with one of 1,2-pentanediol, 1,2-hexanediol, 1,2-heptanediol, 1,2-octanediol, 1,2-nonanediol, 1,2-decanediol, 1,2-undecanediol, 1,2-tridecanediol, or 1,2-tetradecanediol; or
1,2-tridecanediol in combination with one of 1,2-pentanediol, 1,2-hexanediol, 1,2-heptanediol, 1,2-octanediol, 1,2-nonanediol, 1,2-decanediol, 1,2-undecanediol, 1,2-dodecanediol, or 1,2-tetradecanediol; or
1,2-tetradecanediol in combination with one of 1,2-pentanediol, 1,2-hexanediol, 1,2-heptanediol, 1,2-octanediol, 1,2-nonanediol, 1,2-decanediol, 1,2-undecanediol, 1,2-dodecanediol, or 1,2-tridecanediol; or
1,2-pentanediol in combination with one of 2,3-pentanediol, 2,3-hexanediol, 2,3-heptanediol, 2,3-octanediol, 2,3-nonanediol, 2,3-decanediol, 2,3-undecanediol, 2,3-dodecanediol, 2,3-tridecanediol, 2,3-tetradecanediol; or
1,2-hexanediol in combination with one of 2,3-pentanediol, 2,3-hexanediol, 2,3-heptanediol, 2,3-octanediol, 2,3-nonanediol, 2,3-decanediol, 2,3-undecanediol, 2,3-dodecanediol, 2,3-tridecanediol, 2,3-tetradecanediol; or
1,2-heptanediol in combination with one of 2,3-pentanediol, 2,3-hexanediol, 2,3-heptanediol, 2,3-octanediol, 2,3-nonanediol, 2,3-decanediol, 2,3-undecanediol, 2,3-dodecanediol, 2,3-tridecanediol, 2,3-tetradecanediol; or
1,2-octanediol in combination with one of 2,3-pentanediol, 2,3-hexanediol, 2,3-heptanediol, 2,3-octanediol, 2,3-nonanediol, 2,3-decanediol, 2,3-undecanediol, 2,3-dodecanediol, 2,3-tridecanediol, 2,3-tetradecanediol; or
1,2-nonanediol in combination with one of 2,3-pentanediol, 2,3-hexanediol, 2,3-heptanediol, 2,3-octanediol, 2,3-nonanediol, 2,3-decanediol, 2,3-undecanediol, 2,3-dodecanediol, 2,3-tridecanediol, 2,3-tetradecanediol; or
1,2-decanediol in combination with one of 2,3-pentanediol, 2,3-hexanediol, 2,3-heptanediol, 2,3-octanediol, 2,3-nonanediol, 2,3-decanediol, 2,3-undecanediol, 2,3-dodecanediol, 2,3-tridecanediol, 2,3-tetradecanediol; or
1,2-undecanediol in combination with one of 2,3-pentanediol, 2,3-hexanediol, 2,3-heptanediol, 2,3-octanediol, 2,3-nonanediol, 2,3-decanediol, 2,3-undecanediol, 2,3-dodecanediol, 2,3-tridecanediol, 2,3-tetradecanediol; or
1,2-dodecanediol in combination with one of 2,3-pentanediol, 2,3-hexanediol, 2,3-heptanediol, 2,3-octanediol, 2,3-nonanediol, 2,3-decanediol, 2,3-undecanediol, 2,3-dodecanediol, 2,3-tridecanediol, 2,3-tetradecanediol; or
1,2-tridecanediol in combination with one of 2,3-pentanediol, 2,3-hexanediol, 2,3-heptanediol, 2,3-octanediol, 2,3-nonanediol, 2,3-docanediol, 2,3-undecanediol, 2,3-dodecanediol, 2,3-tridecanediol, 2,3-tetradecanediol; or
1,2-tetradecanediol in combination with one of 2,3-pentanediol, 2,3-hexanediol, 2,3-heptanediol, 2,3-octanediol, 2,3-nonanediol, 2,3-decanediol, 2,3-undecanediol, 2,3-dodecanediol, 2,3-tridecanediol, 2,3-tetradecanediol; or
2,3-pentanediol in combination with one of 1,2-pentanediol, 1,2-hexanediol, 1,2-heptanediol, 1,2-octanediol, 1,2-nonanediol, 1,2-decanediol, 1,2-undecanediol, 1,2-dodecanediol, 1,2-tridecanediol, or 1,2-tetradecanediol; or
2,3-hexanediol in combination with one of 1,2-pentanediol, 1,2-heptanediol, 1,2-octanediol, 1,2-nonanediol, 1,2-decanediol, 1,2-undecanediol, 1,2-dodecanediol, 1,2-tridecanediol, or 1,2-tetradecanediol; or
2,3-heptanediol in combination with one of 1,2-pentanediol, 1,2-hexanediol, 1,2-octanediol, 1,2-nonanediol, 1,2-decanediol, 1,2-undecanediol, 1,2-dodecanediol, 1,2-tridecanediol, or 1,2-tetradecanediol; or
2,3-octanediol in combination with one of 1,2-pentanediol, 1,2-hexanediol, 1,2-heptanediol, 1,2-nonanediol, 1,2-decanediol, 1,2-undecanediol, 1,2-dodecanediol, 1,2-tridecanediol, or 1,2-tetradecanediol; or
2,3-nonanediol in combination with one of 1,2-pentanediol, 1,2-hexanediol, 1,2-heptanediol, 1,2-octanediol, 1,2-decanediol, 1,2-undecanediol, 1,2-dodecanediol, 1,2-tridecanediol, or 1,2-tetradecanediol; or
2,3-decanediol in combination with one of 1,2-pentanediol, 1,2-hexanediol, 1,2-heptanediol, 1,2-octanediol, 1,2-nonanediol, 1,2-undecanediol, 1,2-dodecanediol, 1,2-tridecanediol, or 1,2-tetradecanediol; or
2,3-undecanediol in combination with one of 1,2-pentanediol, 1,2-hexanediol, 1,2-heptanediol, 1,2-octanediol, 1,2-nonanediol, 1,2-decanediol, 1,2-dodecanediol, 1,2-tridecanediol, or 1,2-tetradecanediol; or
2,3-dodecanediol in combination with one of 1,2-pentanediol, 1,2-hexanediol, 1,2-heptanediol, 1,2-octanediol, 1,2-nonanediol, 1,2-decanediol, 1,2-undecanediol, 1,2-tridecanediol, or 1,2-tetradecanediol; or
2,3-tridecanediol in combination with one of 1,2-pentanediol, 1,2-hexanediol, 1,2-heptanediol, 1,2-octanediol, 1,2-nonanediol, 1,2-decanediol, 1,2-undecanediol, 1,2-dodecanediol, or 1,2-tetradecanediol;
2,3-tetradecanediol in combination with one of 1,2-pentanediol, 1,2-hexanediol, 1,2-heptanediol, 1,2-octanediol, 1,2-nonanediol, 1,2-decanediol, 1,2-undecanediol, 1,2-dodecanediol, or 1,2-tridecanedio; or
2,3-pentanediol in combination with one of 2,3-hexanediol, 2,3-heptanediol, 2,3-octanediol, 2,3-nonanediol, 2,3-decanediol, 2,3-undecanediol, 2,3-dodecanediol, 2,3-tridecanediol, or 2,3-tetradecanediol; or
2,3-hexanediol in combination with one of 2,3-pentanediol, 2,3-heptanediol, 2,3-octanediol, 2,3-nonanediol, 2,3-decanediol, 2,3-undecanediol, 2,3-dodecanediol, 2,3-tridecanediol, or 2,3-tetradecanediol; or
2,3-heptanediol in combination with one of 2,3-pentanediol, 2,3-hexanediol, 2,3-octanediol, 2,3-nonanediol, 2,3-decanediol, 2,3-undecanediol, 2,3-dodecanediol, 2,3-tridecanediol, or 2,3-tetradecanediol; or
2,3-octanediol in combination with one of 2,3-pentanediol, 2,3-hexanediol, 2,3-heptanediol, 2,3-nonanediol, 2,3-decanediol, 2,3-undecanediol, 2,3-dodecanediol, 2,3-tridecanediol, or 2,3-tetradecanediol; or
2,3-nonanediol in combination with one of 2,3-pentanediol, 2,3-hexanediol, 2,3-heptanediol, 2,3-octanediol, 2,3-decanediol, 2,3-undecanediol, 2,3-dodecanediol, 2,3-tridecanediol, or 2,3-tetradecanediol; or
2,3-decanediol in combination with one of 2,3-pentanediol, 2,3-hexanediol, 2,3-heptanediol, 2,3-octanediol, 2,3-nonanediol, 2,3-undecanediol, 2,3-dodecanediol, 2,3-tridecanediol, or 2,3-tetradecanediol; or
2,3-undecanediol in combination with one of 2,3-pentanediol, 2,3-hexanediol, 2,3-heptanediol, 2,3-octanediol, 2,3-nonanediol, 2,3-decanediol, 2,3-dodecanediol, 2,3-tridecanediol, or 2,3-tetradecanediol; or
2,3-dodecanediol in combination with one of 2,3-pentanediol, 2,3-hexanediol, 2,3-heptanediol, 2,3-octanediol, 2,3-nonanediol, 2,3-decanediol, 2,3-undecanediol, 2,3-tridecanediol, or 2,3-tetradecanediol; or
2,3-tridecanediol in combination with one of 2,3-pentanediol, 2,3-hexanediol, 2,3-heptanediol, 2,3-octanediol, 2,3-nonanediol, 2,3-decanediol, 2,3-undecanediol, 2,3-dodecanediol, or 2,3-tetradecanediol; or
2,3-tetradecanediol in combination with one of 2,3-pentanediol, 2,3-hexanediol, 2,3-heptanediol, 2,3-octanediol, 2,3-nonanediol, 2,3-decanediol, 2,3-undecanediol, 2,3-dodecanediol or 2,3-tridecanediol.

In a particular preferred variant, in the detergent and cleaning composition according to the present invention, the linear alkanediol is selected from the group consisting of 1,2-pentanediol, 1,2-hexanediol, 1,2-heptanediol, 1,2-octanediol, 1,2-nonanediol, 1,2-decanediol, 1,2-undecanediol, 1,2-dodecanediol, 1,2-tridecanediol, 1,2-tetradecanediol, and any mixture thereof.

In a more particular preferred variant, the detergent and cleaning composition according to the present invention which comprises a mixture or a combination comprising at least one first linear alkanediol and one or more second linear alkanediol includes any one of the following mixtures/combinations:
a mixture comprising 1,2-pentanediol and 2,3-pentanediol; or
a mixture comprising 1,2-hexanediol and 2,3-hexanediol; or
a mixture comprising 1,2-heptanediol and 2,3-heptanediol; or
a mixture comprising 1,2-octanediol and 2,3-octanediol; or
a mixture comprising 1,2-nonanediol and 2,3-nonanediol; or
a mixture comprising 1,2-decanediol and 2,3-decanediol; or
a mixture comprising 1,2-undecanediol and 2,3-undecanediol; or
a mixture comprising 1,2-dodecanediol and 2,3-dodecanediol; or
a mixture comprising 1,2-tridecanediol and 2,3-tridecanediol; or
a mixture comprising 1,2-tetradecanediol and 2,3-tetradecanediol.

In said homo alkanediol mixtures the first linear alkanediol and the second linear alkanediol have the same number of carbon atoms.

Particularly favourable is a mixture including 1,2-pentanediol in combination with 2,3-pentanediol or a mixture including 1,2-heptanediol in combination with 2,3-heptanediol, or a mixture including 1,2-octanediol in combination with 2,3-octanediol and/or 3,4-octanediol.

Due to their outstanding enzyme stabilizing effect a homo alkanediol mixture comprising 1,2-nonanediol and 2,3-nonanediol or a homo alkanediol mixture comprising 1,2-decanediol and 2,3-decanediol or a homo alkanediol mixture comprising 1,2-undecanediol and 2,3-undecanediol are most preferred.

The above specified homo alkanediol mixtures according to the second aspect of the present invention, comprising a 1,2-alkanediol and a 2,3-alkanediol are characterized by a synergistically intensified action, i.e. the alkanediol mixtures stabilize an enzyme in a detergent and cleaning composition in a synergistic way compared to their respective single 1,2-alkanediol or 2,3-alkanediol substances.

Said synergistic effect or action in stabilizing an enzyme was found for the homo mixture including 1,2-pentanediol and 2,3-pentanediol.

Said synergistic effect in stabilizing an enzyme is also observed for the homo mixture including 1,2-hexanediol and 2,3-hexanediol.

The homo mixture including 1,2-heptanediol and 2,3-heptanediol is particularly beneficial since it has a particular pronounced synergistic effect on the enzyme stabilization in a detergent and cleaning composition.

The alkanediol mixture comprising 1,2-octanediol and 2,3-octanediol or the alkanediol mixture comprising 1,2-nonanediol and 2,3-nonanediol are particularly advantageous, since the mixtures are effective in synergistically stabilizing an enzyme in an enzymatic detergent and cleaning composition.

Also, the alkanediol mixture comprising 1,2-decanediol and 2,3-decanediol or the alkanediol mixture comprising 1,2-undecanediol and 2,3-undecanediol synergistically stabilizes an enzyme in a detergent and cleaning composition.

An enzyme stabilizing effect is also true for an alkanediol mixture including 1,2-dodecanediol and 2,3-dodecanediol or an alkanediol mixture including 1,2-tridecanediol and 2,3-tridecanediol.

The afore-mentioned synergistically stabilizing effect towards the performance of enzymes in a detergent and cleaning composition is particularly pronounced for the homo mixture including 1,2-heptanediol and 2,3-heptanediol or the homo mixture including 1,2-octanediol and 2,3-octanediol or the homo mixture including 1,2-nonanediol and 2,3-nonanediol.

The afore specified homo alkanediol mixtures including a 1,2-alkanediol and the corresponding 2,3-alkanediol display a remarkably synergistic activity and are clearly superior to the individually corresponding 1,2-alkanediols or 2,3-alkanediols and having the same concentration.

In a particular preferred variant, the detergent and cleaning composition according to the second aspect of the present invention which comprises a mixture or a combination comprising at least one first linear alkanediol and one or more second linear alkanediol thus may include any of the following mixtures/combinations:
a mixture comprising 1,2-hexanediol and 1,2-octanediol; or
a mixture comprising 1,2-hexanediol and 2,3-octanediol; or
a mixture comprising 1,2-octanediol and 2,3-hexanediol; or
a mixture comprising 1,2-octanediol and 2,3-heptanediol; or
a mixture comprising 1,2-pentanediol and 2,3-hexanediol; or
a mixture comprising 1,2-pentanediol and 2,3-heptanediol; or
a mixture comprising 1,2-pentanediol and 2,3-octanediol; or
a mixture comprising 1,2-pentanediol and 1,2-nonanediol; or
a mixture comprising 1,2-pentanediol and 2,3-nonanediol; or
a mixture comprising 1,2-heptanediol and 1,2-pentanediol; or
a mixture comprising 1,2-heptanediol and 1,2-hexanediol; or
a mixture comprising 1,2-heptanediol and 1,2-octanediol; or
a mixture comprising 1,2-heptanediol and 2,3-octanediol; or
a mixture comprising 1,2-heptanediol and 1,2-nonanediol; or
a mixture comprising 1,2-heptanediol and 2,3-nonanediol; or
a mixture comprising 1,2-heptanediol and 1,2-decanediol; or
a mixture comprising 1,2-heptanediol and 1,2-undecanediol; or
a mixture comprising 1,2-heptanediol and 1,2-dodecanediol; or
a mixture comprising 1,2-heptanediol and 1,2-tridecanediol.

The above specified alkanediol mixtures according to the present invention, comprising a first linear alkanediol and a second linear alkanediol, are characterized by synergistically intensified action, i.e. the alkanediol mixtures stabilize the enzymes in a detergent and cleaning composition in a synergistic way compared to the corresponding individual 1,2-alkanediol or 2,3-alkanediol substances.

In a particular preferred variant, the detergent and cleaning composition according to the present invention which comprises a mixture or a combination comprising at least one first linear alkanediol and one or more second linear alkanediol thus may include the following mixture/combination:
a mixture comprising 1,2-hexanediol and 1,2-octanediol.

Surprisingly, said alkanediol mixture has a particularly pronounced enzyme stabilizing effect.

Still more preferred is an enzyme stabilizing agent mixture, wherein the at least first linear alkanediol is selected from a 1,2-alkanediol having a lower number of carbon atoms from 5 to 8 and the one or more second alkanediol is selected from a 1,2-alkanediol having a higher number of carbon atoms from 9 to 14.

Most preferred is an enzyme stabilizing agent mixture, wherein the at least first linear alkanediol is selected from the group consisting of 1,2-pentanediol, 1,2-hexanediol, 1,2-heptanediol, 1,2-octanediol, and any mixture thereof, and the one or more second alkanediol is selected from the group consisting of 1,2-nonanediol, 1,2-decanediol, 1,2-undecanediol, 1,2-dodecanediol, 1,2-tridecanediol, 1,2-tetradecanediol, and any mixture thereof.

Most preferred is an enzyme stabilizing agent blend, wherein the at least one first linear alkanediol is selected from the group consisting of 1,2-alkanediols having a lower number of carbon atoms of 5 to 8, i.e. 1,2-pentanediol, 1,2-hexanediol, 1,2-heptanediol, 1,2-octanediol, and any mixture thereof, and the one or more second alkanediol is selected from the group consisting of 1,2-alkanediols having a higher number of carbon atoms of 9 to 13, i.e. 1,2-nonanediol, 1,2-decanediol, 1,2-undecanediol, 1,2-dodecanediol, 1,2-tridecanediol, and any mixture thereof.

Surprisingly, such alkanediol mixtures of short chain alkanediols and long chain alkanediols have a particularly pronounced enzyme stabilizing effect.

More preferred are such alkanediol mixtures, wherein the difference between the number of carbon atoms of the at least first linear alkanediol and the number of carbon atoms of the one or more second alkanediol is at least 2 carbon atoms. In those alkanediol mixtures, short-chained and long-chained alkanediols are combined with each other resulting in improved enzyme stabilization.

Still more preferred is an enzyme stabilizing agent mixture, wherein the difference between the number of carbon atoms of the at least first linear alkanediol and the number of carbon atoms of the one or more second alkanediol is at least 3 carbon atoms. With such alkanediol mixtures, the enzyme stabilization effect is particularly pronounced.

Such combinations may include any of the following mixtures/combinations:
1,2-pentanediol in combination with one of 1,2-octanediol, 1,2-nonanediol, 1,2-decanediol, 1,2-undecanediol, 1,2-dodecanediol, 1,2-tridecanediol or 1,2-tetradecanediol; or
1,2-hexanediol in combination with one of 1,2-nonanediol, 1,2-decanediol, 1,2-undecanediol, 1,2-dodecanediol, 1,2-tridecanediol, 1,2-tetradecanediol; or
1,2-heptanediol in combination with one of 1,2-decanediol, 1,2-undecanediol, 1,2-dodecanediol, 1,2-tridecanediol, 1,2-tetradecanediol; and
1,2-octanediol in combination with one of 1,2-undecanediol, 1,2-dodecanediol, 1,2-tridecanediol or 1,2-tetradecanediol.

In a further preferred variant according to the present invention in the detergent and cleaning composition the linear alkanediol is selected from the group consisting of 2,3-pentanediol, 2,3-hexanediol, 2,3-heptanediol, 2,3-octanediol, 2,3-nonanediol, 2,3-decanediol, 2,3-undecanediol, 2,3-dodecanediol, 2,3-tridecanediol, 2,3-tetradecanediol and mixtures thereof.

In a more preferred variant of the detergent and cleaning composition according to the other aspect of the present invention, the linear alkanediol is selected from the group consisting of 2,3-pentanediol, 2,3-hexanediol, 2,3-heptanediol, 2,3-octanediol, 2,3-nonanediol, and mixtures thereof.

Surprisingly, the addition of 2,3-pentanediol, 2,3-hexanediol, 2,3-heptanediol as well as other 2,3-alkanediols such as 2,3-octanediol, 2,3-nonanediol, 2,3-decanediol, 2,3-undecanediol, 2,3-dodecanediol, 2,3-tridecanediol, and 2,3-tetradecanediol to a detergent and cleaning composition comprising an enzyme result in a remarkable stabilization of said enzyme, compared to the composition without the addition of an 2,3-alkanediol.

According to a particularly preferred variant, the detergent and cleaning composition according to the present invention comprises at least one enzyme stabilizing agent selected from the group consisting of at least one linear 1,2-alkanediol having a carbon chain of 6 to 14 atoms, or a mixture comprising at least one first linear 1,2-alkanediol having a carbon chain of 6 to 14 carbon atoms and one or more second linear 1,2-alkanediol having a carbon chain of 6 to 14 carbon atoms, which is different from the first linear 1,2-alkanediol.

According to a particularly preferred variant, the detergent and cleaning composition according to the present invention comprises at least one enzyme stabilizing agent selected from the group consisting of at least one linear 1,2-alkanediol having a carbon chain of 7 to 14 atoms, or a mixture comprising at least one first linear 1,2-alkanediol having a carbon chain of 7 to 14 carbon atoms and one or more second linear 1,2-alkanediol having a carbon chain of 7 to 14 carbon atoms, which is different from the first linear 1,2-alkanediol.

Surprisingly, it was found that these 1,2-alkanediols having a carbon chain of 6 to 14 or 7 to 14 carbon atoms are particularly efficient enzyme stabilizing agents, which can also efficiently be incorporated into a broad range of detergents and cleaning compositions. The improved enzyme stability in the detergents and cleaning compositions on the other hand results in a better cleaning performance after storage, compared to a detergents and cleaning composition without the addition of such alkanediols stabilizing agents.

According to a particularly preferred variant, the detergent and cleaning composition according to the present invention comprises at least one enzyme stabilizing agent selected from the group consisting of at least one linear 1,2-alkanediol having a carbon chain of 5 to 8 atoms, or a mixture comprising at least one first linear 1,2-alkanediol having a carbon chain of 5 to 8 carbon atoms and one or more second linear 1,2-alkanediol having a carbon chain of 5 to 8 carbon atoms, which is different from the first linear 1,2-alkanediol.

In a still more preferred variant, the detergent and cleaning composition according to the present invention comprises at least one enzyme stabilizing agent selected from the group consisting of at least one linear 1,2-alkanediol having a carbon chain of 6 to 7 atoms, or a mixture comprising at least one first linear 1,2-alkanediol having a carbon chain of 6 to 7 carbon atoms and one or more second linear 1,2-alkanediol having a carbon chain of 6 to 7 carbon atoms, which is different from the first linear 1,2-alkanediol.

Surprisingly, it was found that these short-chained 1,2-alkanediols are particularly suitable enzyme stabilizing agents and which can also efficiently be incorporated into a broad range of detergents and cleaning compositions. It was found that these substances show outstanding enzyme stabilizing properties and significantly retard the rate of enzyme deactivation in a detergent and cleaning composition during storage. Such detergents and cleaning compositions show improved cleaning properties compared to detergent and cleaning composition without the addition of such substances.

According to a particularly preferred variant, the detergent and cleaning composition according to the present invention comprises at least one enzyme stabilizing agent selected from the group consisting of at least one linear 1,2-alkanediol having a carbon chain of 9 to 14 atoms, or a mixture comprising at least one first linear 1,2-alkanediol having a carbon chain of 9 to 14 carbon atoms and one or more second linear 1,2-alkanediol having a carbon chain of 9 to 14 carbon atoms, which is different from the first linear 1,2-alkanediol.

In a more preferred variant, the detergent and cleaning composition according to the present invention comprises at least one enzyme stabilizing agent selected from the group consisting of at least one linear 1,2-alkanediol having a carbon chain of 10 to 13 atoms, or a mixture comprising at least one first linear 1,2-alkanediol having a carbon chain of 10 to 13 carbon atoms and one or more second linear 1,2-alkanediol having a carbon chain of 10 to 13 carbon atoms, which is different from the first linear alkanediol.

In a still more preferred variant, the detergent and cleaning composition according to the present invention comprises at least one enzyme stabilizing agent selected from the group consisting of at least one linear 1,2-alkanediol having a carbon chain of 11 to 12 atoms, or a mixture comprising at least one first linear 1,2-alkanediol having a carbon chain of 11 to 12 carbon atoms and one or more second linear 1,2-alkanediol having a carbon chain of 11 to 12 carbon atoms, which is different from the first linear alkanediol.

Surprisingly, it was found that these long-chained 1,2-alkanediols are particularly suitable enzyme stabilizing agents and which can also efficiently be incorporated into a broad range of detergents and cleaning compositions. It was found that these substances show striking enzyme stabilizing properties and significantly retard the rate of enzyme deactivation in a detergent and cleaning composition during storage. Such detergents and cleaning compositions show improved cleaning properties compared to detergent and cleaning composition without the addition of such substances.

In a most preferred variant, the detergent and cleaning composition according to the present invention comprises at least one enzyme stabilizing agent selected from the group consisting of at least one linear 1,2-alkanediol having a log Pow value of ≤1, or a mixture comprising at least one first linear 1,2-alkanediol having a log Pow value of ≤1 and one or more second linear 1,2-alkanediol having a log Pow value of ≤1, which is different from the first linear 1,2-alkanediol.

The 1,2-alkanediols having a log Pow value of ≤1 are selected from the group consisting of 1,2-pentanediol (0.06), 1,2-hexanediol (0.58), 1,2-heptanediol (0.9), and any mixture thereof. Said 1,2-alkanediols are more soluble in water.

The Pow value is the partition coefficient of a chemical compound for the two-phase system consisting of the two immiscible solvents n-octanol and water at equilibrium. This value is therefore a comparison of the solubility of the solute in these two liquids. Hence the partition coefficient measures how hydrophilic or hydrophobic a chemical substance is.

The log Pow value is a constant defined in the following manner:

Log Pow=log 10 (Partition Coefficient)

Partition Coefficient, P=[n-octanol]/[water]
where [ ] indicates the concentration of solute in the organic and/or aqueous partition. The log Pow value is determined at a standard temperature of 25 °C.

The log Pow value s 1 means the compound has a higher affinity for the aqueous phase (it is more hydrophilic) and, thus, more soluble in water; a log Pow value≥1 denotes a higher concentration in the lipid phase (i.e., the compound is more lipophilic) and, thus, more soluble in fat-like solvents.

Surprisingly, it was found that 1,2-alkanediols having a log Pow value of ≤1 are particularly suitable enzyme stabilizing agents, which can also efficiently be incorporated into a broad range of detergents and cleaning compositions. Thus, detergents and cleaning compositions comprising 1,2-alkanediols having a log Pow value of ≤1 show an improved enzymatic stability during storage compared to detergent and cleaning composition without the addition of such 1,2-alkanediols.

In a still further preferred variant, the detergent and cleaning composition according to the present invention comprises at least one enzyme stabilizing agent selected from the group consisting of at least one linear 1,2-alkanediol having a log Pow value of ≥1, or a mixture comprising at least one first linear 1,2-alkanediol having a log Pow value of ≥1 and one or more second linear 1,2-alkanediol having a log Pow value of ≥1, which is different from the first linear 1,2-alkanediol.

The 1,2-alkanediols having a log Pow value of ≥1 are selected from the group consisting of 1,2-octanediol (log Pow=2.1), 1,2-nonanediol, 1,2-decanediol, 1,2-undecanediol, 1,2-dodecanediol, 1,2-tridecanediol, 1,2-tetradecanediol, and any mixture thereof. Said 1,2-alkanediols are more soluble in fat-like solvents, for example n-octanol.

Surprisingly, it was found that 1,2-alkanediols having a log Pow value of ≥1 are particularly suitable enzyme stabilizing agents, which can also efficiently be incorporated into a broad range of detergents and cleaning compositions. Thus, detergents and cleaning compositions comprising 1,2-alkanediols having a log Pow value of ≥1 show improved enzymatic stability during storage compared to detergent and cleaning composition without the addition of such 1,2-alkanediols.

The term “alkanediol” within the context of the present invention also includes its stereoisomers. Stereoisomers are molecules that have the same molecular formula and differ only in how their atoms are arranged in three-dimensional space. In accordance with said definition, the linear alkanediol of the invention or the first linear alkanediol having a carbon chain of 5 to 14 carbon atoms or the second linear alkanediol having a carbon chain of 5 to 14 carbon atoms as described above in detail encompass the following stereoisomers:

1,2-alkanediol stereoisomers:

| | |
|---|---|
| (2S)-pentane-1,2-diol, | (2R)-pentane-1,2-diol, |
| (2S)-hexane-1,2-diol, | (2R)-hexane-1,2-diol, |
| (2S)-heptane-1,2-diol, | (2R)-heptane-1,2-diol, |
| (2S)-octane-1,2-diol, | (2R)-octane-1,2-diol, |
| (2S)-nonane-1,2-diol, | (2R)-nonane-1,2-diol, |
| (2S)-decane-1,2-diol, | (2R)-decane-1,2-diol, |
| (2S)-undecane-1,2-diol, | (2R)-undecane-1,2-diol, |
| (2S)-dodecane-1,2-diol, | (2R)-dodecane-1,2-diol, |
| (2S)-tridecane-1,2-diol, | (2R)-tridecane-1,2-diol, |
| (2S)-tetradecane-1,2-diol, | (2R)-tetradecane-1,2-diol, |

2,3-alkanediol stereoisomers:

| | |
|---|---|
| (2S,3S)-pentane-2,3-diol, | (2R,3R)-pentane-2,3-diol, |
| (2S,3S)-hexane-2,3-diol, | (2R,3R)-hexane-2,3-diol, |
| (2S,3S)-heptane-2,3-diol, | (2R,3R)-heptane-2,3-diol, |
| (2S,3S)-octane-2,3-diol, | (2R,3R)-octane-2,3-diol, |
| (2S,3S)-nonane-2,3-diol, | (2R,3R)-nonane-2,3-diol, |
| (2S,3S)-decane-2,3-diol, | (2R,3R)-decane-2,3-diol, |
| (2S,3S)-undecane-2,3-diol, | (2R,3R)-undecane-2,3-diol, |
| (2S,3S)-dodecane-2,3-diol, | (2R,3R)-dodecane-2,3-diol, |
| (2S,3S)-tridecane-2,3-diol, | (2R,3R)-tridecane-2,3-diol, |
| (2S,3S)-tetradecane-2,3-diol, | (2R,3R)-tetradecane-2,3-diol, |
| (2S,3R)-pentane-2,3-diol, | (2R,3S)-pentane-2,3-diol, |
| (2S,3R)-hexane-2,3-diol, | (2R,3S)-hexane-2,3-diol, |
| (2S,3R)-heptane-2,3-diol, | (2R,3S)-heptane-2,3-diol, |
| (2S,3R)-octane-2,3-diol, | (2R,3S)-octane-2,3-diol, |
| (2S,3R)-nonane-2,3-diol, | (2R,3S)-nonane-2,3-diol, |
| (2S,3R)-decane-2,3-diol, | (2R,3S)-decane-2,3-diol, |
| (2S,3R)-undecane-2,3-diol, | (2R,3S)-undecane-2,3-diol, |
| (2S,3R)-dodecane-2,3-diol, | (2R,3S)-dodecane-2,3-diol, |
| (2S,3R)-tridecane-2,3-diol, | (2R,3S)-tridecane-2,3-diol, |
| (2S,3R)-tetradecane-2,3-diol, | (2R,3S)-tetradecane-2,3-diol. |

3,4-alkanediol stereoisomers:

| | |
|---|---|
| (3R,4R)-pentane-3,4-diol, | (3S,4S)-pentane-3,4-diol, |
| (3R,4R)-hexane-3,4-diol, | (3S,4S)-hexane-3,4-diol, |
| (3R,4R)-heptane-3,4-diol, | (3S,4S)-heptane-3,4-diol, |
| (3R,4R)-octane-3,4-diol, | (3S,4S)-octane-3,4-diol, |
| (3R,4R)-nonane-3,4-diol, | (3S,4S)-nonane-3,4-diol, |
| (3R,4R)-decane-3,4-diol, | (3S,4S)-decane-3,4-diol, |
| (3R,4R)-undecane-3,4-diol, | (3S,4S)-undecane-3,4-diol, |
| (3R,4R)-dodecane-3,4-diol, | (3S,4S)-dodecane-3,4-diol, |
| (3R,4R)-tridecane-3,4-diol, | (3S,4S)-tridecane-3,4-diol, |
| (3R,4R)-tetradecane-3,4-diol, | (3S,4S)-tetradecane-3,4-diol, |
| (3R,4S)-pentane-3,4-diol, | (3S,4R)-pentane-3,4-diol, |
| (3R,4S)-hexane-3,4-diol, | (3S,4R)-hexane-3,4-diol, |
| (3R,4S)-heptane-3,4-diol, | (3S,4R)-heptane-3,4-diol, |
| (3R,4S)-octane-3,4-diol, | (3S,4R)-octane-3,4-diol, |
| (3R,4S)-nonane-3,4-diol, | (3S,4R)-nonane-3,4-diol, |
| (3R,4S)-decane-3,4-diol, | (3S,4R)-decane-3,4-diol, |
| (3R,4S)-undecane-3,4-diol, | (3S,4R)-undecane-3,4-diol, |
| (3R,4S)-dodecane-3,4-diol, | (3S,4R)-dodecane-3,4-diol, |
| (3R,4S)-tridecane-3,4-diol, | (3S,4R)-tridecane-3,4-diol, |
| (3R,4S)-tetradecane-3,4-diol, | (3S,4R)-tetradecane-3,4-diol. |

In the context of the present text, the terms “1,2-diol”, “2,3-diol” or “3,4-diol” includes both the corresponding S-configured enantiomers and also the R-enantiomer as well as arbitrary mixtures of these S- and R-configured enantiomers, i.e. mixtures of racemates of the respective diols.

The alkanediol mixture of the detergent and cleaning composition according to the first aspect of the present invention comprises the 1,2-heptanediol and the 2,3-heptanediol in a ratio in a range of 50:50 to 99.9:0.1, preferably in a ratio in a range of 75:25 to 99:1, more preferred in a ratio in a range of 80:20 to 98:2 or still more preferred in a ratio in a range of 90:10 to 95:5.

In the detergent and cleaning composition according to the first aspect of the present invention, 1,2-heptanediol and 2,3-heptanediol are comprised in the mixture preferably in a ratio in a range of 98:2 to 99.9:0.1.

In the detergents and cleaning compositions according to the first aspect of the present invention, 1,2-heptanediol and 2,3-heptanediol are comprised in the alkanediol mixture preferably in a ratio in a range of 95:5 to 99.9:0.1.

Preferably, 1,2-heptanediol and 2,3-heptanediol are comprised in the mixture of the detergent and cleaning composition according to the first aspect of the present invention in a ratio of ≥95:≤5, more preferred in a ratio of ≥96:≤4; still more preferred in a ratio of ≥97:≤3, and most preferred in a ratio of ≥98:≤2.

Most of all the mixtures of the detergent and cleaning composition according to the first aspect of the present invention comprises 1,2-heptanediol and 2,3-heptanediol in a ratio of ≥95:≤5, including the ratios≥95.5:≤4.5; ≥96:≤4; ≥96.5:≤3.5; ≥97:≤3; ≥97.5:2,5 and ≥98.0:≤2.0.

Even more preferred the alkanediol mixture of the detergent and cleaning composition according to the first aspect of the present invention comprises 1,2-heptanediol and 2,3-heptanediol in a ratio of ≥98:≤2, including the ratios of ≥98.1:≤1.9; ≥98.2:≤1.8; ≥98.3: ≤1.7; ≥98.4:≤1.6; ≥98.5:≤1.5; ≥98.6:≤1.4; ≤98.7:≤1.3; ≥98.8:≤1.2; ≥98.9:≤1.1; ≥99:≤1.0; ≥99.1:≤0.9; ≥99.2:≤0.8; ≥99.3:≤0.7; ≥99.4:≤0.6; ≥99.5:≤0.5; ≥99.6: ≤0.4; ≥99.7:≤0.3; ≥99.8:≤0.2 and ≥99.9:≤0.1.

The first linear alkanediol and the second linear alkanediol as defined in detail above, are present in the alkanediol mixture according to the other aspect of the present invention in a ratio in a range of 50:50 to 99.9:0.1, preferably in a ratio in a range of 75:25 to 99:1, more preferred in a ratio in a range of 80:20 to 98:2, still more preferred in a ratio in a range of 90:10 to 95:5.

In the detergent and cleaning composition according to the other aspect of the present invention, the first linear alkanediol and the second linear alkanediol are comprised in the mixture preferably in a ratio in a range of 98:2 to 99.9:0.1

In the detergent and cleaning composition according to the other aspect of the present invention, the first linear alkanediol and the second alkanediol are comprised in the alkanediol mixture preferably in a ratio in a range of 95:5 to 99.9:0.1.

Preferably, the first linear alkanediol and the second alkanediol are comprised in the mixture of the detergent and cleaning composition according to the other aspect of the present invention in a ratio of ≥95:≤5, more preferred in a ratio of ≥96:≤4; still more preferred in a ratio of ≥97:≤3, and most preferred in a ratio of ≥98:≤2.

Most of all the mixtures of the detergent and cleaning composition according to the other aspect of the present invention comprises the first linear alkanediol and the second linear alkanediol in a ratio of ≥95:≤5, including the ratios≥95.5:≤4.5; ≥96:≤4; ≥96.5:≤3.5; ≥97:≤3; ≥97.5:2.5 and ≥98.0:≤2.0.

Even more preferred the alkanediol mixture of the detergent and cleaning composition according to the other aspect of the present invention comprises the first linear alkanediol and the second alkanediol in a ratio of ≥98:≤2, including the ratios of ≥98.1:≤1.9; ≥98.2:≤1.8; ≤98.3:≤1.7; ≥98.4:≤1.6; ≥98.5:≤1.5; ≥98.6:≤1.4; ≥98.7:≤1.3; ≥98.8:≤1.2; ≥98.9:≤1.1; ≥99:≤1.0; ≥99.1:≤0.9; ≥99.2:≤0.8; ≥99.3:≤0.7; ≥99.4:≤0.6; ≥99.5:≤0.5; ≥99.6:≤0.4; ≥99.7:≤0.3; ≥99.8:≤0.2 and ≥99.9:≤0.1.

Alternatively, said ratio ranges for the first and second alkanediol are switched, such that the second alkanediol is the main component and the first alkanediol is the secondary component.

In an advantageous variant according to the other aspect of the present invention, the alkanediol mixture comprises as first linear alkanediol an 1,2-alkanediol, such as 1,2-pentanediol, 1,2-hexanediol, 1,2-heptanediol, 1,2-octanediol, 1,2-nonanediol, 1,2-decanediol, 1,2-undecanediol, 1,2-dodecanediol, 1,2-tridecanediol, or 1,2-tetradecanediol,and as second linear alkanediol the corresponding 2,3-alkanediols, such as 2,3-pentanediol, 2,3-hexanediol, 2,3-heptanediol, 2,3-octanediol, 2,3-nonanediol, 2,3-decanediol, 2,3-undecanediol, 2,3-dodecanediol, 2,3-tridecanediol, or 2,3-tetradecanediol, in a ratio in a range of 50:50 to 99.9:0.1, preferably in a ratio in a range of 75:25 to 99:1, more preferred in a ratio in a range of 80:20 to 98:2, still more preferred in a ratio in a range of 90:10 to 95:5.

In a further advantageous variant according to the present invention, the alkanediol mixture comprises as first linear alkanediol an 1,2-alkanediol, such as 1,2-hexanediol, 1,2-heptanediol, 1,2-octanediol, 1,2-nonanediol, 1,2-decanediol, 1,2-undecanediol, 1,2-dodecanediol, 1,2-tridecanediol, or 1,2-tetradecanediol, and as second linear alkanediol the corresponding 2,3-alkanediols, such as 2,3-hexanediol, 2,3-heptanediol, 2,3-octanediol, 2,3-nonanediol, 2,3-decanediol, 2,3-undecanediol, 2,3-dodecanediol, 2,3-tridecanediol, or 2,3-tetradecanediol, in a ratio in a range of 50:50 to 99.9:0.1, preferably in a ratio in a range of 75:25 to 99:1, more preferred in a ratio in a range of 80:20 to 98:2, still more preferred in a ratio in a range of 90:10 to 95:5.

Likewise, for said alkanediol mixtures the ratios of first linear alkanediol: second alkanediol or ranges of ratios as described above are also applicable.

In a still further variant, according to the second aspect of the present invention, the alkanediol mixture comprises as first linear alkanediol an 2,3-alkanediol, such as 2,3-pentanediol, 2,3-hexanediol, 2,3-heptanediol, 2,3-octanediol, 2,3-nonanediol, 2,3-decanediol, 2,3-undecanediol, 2,3-dodecanediol, 2,3-tridecanediol, or 2,3-tetradecanediol, and as second linear alkanediol the corresponding 1,2-alkanediols, such as 1,2-pentanediol, 1,2-hexanediol, 1,2-heptanediol, 1,2-octanediol, 1,2-nonanediol, 1,2-decanediol, 1,2-undecanediol, 1,2-dodecanediol, 1,2-tridecanediol, or 1,2-tetradecanediol, in a ratio in a range of 50:50 to 99.9:0.1, preferably in a ratio in a range of 75:25 to 99:1, more preferred in a ratio in a range of 80:20 to 98:2, still more preferred in a ratio in a range of 90:10 to 95:5.

In a further advantageous variant, according to the present invention, the alkanediol mixture comprises as first linear alkanediol an 2,3-alkanediol, such as 2,3-hexanediol, 2,3-heptanediol, 2,3-octanediol, 2,3-nonanediol, 2,3-decanediol, 2,3-undecanediol, 2,3-dodecanediol, 2,3-tridecanediol, or 2,3-tetradecanediol, and as second linear alkanediol the corresponding 1,2-alkanediols, such as 1,2-hexanediol, 1,2-heptanediol, 1,2-octanediol, 1,2-nonanediol, 1,2-decanediol, 1,2-undecanediol, 1,2-dodecanediol, 1,2-tridecanediol, or 1,2-tetradecanediol, in a ratio in a range of 50:50 to 99.9:0.1, preferably in a ratio in a range of 75:25 to 99:1, more preferred in a ratio in a range of 80:20 to 98:2, still more preferred in a ratio in a range of 90:10 to 95:5.

Likewise, for said alkanediol mixtures the ratios of first linear alkanediol:second alkanediol or ranges of ratios as described above are also applicable.

In a more advantageous variant according to the present invention, in the alkanediol mixtures comprising a combination of a 1,2-alkanediol as first linear alkanediol and the corresponding 2,3-alkanediol as second linear alkanediol, such as
1,2-pentanediol and 2,3-pentanediol, or
1,2-hexanediol and 2,3-hexanediol, or
1,2-heptanediol and 2,3-heptanediol, or
1,2-octanediol and 2,3-octanediol, or
1,2-nonanediol and 2,3-nonanediol, or
1,2-decanediol and 2,3-decanediol, or
1,2-undecanediol and 2,3-undecenaediol, or
1,2-dodecanediol and 2,3-dodecanediol, or
1,2-tridecanediol and 2,3-tridecanediol, or
1,2-tetradecanediol and 2,3-tetradecanediol,
the first linear alkanediol and the second linear alkanediol are present in a ratio in a range of 50:50 to 99.9:0.1, preferably in a ratio in a range of 75:25 to 99:1, more preferred in a ratio in a range of 80:20 to 98:2 or still more preferred in ratio in a range of 90:10 to 95:5.

Likewise, for said alkanediol mixtures the ratios of first linear alkanediol:second alkanediol or ranges of ratios as described above are also applicable.

A preferred variant according to the present invention also encompasses a mixture including as first linear alkanediol 1,2-hexanediol and as second linear alkanediol 1,2-octanediol either in a ratio in a range of 50:50 to 99.9:0.1, preferably in a ratio in a range of 75:25 to 99:1, more preferred in a ratio in a range of 80:20 to 98:2 or still more preferred in a ratio in a range of 90:10 to 95:5.

Thus, according to another preferred variant, the present invention relates to a detergent and cleaning composition,
(i) wherein the mixture comprising 1,2-heptanediol and 2,3-heptanediol comprises the 1,2-heptanediol and the 2,3-heptanediol in a ratio in a range of 50:50 to 99.9:0.1, preferably in a ratio in a range of 75:25 to 99:1, more preferred in a ratio in a range of 80:20 to 98:2, still more preferred in a ratio of 90:10 to 95:5; or
(ii) wherein the mixture comprising at least one first linear alkanediol and one or more second linear alkanediol comprises the first linear alkanediol and the second alkanediol in a ratio in a range of 50:50 to 99.9:0.1, preferably in a ratio in a range of 75:25 to 99:1, more preferred in a ratio in a range of 80:20 to 98:2, still more preferred in a ratio of 90:10 to 95:5.

By these mixing ratios the afore-mentioned mixtures show a synergistical enzyme stabilizing activity in a detergent and cleaning composition comprising an enzyme in direct comparison with the corresponding individual alkanediols.

The alkanediols are obtained either by synthesis from petrochemical or other fossil fuel sources by known methods such as olefin bis-hydroxylation, hydrolysis from epoxide or various chemical transformations or from bioderived feedstock by fermentation or from bio-based natural and renewable feedstock such as biomass by catalytic synthesis as it is described in US 2019/0241491 A1 and US 2020/0189995 A1. The alkanediols used according to the present invention comprise either petrochemically derived and biobased natural and renewable feedstock derived alkanediols. Preferably, the alkanediols are from bio-based sources and are thus bio-alkanediols.

Beyond the above specified alkanediols, the enzyme stabilizing agent of the detergent and cleaning composition according to the second aspect of the present invention is either (b^{II}) glyceryl caprylate, or (b^{III}) 4-hydroxyacetophenone, or (b^{IV}) ethyl hexyl glycerin, or (b^{V}) tropolone, or any mixture of the aforementioned agents.

Glyceryl Caprylate (b^{II})

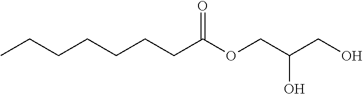

is a natural emollient derived from glycerine and plant fatty acids, usually appearing as a white waxy solid. This ingredient is used in many skincare products for its emollient and moisturising properties, to help maintain the balance of moisture in the skin. In additional, glyceryl caprylate (b^{II}) is used as antimicrobial active component in cosmetic preparations.

It was surprisingly found that the oily, surface-active co-emulsifier glyceryl caprylate is a further suitable enzyme stabilizing agent within the meaning of the present invention.

4-hydroxyacetophenone (4-HAP) (b^{III})

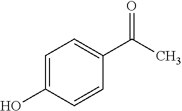

possesses oxidation-inhibiting, fungicidal and bacterial growth-inhibiting properties and is therefore used to stabilize cosmetic preparations.

It was surprisingly found that the 4-HAP is a further suitable enzyme stabilizing agent within the meaning of the present invention.

Ethyl Hexyl Glycerin (EHG) (b^{IV})

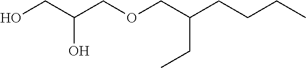

is a relatively new cosmetic ingredient that is used for its surfactant, dispersant, emollient, skin-conditioning and antimicrobial properties. Ethyl hexyl glycerin (EHG or octoxyglycerin) is a glyceryl ether and a vicinal diol.

It was surprisingly found that EHG is suitable to stabilize enzymes in a detergent and cleaning composition within the meaning of the present invention.

### Tropolone (b^{V})

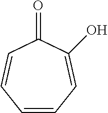

is known for its antibacterial, antifungal, anti-inflammatory, antioxidant, and chelating properties and is therefore used in cosmetic formulations.

It was surprisingly found that tropolone act as enzyme stabilizer in a detergent and cleaning composition within the meaning of the present invention.

The above specified enzyme stabilizing agents (b^{II}) (b^{III}), (b^{IV}) and (b^{V}) can be used in the detergent and cleaning composition either individually or in the form of mixtures of two, or even more enzyme stabilizing agents.

In a particular preferred variant, the at least one enzyme stabilizing agent (b) in the detergent and cleaning composition according to the present invention includes any of the following mixtures/combinations:
a mixture comprising (b^{II}) glyceryl caprylate and (b^{III}) 4-hydroxyacetophenone;
a mixture comprising (b^{II}) glyceryl caprylate and (b^{IV}) ethyl hexyl glycerin;
a mixture comprising (b^{II}) glyceryl caprylate and (b^{V}) tropolone;
a mixture comprising (b^{III}) 4-hydroxyacetophenone and (b^{IV}) ethyl hexyl glycerin;
a mixture comprising (b^{III}) 4-hydroxyacetophenone and (b^{V}) tropolone; and
a mixture comprising (b^{IV}) ethyl hexyl glycerin and (b^{V}) tropolone.

For said boosting agent mixtures even a synergistic enzyme stabilizing effect can be observed.

Similarly, and still more preferred, the above specified single enzyme stabilizing agents (b^{II}) (b^{III}), (b^{IV}) and (b^{V}) or mixtures or two or three enzyme stabilizing agents (b^{II}) (b^{III}), (b^{IV}) and (b^{V}) can also be used in the detergent and cleaning composition in mixture with one or two or even more alkanediol(s) enzyme stabilizing agents (b^{I}) as defined herein. Preferably, such mixtures contain two, or even more enzyme stabilizing agents as defined herein.

In a particular preferred variant, the detergent and cleaning composition according to the present invention includes any of the following enzyme stabilizing agent mixtures/combinations:
a mixture comprising (b^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above, and (b^{II}) glyceryl caprylate;
a mixture comprising (b^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above, and (b^{III}) 4-hydroxyacetophenone;
a mixture comprising (b^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above, and (b^{IV}) ethyl hexyl glycerin;
a mixture comprising (b^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above, and (b^{V}) tropolone.

In a preferred variant, the deter detergent and cleaning composition according to the present invention includes any of the following enzyme stabilizing agent mixtures/combinations selected from the group consisting of:
a mixture comprising (b^{II}) glyceryl caprylate and 1,2-pentanediol;
a mixture comprising (b^{II}) glyceryl caprylate and 1,2-hexanediol;
a mixture comprising (b^{II}) glyceryl caprylate and 1,2-heptanediol;
a mixture comprising (b^{II}) glyceryl caprylate and 1,2-octanediol;
a mixture comprising (b^{II}) glyceryl caprylate and 1,2-nonanediol;
a mixture comprising (b^{II}) glyceryl caprylate and 1,2-decanediol;
a mixture comprising (b^{II}) glyceryl caprylate and 1,2-undecanediol;
a mixture comprising (b^{II}) glyceryl caprylate and 1,2-dodecanediol;
a mixture comprising (b^{II}) glyceryl caprylate and 1,2-tridecanediol;
a mixture comprising (b^{II}) glyceryl caprylate and 1,2-tetradecanediol;
a mixture comprising (b^{III}) 4-hydroxyacetophenone and 1,2-pentanediol;
a mixture comprising (b^{III}) 4-hydroxyacetophenone and 1,2-hexanediol;
a mixture comprising (b^{III}) 4-hydroxyacetophenone and 1,2-heptanediol;
a mixture comprising (b^{III}) 4-hydroxyacetophenone and 1,2-octanediol;
a mixture comprising (b^{III}) 4-hydroxyacetophenone and 1,2-nonanediol;
a mixture comprising (b^{III}) 4-hydroxyacetophenone and 1,2-decanediol;
a mixture comprising (b^{III}) 4-hydroxyacetophenone and 1,2-undecanediol;
a mixture comprising (b^{III}) 4-hydroxyacetophenone and 1,2-dodecanediol;
a mixture comprising (b^{III}) 4-hydroxyacetophenone and 1,2-tridecanediol;
a mixture comprising (b^{III}) 4-hydroxyacetophenone and 1,2-tetradecanediol;
a mixture comprising (b^{IV}) ethyl hexyl glycerin and 1,2-pentanediol;
a mixture comprising (b^{IV}) ethyl hexyl glycerin and 1,2-hexanediol;
a mixture comprising (b^{IV}) ethyl hexyl glycerin and 1,2-heptanediol;
a mixture comprising (b^{IV}) ethyl hexyl glycerin and 1,2-octanediol;
a mixture comprising (b^{IV}) ethyl hexyl glycerin and 1,2-nonanediol;
a mixture comprising (b^{IV}) ethyl hexyl glycerin and 1,2-decanediol;
a mixture comprising (b^{IV}) ethyl hexyl glycerin and 1,2-undecanediol;
a mixture comprising (b^{IV}) ethyl hexyl glycerin and 1,2-dodecanediol;
a mixture comprising (b^{IV}) ethyl hexyl glycerin and 1,2-tridecanediol;
a mixture comprising (b^{IV}) ethyl hexyl glycerin and 1,2-tetradecanediol;
a mixture comprising (b^{V}) tropolone and 1,2-pentanediol;
a mixture comprising (b^{V}) tropolone and 1,2-hexanediol;
a mixture comprising (b^{V}) tropolone and 1,2-heptanediol;
a mixture comprising (b^{V}) tropolone and 1,2-octanediol;
a mixture comprising (b^{V}) tropolone and 1,2-nonanediol;
a mixture comprising (b^{V}) tropolone and 1,2-decanediol;
a mixture comprising (b^{V}) tropolone and 1,2-undecanediol;
a mixture comprising (b^{V}) tropolone and 1,2-dodecanediol;
a mixture comprising (b^{V}) tropolone and 1,2-tridecanediol; and
a mixture comprising (b^{V}) tropolone and 1,2-tetradecanediol.

Surprisingly, it was found that the above specified combinations are particularly efficient enzyme stabilizing agents. The improved enzyme stability in the detergents and cleaning compositions in turn results in a better cleaning performance even after storage, compared to detergents and cleaning compositions without the addition of such enzyme stabilizing agent mixtures.

Surprisingly, for said mixtures even a synergistic enzyme stabilizing effect can be observed compared to the stabilizing effect of the single enzyme stabilizing agents.

Most preferred, the deter detergent and cleaning composition according to the present invention includes a mixture of enzyme stabilizing agents comprising an 1,2-alkanediol combined with 4-hydroxyacetophenone selected from the group consisting of:
a mixture comprising (b^{III}) 4-hydroxyacetophenone and 1,2-pentanediol;
a mixture comprising (b^{III}) 4-hydroxyacetophenone and 1,2-hexanediol;
a mixture comprising (b^{III}) 4-hydroxyacetophenone and 1,2-heptanediol;
a mixture comprising (b^{III}) 4-hydroxyacetophenone and 1,2-octanediol;
a mixture comprising (b^{III}) 4-hydroxyacetophenone and 1,2-nonanediol;
a mixture comprising (b^{III}) 4-hydroxyacetophenone and 1,2-decanediol;
a mixture comprising (b^{III}) 4-hydroxyacetophenone and 1,2-undecanediol;
a mixture comprising (b^{III}) 4-hydroxyacetophenone and 1,2-dodecanediol;
a mixture comprising (b^{III}) 4-hydroxyacetophenone and 1,2-tridecanediol;
a mixture comprising (b^{III}) 4-hydroxyacetophenone and 1,2-tetradecanediol;
It was found that the enzyme stabilizing agent mixtures comprising 4-hydroxyacetophenone in combination with an 1,2-alkanediol show outstanding synergistic enzyme stabilizing effects and significantly retard the rate of enzyme deactivation in a detergent and cleaning composition during storage. Such detergents and cleaning compositions show improved cleaning properties compared to detergent and cleaning composition without the addition of such enzyme stabilizing mixtures.

A particular pronounced stabilizing effect was observed when said enzyme stabilizing mixtures comprising 4-hydroxyacetophenone are added to a detergent and cleaning composition comprising amylase.

However, a particular pronounced enzyme stabilizing effect can be observed for the following enzyme stabilizing agents:
1,2-pentanediol;
1,2-hexanediol;
1,2-heptanediol;
1,2-octanediol;
1,2-nonanediol;
1,2-decanediol;
1,2-undecanediol;
1,2-dodecanediol;
1,2-tirdecanediol;
1,2-tetradecanediol;
glyceryl caprylate;
4-hydroxyacetophenone;
ethyl hexyl glycerin;
tropolone;
a mixture comprising 1,2-hexanediol and 1,2-octanediol;
a mixture comprising 1,2-hexanediol and 1,2-octanediol and tropolone; and
a mixture comprising 4-hydroxyacetophenone and 1,2-octanediol.

For the detergent and cleaning composition according to the present invention, the list of enzyme stabilizing agents (b1, b2, b3, b) specified herein can be arbitrary combined with the list of enzymes specified herein.

In a particular advantageously variant, the detergent and cleaning composition according to the present invention comprises one of the following combinations of components (a) and (b):
proteases plus one or more of the following enzyme stabilizing agents: (b^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above; (b^{II}) glyceryl caprylate; (b^{III}) 4-hydroxyacetophenone; (b^{IV}) ethyl hexyl glycerin; or (b^{V}) tropolone; or
lipases plus one or more of the following enzyme stabilizing agents: (b^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above; (b^{II}) glyceryl caprylate; (b^{III}) 4-hydroxyacetophenone; (b^{IV}) ethyl hexyl glycerin; or (b^{V}) tropolone; or
amylases plus one or more of the following enzyme stabilizing agents: (b^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above; (b^{II}) glyceryl caprylate; (b^{III}) 4-hydroxyacetophenone; (b^{IV}) ethyl hexyl glycerin; or (b^{V}) tropolone; or
cellulases plus one or more of the following enzyme stabilizing agents: (b^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above; (b^{II}) glyceryl caprylate; (b^{III}) 4-hydroxyacetophenone; (b^{IV}) ethyl hexyl glycerin; or (b^{V}) tropolone; or
mannanases plus one or more of the following enzyme stabilizing agents: (b^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above; (b^{II}) glyceryl caprylate; (b^{III}) 4-hydroxyacetophenone; (b^{IV}) ethyl hexyl glycerin; or (b^{V}) tropolone; or
pectate lyases plus one or more of the following enzyme stabilizing agents: (b^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above; (b^{II}) glyceryl caprylate; (b^{III}) 4-hydroxyacetophenone; (b^{IV}) ethyl hexyl glycerin; or (b^{V}) tropolone.

In a more preferred variant, the detergent and cleaning composition according to the second aspect of the present invention comprises one of the following combinations of components (a) and (b):
proteases plus 1,2-pentanediol;
proteases plus 1,2-hexanediol;
proteases plus 1,2-heptanediol;
proteases plus 1,2-octanediol;
proteases plus glyceryl caprylate;
proteases plus 4-hydroxyacetophenone;
proteases plus ethyl hexyl glycerin;
proteases plus tropolone;
proteases plus a mixture comprising 1,2-hexanediol and 1,2-octanediol;
proteases plus a mixture comprising 1,2-hexanediol and 1,2-octanediol and tropolone;
proteases plus a mixture comprising 4-hydroxyacetophenone and a 1,2-alkanediol, such as 1,2-hexanediol, 1,2-heptanediol, 1,2-octanediol, 1,2-nonanediol, 1,2-decanediol, 1,2-undecanediol, 1,2-dodecanediol, 1,2-tridecanediol or 1,2-tetradecanediol;
amylases plus 1,2-pentanediol;
amylases plus 1,2-hexanediol;
amylases plus 1,2-heptanediol;
amylases plus 1,2-octanediol;
amylases plus glyceryl caprylate;
amylases plus 4-hydroxyacetophenone;
amylases plus ethyl hexyl glycerin;
amylases plus tropolone;
amylases plus a mixture comprising 1,2-hexanediol and 1,2-octanediol;
amylases plus a mixture comprising 1,2-hexanediol and 1,2-octanediol and tropolone;
amylases plus a mixture comprising 4-hydroxyacetophenone and a 1,2-alkanediol, such as 1,2-hexanediol, 1,2-heptanediol, 1,2-octanediol, 1,2-nonanediol, 1,2-decanediol, 1,2-undecanediol, 1,2-dodecanediol, 1,2-tridecanediol or 1,2-tetradecanediol;
lipases plus 1,2-pentanediol;
lipases plus 1,2-hexanediol;
lipases plus 1,2-heptanediol;
lipases plus 1,2-octanediol;
lipases plus glyceryl caprylate;
lipases plus 4-hydroxyacetophenone;
lipases plus ethyl hexyl glycerin;
lipases plus tropolone;
lipases plus a mixture comprising 1,2-hexanediol and 1,2-octanediol;
lipases plus a mixture comprising 1,2-hexanediol and 1,2-octanediol and tropolone;
lipases plus a mixture comprising 4-hydroxyacetophenone and a 1,2-alkanediol, such as 1,2-hexanediol, 1,2-heptanediol, 1,2-octanediol, 1,2-nonanediol, 1,2-decanediol, 1,2-undecanediol, 1,2-dodecanediol, 1,2-tridecanediol or 1,2-tetradecanediol;
mannanases plus 1,2-pentanediol;
mannanases plus 1,2-hexanediol;
mannanases plus 1,2-heptanediol;
mannanases plus 1,2-octanediol;
mannanases plus glyceryl caprylate;
mannanases plus 4-hydroxyacetophenone;
mannanases plus ethyl hexyl glycerin;
mannanases plus tropolone;
mannanases plus a mixture comprising 1,2-hexanediol and 1,2-octanediol;
mannanases plus a mixture comprising 1,2-hexanediol and 1,2-octanediol and tropolone;
mannanases plus a mixture comprising 4-hydroxyacetophenone and a 1,2-alkanediol, such as 1,2-hexanediol, 1,2-heptanediol, 1,2-octanediol, 1,2-nonanediol, 1,2-decanediol, 1,2-undecanediol, 1,2-dodecanediol, 1,2-tridecanediol or 1,2-tetradecanediol;
pectate lyases plus 1,2-pentanediol;
pectate lyases plus 1,2-hexanediol;
pectate lyases plus 1,2-heptanediol;
pectate lyases plus 1,2-octanediol;
pectate lyases plus glyceryl caprylate;
pectate lyases plus 4-hydroxyacetophenone;
pectate lyases plus ethyl hexyl glycerin;
pectate lyases plus tropolone;
pectate lyases plus a mixture comprising 1,2-hexanediol and 1,2-octanediol;
pectate lyases plus a mixture comprising 1,2-hexanediol and 1,2-octanediol and tropolone; or
pectate lyases plus a mixture comprising 4-hydroxyacetophenone and a 1,2-alkanediol, such as 1,2-hexanediol, 1,2-heptanediol, 1,2-octanediol, 1,2-nonanediol, 1,2-decanediol, 1,2-undecanediol, 1,2-dodecanediol, 1,2-tridecanediol or 1,2-tetradecanediol.

Particular preferred is the use of any enzyme stabilizing agent mixture in a detergent and cleaning composition comprising amylases selected from the group consisting of:
4-hydroxyacetophenone and 1,2-pentanediol,
4-hydroxyacetophenone and 1,2-hexanediol,
4-hydroxyacetophenone and 1,2-heptanediol,
4-hydroxyacetophenone and 1,2-octanediol,
4-hydroxyacetonphenone and 1,2-nonanediol,
4-hydroxyacetophenone and 1,2-decanediol,
4-hydroxyacetophenone and 1,2-undecanediol,
4-hydroxyacetophenone and 1,2-dodecanediol,
4-hydroxy1,2-tridecanediol or 1,2-tetradecanediol.

Particular preferred is the use of any enzyme stabilizing agent mixture in a detergent and cleaning composition comprising mannanases selected from the group consisting of:
4-hydroxyacetophenone and 1,2-pentanediol,
4-hydroxyacetophenone and 1,2-hexanediol,
4-hydroxyacetophenone and 1,2-heptanediol,
4-hydroxyacetophenone and 1,2-octanediol,
4-hydroxyacetonphenone and 1,2-nonanediol,
4-hydroxyacetophenone and 1,2-decanediol,
4-hydroxyacetophenone and 1,2-undecanediol,
4-hydroxyacetophenone and 1,2-dodecanediol,
4-hydroxy1,2-tridecanediol or 1,2-tetradecanediol.

In a further preferred variant, the detergent and cleaning composition according to the present invention comprises one of the following combinations of components (a) and (b):
proteases plus 1,2-hexanediol;
proteases plus 1,2-heptanediol;
proteases plus 1,2-octanediol;
proteases plus 1,2-nonanediol;
proteases plus 1,2-decanediol;
proteases plus 1,2-undecanediol;
proteases plus 1,2-dodecanediol;
proteases plus 1,2-tridecanediol;
proteases plus 1,2-tetradecanediol;
amylases plus 1,2-nonanediol;
amylases plus 1,2-decanediol;
amylases plus 1,2-undecanediol;
amylases plus 1,2-dodecanediol;
amylases plus 1,2-tridecanediol;
amylases plus 1,2-tetradecanediol;
lipases plus 1,2-nonanediol;
lipases plus 1,2-decanediol;
lipases plus 1,2-undecanediol;
lipases plus 1,2-dodecanediol;
lipases plus 1,2-tridecanediol;
lipases plus 1,2-tetradecanediol;
mannanases plus 1,2-nonanediol;
mannanases plus 1,2-decanediol;
mannanases plus 1,2-undecanediol;
mannanases plus 1,2-dodecanediol;
mannanases plus 1,2-tridecanediol;
mannanases plus 1,2-tetradecanediol;
pectate lyases plus 1,2-nonanediol;
pectate lyases plus 1,2-decanediol;
pectate lyases plus 1,2-undecanediol;
pectate lyases plus 1,2-dodecanediol;
pectate lyases plus 1,2-tridecanediol; or
pectate lyases plus 1,2-tetradecanediol.

It was found that the above-specified combinations of enzyme and enzyme stabilizing agent result in superior enzyme stability in a detergent and cleaning composition during storage.

### Surfactant/Component (c1, c2, c3, c)

The detergent and cleaning composition according to the present invention includes at least one surfactant (c1, c2, c3, c).

Surfactants are added for a number of reasons, the main purposes being their washing and surface-active properties. They remove soils from the clothing and surfaces in the washing and cleaning process and keep it suspended in the washing solution. Some surfactants perform other functions such as foam inhibition.

The detergent and cleaning composition according to the present invention may comprise any kind of surfactant, namely anionic surfactants, cationic surfactants, nonionic surfactants, amphoteric/zwitterionic surfactant, and any mixture thereof.

Suitable surfactants which can be incorporated into the detergents and cleaning compositions according to the present invention are:

### Anionic Surfactants

Suitable anionic surfactants for the detergent and cleaning composition according to the present invention may include any conventional anionic surfactants. Typical examples for anionic surfactants encompass:
C10 to C18 alkyl benzene sulfonates;
C10 to C18 alkyl sulfates;
C10 to C18 alkyl sulfates, ethoxylated with 1 to 3 moles ethylene oxide;
C10 to C18 alpha-olefin sulfonates;
C8 to C18 alkyl carboxylates, ethoxylated with 1 to 10 moles ethylene oxide;
   and any mixture thereof.

In a preferred variant of the detergent and cleaning composition according to the present invention, the anionic surfactant is selected from the group consisting of
C10 to C13 alkyl benzene sulfonates;
C12 to C15 alkyl sulfates;
C12 to C14 alkyl sulfates, ethoxylated with 1 to 3 moles ethylene oxide;
C12 to C16 alpha-olefin sulfonates;
C8 to C18 alkyl carboxylates, ethoxylated with 3 to 10 moles ethylene oxide;
   and any mixture thereof.

In a more preferred variant of the detergent and cleaning composition according to the first and second aspect of the present invention, the anionic surfactant is selected from the group consisting of
dodecyl benzene sulfonate;
dodecyl sulfate;
dodecyl sulfate, ethoxylated with 2 moles ethylene oxide;
C12 to C14 alpha-olefin sulfonates;
C18 alkyl carboxylates, ethoxylated with 9 to 10 moles ethylene oxide;
   and any mixture thereof.

For laundry detergents, the anionic surfactant is most preferred selected from the group consisting of dodecyl benzene sulfonate, dodecyl sulfate, dodecyl sulfate, ethoxylated with 2 moles ethylene oxide, and any mixture thereof.

For hand dishwashing detergents, the anionic surfactant is most preferred selected from the group consisting of dodecyl sulfate, dodecyl sulfate, ethoxylated with 2 moles ethylene oxide, and any mixture thereof.

For hard surface cleaning detergents, the anionic surfactant is most preferred selected from the group consisting of dodecyl sulfate, dodecyl sulfate, ethoxylated with 2 moles ethylene oxide, and any mixture thereof.

### Cationic Surfactants

Suitable cationic surfactants for the detergent and cleaning composition according to the present invention may include any conventional cationic surfactants. Typical examples for cationic surfactants encompass:
quaternary C8 to C18 alkyl ethanolamines;
quaternary C8 to C18 alkyl ammonium compounds;
C8 to C18 alkyl ammonium methosulfates;
   and any mixture thereof.

In a preferred variant of the detergent and cleaning composition according to the present invention, the cationic surfactant is selected from the group consisting of
quaternary C12 to C18 alkyl ethanolamines;
quaternary C12 to C18 alkyl ammonium compounds;
C12 to C18 alkyl ammonium methosulfates;
   and any mixture thereof.

In a more preferred variant of the detergent and cleaning composition according to the first and second aspect of the present invention, the cationic surfactant is selected from the group consisting of
quaternary C16 to C18 alkyl ethanolamines;
quaternary C16 to C18 alkyl ammonium compounds;
C14 to C18 alkyl ammonium methosulfates;
   and any mixture thereof.

For hard surface cleaning detergents, the cationic surfactant is most preferred selected form the group consisting of quaternary C16 to C18 alkyl ammonium compounds, and any mixture thereof.

For fabric softener, the cationic surfactant is most preferred selected form the group consisting of C14 to C18 alkyl ammonium methosulfates, and any mixture thereof.

### Non-Ionic Surfactants

Suitable non-ionic surfactants for the detergent and cleaning composition according to the present invention may include any conventional non-ionic surfactants. Typical examples for non-ionic surfactants encompass:
C6 to C18 fatty alcohols, ethoxylated with 1 to 12 moles ethylene oxide;
alkoxylated C6 to C18 fatty alcohols such as
   C6 to C18 fatty alcohols, ethoxylated with 1 to 25 moles ethylene oxide,
   C6 to C18 fatty alcohols, propoxylated with 1 to 15 moles propylene oxide,
   C6 to C18 fatty alcohols, butoxylated with 1 to 10 moles butylene oxide,
   and combinations thereof;
C6 to C18 sophorolipids;
C6 to C18 rhamnolipids;
C5 to C18 alkyl polyglycosides;
C6 to C18 alkanolamides;
C6 to C18 fatty acid ester alkoxylates;
   and any mixture thereof.

In a preferred variant of the detergent and cleaning composition according to the the present invention, the non-ionic surfactant is selected from the group consisting of
C8 to C15 fatty alcohols, ethoxylated with 3 to 8 moles ethylene oxide;
alkoxylated C8 to C15 fatty alcohols such as
   C8 to C15 fatty alcohols, ethoxylated with 1 to 25 moles ethylene oxide,
   C8 to C15 fatty alcohols, propoxylated with 1 to 15 moles propylene oxide,
   C8 to C15 fatty alcohols, butoxylated with 1 to 10 moles butylene oxide,
   and combinations thereof;
C8 to C18 sophorolipids;
C8 to C18 rhamnolipids;
C7 to C15 alkyl polyglycosides;
C8 to C15 alkanolamides;
C8 to C15 fatty acid ester alkoxylates;
   and any mixture thereof.

In a more preferred variant of the detergent and cleaning composition according to the present invention, the non-ionic surfactant is selected from the group consisting of
C10 to C18 sophorolipids;
C10 to C18 rhamnolipids;
C8 to C14 alkyl polyglycosides;
Cocamide DEA/MEA;
C10 to C14 fatty acid ester alkoxylates;
   and any mixture thereof.

In a still more preferred variant of the detergent and cleaning composition according to the present invention, the non-ionic surfactant is selected from the group consisting of
C10 to C18 sophorolipids;
C10 to C18 rhamnolipids;
C8 to C14 alkyl polyglycosides;
   and any mixture thereof.

Said non-ionic detergents are particularly beneficial for preparing “green” detergents and cleaning compositions.

For laundry detergents, dishwashing detergents and hard surface cleaning detergents, the non-ionic surfactant is most preferred selected from the group consisting of C10 to C18 sophorolipids, C10 to C18 rhamnolipids, C8 to C14 alkyl polyglycosides, and any mixture thereof.

In a further preferred variant, for laundry detergents the non-ionic surfactant is selected from the group consisting of C12 to C14 fatty alcohols, ethoxylated with 7 moles ethylene oxide, C13 to C15 fatty alcohols, ethoxylated with 7 moles ethylene oxide, and any mixture thereof.

In a further preferred variant, for hard surface cleaning, such as degreaser, the non-ionic surfactant is selected from the group consisting of C9 to C11 fatty alcohols, ethoxylated with 3 to 8 moles ethylene oxide, C10 fatty alcohol, ethoxylated with 3 to 8 moles ethylene oxide, and any mixture thereof.

In a further preferred variant, for automatic dishwashing, the non-ionic surfactant is selected from the group consisting of C12 to C14 fatty alcohols, ethoxylated with 5 mol ethylene oxide and/or propoxylated with 4 mol propylene oxide.

### Amphoteric/Zwitterionic Surfactants

Suitable amphoteric/zwitterionic surfactants for the detergent and cleaning composition according to the present invention may include any conventional amphoteric/zwitterionic surfactants. Typical examples for amphoteric/zwitterionic surfactants encompass:
C10 to C18 N-(alkyl)-N,N-dimethylamine oxide;
C10 to C18 N-(alkyl)-N,N-bis(2-hydroxyethyl)amine oxide;
C10 to C18 alkyl amido propyl dimethyl amine oxide;
C10 to C18 alkylbetaines;
C10 to C18 alkylamidobetaines;
C10 to C18 sulfobetaines;
   and any mixture of the above surfactants.

In a preferred variant of the detergent and cleaning composition according to the present invention, the amphoteric/zwitterionic surfactant is selected from the group consisting of
C10 to C15 N-(alkyl)-N,N-dimethylamine oxide;
C10 to C15 N-(alkyl)-N,N-bis(2-hydroxyethyl)amine oxide;
C10 to C15 alkyl amido propyl dimethyl amine oxide;
C10 to C15 alkylbetaines;
C10 to C15 alkylamidobetaines;
C10 to C15 sulfobetaines;
   and any mixture of the above surfactants.

In a more preferred variant of the detergent and cleaning composition according to the present invention, the amphoteric/zwitterionic surfactant is selected from the group consisting of
C12 to C14 N-(alkyl)-N,N-dimethylamine oxides;
C12 to C14 N-(alkyl)-N,N-bis(2-hydroxyethyl)amine oxides;
C12 to C14 alkyl amido propyl dimethyl amine oxides;
C12 to C14 alkylbetaines;
C12 to C14 alkylamidobetaines;
C12 to C14 sulfobetaines;
   and any mixture of the above surfactants.

For hand dishwashing detergents, the amphoteric/zwitterionic surfactant is most preferred selected from the group consisting of C12 to C14 alkylbetaines, and any mixture thereof.

In a preferred variant, the detergent and cleaning composition according to the present invention comprises an anionic surfactant or a mixture of two or even more anionic surfactants selected from the group consisting of
C10 to C18 alkyl benzene sulfonates;
C10 to C18 alkyl sulfates;
C10 to C18 alkyl sulfates, ethoxylated with 1 to 3 moles ethylene oxide;
C10 to C18 alpha-olefin sulfonates;
C8 to C18 alkyl carboxylates, ethoxylated with 1 to 10 moles ethylene oxide; and
their preferred variants as specified before.

In a more preferred variant, the detergent and cleaning composition according to the present invention comprises a cationic surfactant or a mixture of two or even more cationic surfactants selected from the group consisting of
quaternary C8 to C18 alkyl ethanolamines;
quaternary C8 to C18 alkyl ammonium compounds;
C8 to C18 alkyl ammonium methosulfates; and
their preferred variants as specified before.

In a still more preferred variant, the detergent and cleaning composition according to the present invention comprises a non-ionic surfactant or a mixture of two or even more non-ionic surfactants selected from the group consisting of
C8 to C15 fatty alcohols, ethoxylated with 3 to 8 moles ethylene oxide;
alkoxylated C8 to C15 fatty alcohols such as
C8 to C15 fatty alcohols, ethoxylated with 1 to 25 moles ethylene oxide,
C8 to C15 fatty alcohols, propoxylated with 1 to 15 moles propylene oxide,
C8 to C15 fatty alcohols, butoxylated with 1 to 10 moles butylene oxide,
   and combinations thereof;
C8 to C18 sophorolipids;
C8 to C18 rhamnolipids;
C7 to C15 alkyl polyglycosides;
C8 to C15 alkanolamides;
C8 to C15 fatty acid ester alkoxylates; and
their preferred variants as specified before.

The above specified surfactants can be used either singular or in the form of mixtures of two, three, or even more surfactants, either from the same surfactant category (anionic, cationic, non-ionic, amphoteric/zwitterionic) or as mixture of surfactants of different surfactant categories.

In a most preferred variant, the detergent and cleaning composition according to the present invention comprises a combined mixture of one or even more of anionic surfactant and one or even more of non-ionic surfactant as specified herein, i.e. a combination of one or more anionic surfactant and one or more non-ionic surfactant.

Alternatively, the detergent and cleaning composition according to the present invention comprises a combined mixture of one or even more of cationic surfactant and one or even more of non-ionic surfactant as specified herein, i.e. a combination of one or more cationic surfactant and one or more non-ionic surfactant.

The above numeric ranges recited with respect of the number of C atoms of the surfactants, given in the form “Cx to Cy” include the values defining the range and include each integer within the defined range, the range C10 to C18 includes C10, C11, C12, C13, C14, C15, C16, C17 and C18. For example, the term “C10 to C18 alkyl” includes decyl, undecyl, dodecyl, tridecyl, tetradecyl, pentadecyl, hexadecyl, heptadecyl and octadecyl. Analogously, the term “C12 to C14 alkyl” includes dodecyl, tridecyl and tetradecyl. For example, the term “C6 to C18 fatty alcohols” includes fatty alcohols having a carbon chain with 6, 7, 8, 9, 10, 11, 12, 13, 14, 15, 16, 17, or 18 carbon atoms. Analogously, the term “C6 to C18 rhamnolipids” includes structures comprising a rhamnolipid and a carbon chain having 6, 7, 8, 9, 10, 11, 12, 13, 14, 15, 16, 17 or 18 carbon atoms.

### Further Enzyme Stabilizer/Component (d1, d2, d3, d)

The enzymatic detergent and cleaning composition according to the first and second aspect of the present invention optionally comprises at least one further enzyme stabilizer (d1, d2, d3, d), which is different from the enzyme stabilizing agent (b1, b2, b3, b), to further stabilize the enzyme in the detergent and cleaning composition from loss of performance (i.e. retain proteolytic activity or enzymatic retention). The enzymes are stabilized by the further enzyme stabilizer through a physical protection by means of a protective layer.

Negatively charged anionic surfactants trap Ca and/or Mg ions from the wash liquor and form a complex. This complex formation leads to a reduction in washing performance. To prevent this complex formation, chelating agents such as EDTA, HEDP etc. are added to the detergent and cleaning composition. However, these chelating agents do not only complex the Ca ions and/or Mg ions from the wash liquor, but also trap the Ca ions and Mg ions from the surface of the enzymes, which in turn leads to a denaturation. Thus, the enzymes lose their active form, which in turn results in a reduction of the enzymatic activity. Thus, enzyme stabilizers are added to the detergent and cleaning composition, which protect the enzymes. Accordingly, the chelating agent can only capture Ca ions and/or Mg ions from the wash liquor but can no longer trap Ca ions and/or Mg ions from the surface of the enzyme. Thus, the enzyme activity can be maintained by the addition of enzyme stabiliser.

The formulation of the detergents and cleaning compositions may vary based upon the particular enzymes employed.

The enzymes employed herein are stabilized by the presence of water-soluble sources of calcium and/or magnesium ions in the finished detergents and cleaning compositions which provide such ions to the enzymes. Calcium ions are generally somewhat more effective than magnesium ions and are preferred herein if only one type of cation is being used. Typical detergents and cleaning compositions, especially liquids, comprise from 1 to 30, preferably from 2 to 20, more preferably from 5 to 15, and most preferably from 8 to 12, millimoles of calcium ion per liter of finished composition.

It is to be understood that the foregoing levels of calcium and/or magnesium ions are sufficient to provide enzyme stability. More calcium and/or magnesium ions can be added to the compositions to provide an additional measure of grease removal performance. Accordingly, as a general proposition the compositions herein will typically comprise from 0.01% to 2% by weight of a water-soluble source of calcium or magnesium ions, or both. The amount can vary, of course, with the amount and type of enzyme employed in the composition.

Additional enzyme stability can be provided by the presence of various other art-disclosed stabilizers, especially borate species, see U.S. Pat. No. 4,537,706, which is incorporated herein in its entirety.

One group of stabilizers are reversible protease inhibitors. Benzamidine hydrochloride, borax, boric acids, boronic acids or their salts or esters are frequently used for this purpose, including in particular derivatives having aromatic groups. Typically, such enzyme stabilizers are used at levels in the compositions from 0.05% to 5%, more preferably from 0.075% to 3% by weight of boric acid or other borate compound capable of forming boric acid in the composition (calculated on the basis of boric acid). Boric acid is preferred, although other compounds such as boric oxide, borax and other alkali metal borates (e.g., sodium ortho-, meta- and pyroborate, and sodium pentaborate) are suitable. Substituted boric acids (e.g., phenylboronic acid, butane boronic acid, and p-bromo phenylboronic acid) can also be used in place of boric acid.

Also peptide aldehydes, i.e. oligopeptides having a reduced C-terminus, in particular those from 2 to 50 monomers, or hydrogen sulfite adducts thereof are used for this purpose. The peptidic reversible protease inhibitors include, but are not limited to, ovomucoid and leupeptin. Specific, reversible peptide inhibitors for the protease subtilisin and fusion proteins from proteases and specific peptide inhibitors are also suitable for this purpose.

Further enzyme stabilizers are amino alcohols such as mono-, di-, triethanol- and propanolamine and mixtures thereof, aliphatic carboxylic acids up to C12, such as succinic acid, other dicarboxylic acids or salts of the acids mentioned.

End-capped fatty acid amide alkoxylates are also suitable for this purpose.

Preferably, the further enzyme stabilizer (d1, d2, d3, d) in the detergent and cleaning composition according to the present invention is selected from the group consisting of polyols such as glycol, such as monopropylene glycol, glycerine, mannitol, isomaltol, sorbitol, xylitol, threitol, erythritol, arabitol; amino alcohols such as mono-, di-, triethanolamine and -propanolamine; aliphatic carboxylic acids up to C12, such as succinic acid and salts thereof; dicarboxylic acids and salts thereof; end-capped fatty acid amide alkoxylates; salts, preferably calcium and magnesium salts, such as calcium chloride, calcium formate, magnesium chloride, magnesium formate; reversible enzyme inhibitors such as borate-containing compositions, such as 4-FBPA, boron-free inhibitors, such as disubstituted alaninamide, sodium formate; and any mixture thereof.

Most preferred, the further enzyme stabilizer (d1, d2, d3, d) in the detergent and cleaning composition according to the present invention is selected from the group consisting of calcium chloride, calcium formate, magnesium chloride, magnesium formate, and any mixture thereof.

Furthermore, with the addition of said further enzyme stabilizer, it can be prevented that the negatively charged anionic surfactants form a complex with Ca ions and/or Mg ions from the washing liquid thereby reducing or losing their washing performance.

Preferably, the at least one enzyme (a1, a2, a3, a) is added to the detergent and cleaning composition according to the first and second aspect of the present invention as enzyme formulation in mixture with at least one further enzyme stabilizer (d1, d2, d3, d), as specified above, and optionally buffers, and the like.

In a further preferred variant, the at least one enzyme (a1, a2, a3, a) is added to the detergent and cleaning composition according to the present invention as enzyme formulation in mixture with one or more further enzyme stabilizer(s) (d1, d2, d3, d) and with a specific type of enzyme stabilizing agent (b1, b2, b3, b), such as alkanediols as defined herein, glyceryl caprylate, 4-hydroxyacetophenone, ethyl hexyl glycerin, tropolone, or a mixture of said enzyme stabilizing agents, which are different from the further enzyme stabilizer, and optionally buffers, and the like.

Surprisingly, it turned out that the addition of an enzyme stabilizing agent (b1, b2, b3, b) as defined herein enhances or boosts the enzyme stabilizing effect of the further enzyme stabilizer (d1, d2, d3, d3).

Unexpectedly, the combination of an enzyme stabilizing agent (b1, b2, b3, b) and a further enzyme stabilizer (d1, d2, d3, d) results in a synergistic enzyme stabilizing effect in the detergent and cleaning composition comprising an enzyme in comparison to the single use of the enzyme stabilizing agent (b1, b2, b3, b) or to the single use of the single the further enzyme stabilizer (d1, d2, d3, d).

A particular boosting effect could be observed, for a combined use of an enzyme stabilizing agent (b1, b2, b3, b), such as alkanediols having a carbon chain of 5 to 14 carbon atoms, glyceryl caprylate, 4-hydroxyacetophenone, ethyl hexyl glycerin, tropolone, or a mixture of said enzyme stabilizing agents and an enzyme stabilizer (d1, d2, d3, d) comprising calcium chloride, calcium formate, magnesium chloride, magnesium formate, and any mixture thereof.

For the detergent and cleaning composition according to the present invention and the enzyme formulation, the list of enzyme stabilizing agents (b1, b2, b3, b) specified herein can be arbitrary combined with the list of the further enzyme stabilizer (d1, d2, d3, d) specified herein.

A remarkable synergistic enzyme stabilizing effect is observed, when one or more of the following enzyme stabilizing agents (b1, b2, b3, b) is/are used in combination with one or more further enzyme stabilizers (d1, d2, d3, d), as defined herein, preferably calcium chloride, calcium formate, magnesium chloride, magnesium formate, and any mixture thereof:
1,2-pentanediol;
1,2-hexanediol;
1,2-heptanediol;
1,2-octanediol;
1,2-nonanediol;
1,2-decanediol;
1,2-undecanediol;
1,2-dodecanediol;
1,2-tridecanediol;
1,2-tetradecanediol;
glyceryl caprylate;
4-hydroxyacetophenone;
ethyl hexyl glycerin;
tropolone;
a mixture comprising 1,2-hexanediol and 1,2-octanediol;
a mixture comprising 1,2-hexanediol and 1,2-octanediol and tropolone; and
a mixture comprising 4-hydroxyacetophenone and 1,2-octanediol.

Hence, the combined addition of an enzyme stabilizing agent as defined herein and a further enzyme stabilizer results in an improved enzyme stability compared to the enzyme stabilisation effect of the single agents. The detergent and cleaning compositions comprising said mixtures show improved cleaning properties compared to a detergent and cleaning compositions without the addition of such mixtures.

### Optional Further Components

Within the context of the present invention, it is also possible, and in some cases advantageous, to combine the detergents and cleaning compositions according to the first aspect or second aspect of the present invention with other active substances and/or additives, depending on the purpose of the composition, in order to obtain a ready-for-use composition or formulation. The active ingredients provide desired properties and functionalities to the detergents and cleaning compositions according to the present invention. The term “functional ingredient” or “functional additive” includes an ingredient that provides a beneficial property in a particular use. Some particular examples of functional ingredients are discussed in more detail below. However, a broad variety of other functional ingredients may also be used.

The detergents and cleaning compositions according to the present invention may comprise any of the ingredients customarily found in such compositions, such as, for example organic solvents, builders, and additional auxiliaries such as soil repellents, thickeners, colorants and fragrances or the like.

Preferably, the detergent and cleaning composition according to the present invention can advantageously be combined or varied with at least one active substance and/or at least one (functional) additive, such as for example solvents, builders, bleaching agents, soil release agents, dispersing agents, foam inhibitors, sequestrant agents, chelating agents, anti-redeposition agents, dye transfer inhibition/colour protection agents, dye scavengers, dyes, greying inhibitors, optical brighteners, ultraviolet light absorbers, thickeners or rheology modifiers, hydrotropes, solubility modifiers, pH-adjusting agents, buffers, solvents, anti-static agents, anti-wrinkling agents, antimicrobial agents, odor removal/odor capturing agents, ultraviolet light protection agents, fragrances, sanitizing agents, disinfecting agents, water repellency agents, insect repellency agents, anti-pilling agents, souring agents, mildew removing agents, allergicide agents, and any mixture thereof.

### Chelating Agents/Sequestrants

The detergents and cleaning compositions disclosed herein can optionally contain one or more chelating agents, capable of complexing iron, manganese and/or calcium ions. This additionally allows for a softening of water. In addition, negatively charged anionic surfactants trap Ca and/or Mg ions from the wash liquor and form a complex. This complex formation leads to a reduction in washing performance. To prevent this complex formation, chelating agents as described below, are also added to the detergent and cleaning composition. Hence, the addition of chelating agents allows that the performance of the anionic surfactant in the detergent and cleaning composition is not diminished.

Chelating agents can be present in the acid or salt form including alkali metal, ammonium, and substituted ammonium salts thereof, and mixtures thereof.

Preferably the chelating agent is selected from the group consisting of amino carboxylates, phosphonates or mixtures thereof.

These agents as used herein include those chemicals which interact with divalent ions, cations and anions, having tendency to precipitate in their saturated aqueous solutions.

Useful amino carboxylate chelating agents include, but are not limited to, the following: N-(1,2-dicarboxy-ethyl)-D,L-aspartic acid (IDS), N-(2-hydroxyethyl)iminodiacetic acid (EDG), aspartic acid-N-monoacetic acid (ASMA), aspartic acid-N,N-diacetic acid (ASDA), aspartic acid-N-mono-propionic acid (ASMP), iminodisuccinic acid (IDA), N-(2-sulfomethyl) aspartic acid (SMAS), N-(2-sulfoethyl) aspartic acid (SEAS), N-(2-sulfomethyl) glutamic acid (SMGL), N-(2-sulfoethyl) glutamic acid (SEGL), N-methyliminodiacetic acid (MIDA), a-alanine-N,N-diacetic acid (a-ALDA), serine-N,N-diacetic acid (SEDA), isoserine-N,N-diacetic acid (ISDA), phenylalanine-N,N-diacetic acid (PHDA), anthranilic acid-N,N-diacetic acid (AND A), sulfanilic acid-N, N-diacetic acid (SLDA), taurine-N,N-diacetic acid (TUDA), sulfomethyl-N,N-diacetic acid (SMDA), N-(hydroxyethyl)-ethylidenediaminetriacetate (HEDTA), diethanolglycine (DEG), aminotris(methylenephosphonic acid) (ATMP).

The preferred chelating agent may contain an amino group and may be, e.g., an amino-polycarboxylate or a phosphonate. It may be a monomeric molecule comprising one, two or three amino groups (typically secondary or tertiary amino groups), and it may contain two, three, four or five carboxyl groups or even more carboxyl groups. The chelating agents may be phosphorus containing or without phosphorus. Suitable chelating agents includes those based on carboxylate groups includes EDTA (ethylene diamine tetraacetate), NTA (2,2′,2″-nitrilotriacetate), citrate, 2-hydroxypropan-1,2,3-tricarboxylate, DTPA (diethylenetriaminepentaacetic acid), MGDA (methylglycinediacetic acid OT N,N′-bis(carboxymethyl)alanine), EGTA (ethylene glycol tetraacetic acid), EDDS (ethylenediamine-N,W-disuccinic acid), GLDA (L-Glutamic acid, N, N-diacetic acid), The composition preferably may also include other polycarboxylates such as PAA [poly(acrylic acid)], PAA/PMA [copoly(acrylic acid/maleic acid)], or mixtures thereof.

Another group of preferred chelating agents includes phosphonates. Aminoalkane and/or hydroxyalkane phosphonates are preferably used as phosphonates. Suitable examples of these phosphonate chelating agent includes HEDP (1-hydroxyethylidene-1,1-diphosphonic acid), EDTMP [ethylenediamine tetra(methylene phosphonic acid], EDTMPA (ethylenediaminetetramethylene-tetraphosphonic acid), DTPMP (diethylenetriamine penta (methylene phosphonic acid), DTMPA (diethylenetriaminepenta(methylenephosphonic acid)) nitrilotris(methylenephosphonic acid) (NTMP), 2-phosphonobutane-1,2,4-tricarboxylic acid (PBTC), ethylenediamine tetramethylene phosphonate (EDTMP), and the higher homologs thereof. Among the hydroxyalkane phosphonates, 1-hydroxyethane-1,1-diphosphonate (HEDP) is of particular importance. The chelating agents may contain nitrogen such as in EDTA, NTA, DTPA, PDTA, GLDA, MGDA, EDDS, EDTMP, EDTMPA, and DTPMP or ASMA, ASDA, ASMP, IDA, SMAS, SEAS, SMGL, SEGL, MIDA, a-ALDA, SEDA, ISDA, PHDA, ANDA, SLDA, TUDA, SMDA, HEDTA, DEG, ATMP, or mixtures thereof.

Particularly preferred chelating agents includes but are not limited to the following: ethylene-diamine-tetra-acetic acid (EDTA), diethylene triamine pentamethylene phosphonic acid (DTMPA, DTPMP), hydroxy-ethane diphosphonic acid (HEDP), ethylenediamine N,N-disuccinic acid (EDDS), methyl glycine di-acetic acid (MGDA), diethylene triamine penta acetic acid (DTPA), propylene diamine tetraacetic acid (PDTA), 2-hydroxypyridine-N-oxide (HPNO), methyl glycine diacetic acid (MGDA), glutamic acid N,N-diacetic acid (N,N-dicarboxymethyl glutamic acid tetrasodium salt (GLDA), nitrilotriacetic acid (NTA), sodium citrate, or mixtures thereof. The chelating agent may be present in their acid form or a salt, preferably the chelating agents may be present as a sodium, ammonium or potassium salt.

Especially preferred chelating agent includes diethylenetriamine pentacetic acid (DTPA), ethylenediamine-N,N′-disuccinic acid (EDDS) and 1,1-hydroxyethane diphosphonic acid (HEDP) or the alkali metal, potassium, alkaline earth metal, ammonium or substituted ammonium salts thereof, or mixtures thereof. The most preferred chelating agent is a phosphonate. The phosphonate chelating agent includes HEDP in its acid form or salt form with alkali metal, potassium, alkaline earth metal, ammonium or substituted ammonium.

Most preferred are the following chelating agents: GLDA, MGDA, sodium citrate, HEDP, and any mixture thereof.

In the detergents and cleaning compositions according to the present invention, the chelating agent is typically present in an amount from 0.1 to 10.0% by weight, based on the total weight of the compositions, preferably from 0.1 to 5.0% by weight, and more preferably from 0.1 to 3.0% by weight.

Preferably the detergents and cleaning compositions according to the present invention comprises at least 0.2% by weight chelating agent based on the total weight of the composition, still preferably at least 0.3% by weight, still preferably at least 0.5% by weight, most preferably at least 0.6% by weight, but typically not more than 3% by weight, still preferably not more than 2% by weight, most preferably not more than 1% by weight of the chelating agent.

However, in some automatic dish washing gels, the amount of GLDA can be from 30 to 40% by weight, based on the total weight of the composition.

### Antimicrobial Agents

The detergents and cleaning compositions can further include one or more antimicrobial agents.

The term “antimicrobial component” in the context of the present invention refers to a group of substances, in particular to agents that kills microorganisms, such as bacteria, yeast and/or fungi, or stops or inhibits their growth, which prevents products from microbial contamination. Without the addition of such agents the products spoil, which may manifest changes in smell, discoloration, mould growth, gas formation, the separation of emulsions or changes in viscosity, rendering the product unacceptable to the consumer.

Suitable antimicrobial agents include, but are not limited to, the antimicrobial classes such as phenolics, quaternary ammonium compounds, metal derivatives, amines, alkanol amines, nitro derivatives, analides, organosulfur and sulfur-nitrogen compounds and miscellaneous compounds. Exemplary phenolic agents include pentachlorophenol, orthophenylphenol, phenoxyethanol. Exemplary quaternary antimicrobial agents include benzalkonium chloride, cetylpyridiniumchloride, amine and nitro containing antimicrobial compositions such as hexahydro-1,3,5-tris(2-hydroxyethyl)-s-triazine, dithiocarbamates such as sodium dimethyldithiocarbamate, and a variety of other materials known in the art for their antimicrobial properties. Other exemplary antimicrobial agents include glutaraldehyde, Bronopol (2-bromo-2-nitropropane-1,3-diol), silver, and isothiazolones such as methylisothiazolinone, ethyl lauroyl arginate HCl, sold under the tradename Neolone™ sodium benzoate, benzyl alcohol, or methylbenzyl alcohol.

In a preferred variant according to the present invention, the detergents and cleaning compositions are further combined with benzyl alcohol, methylbenzyl alcohol, phenoxyethanol, and any mixture thereof. Said substances have a broad-spectrum activity against microorganisms and are added to the detergent compositions to inhibit microbial spoilage, and, thus, for stabilizing purposes.

In particular, the antimicrobial agents are added to liquid detergents due to their higher water content, which makes such compositions susceptible against microbial infestation and growth.

If an antimicrobial agent is included in the inventive detergents and cleaning compositions, it is preferably in an amount between about 0.0001% by weight and about 15% by weight, particularly in an amount of 0.001 to 10% by weight, most particularly in an amount of 0.001 to 5% by weight, based on the total weight of the composition.

The enzyme(s) is/are normally incorporated into the detergent and cleaning composition according to the disclosure in an amount sufficient to yield effective cleaning during a washing procedure. An amount effective for cleaning refers to an amount that produces a clean, sanitary, and, preferably, corrosion free appearance to the material cleaned, particularly for medical or dental devices or instruments. An amount effective for cleaning also can refer to an amount that produces a cleaning, stain removal, soil removal, whitening deodorizing, or freshness improving effect on substrates such as medical or dental devices or instruments and the like. Such a cleaning effect can be achieved with amounts of enzyme as low as about 0.02% by weight of the detergent and cleaning composition.

In the detergents and cleaning compositions of the present disclosure, suitable cleaning can typically be achieved when an enzyme is present at about 0.0001 to about 35% by weight; preferably about 2 to about 15% by weight; preferably about 3 to about 10% by weight; preferably about 4 to about 8% by weight; preferably about 4, about 5, about 6, about 7, or about 8% by weight. The higher enzyme levels are typically desirable in highly concentrated cleaning formulations.

In the detergent and cleaning composition of the present invention, suitable cleaning can be achieved when the enzyme is present in an amount of 0.0001 to 5% by weight, based on the total weight of the composition. Preferably, the enzyme is present in an amount of 0.0001 to 4% by weight, based on the total weight of the composition. More preferred the detergent and cleaning composition according to the present invention comprises the enzyme in an amount of 0.001 to 3% by weight, based on the total weight of the composition. Most preferred the enzyme is present in the detergent and cleaning composition in an amount of 0.01 to 2% by weight, based on the total weight of the composition. Further preferred the enzyme is present in the detergent and cleaning composition in an amount of 0.05 to 2% by weight, based on the total weight of the composition.

Typically, the enzyme is present in the detergent and cleaning composition according to the present invention in an amount of 0.05 to 2.0% by weight. Usually, proteases and amylase are used in higher concentrations in the detergents and cleaning compositions, namely proteases in an amount of 0.4 to 1.5% by weight, amylases in an amount of 0.05 to 0.6% by weight, based on the total weight of the composition.

For an enzyme cocktail the above amounts relate to the total content of the enzymes in the mixture, i.e. the amount is the sum of the content of all enzymes in the mixture.

The 1,2-heptanediol (b1) or the 2,3-heptanediol (b2) or the mixture comprising 1,2-heptanediol and 2,3-heptanediol (b3) according to the first aspect of the present invention is present in the detergent and cleaning composition in an amount of 0.001 to 15.0% by weight, based on the total weight of the composition. In a preferred variant, the detergent and cleaning composition comprises the 1,2-heptanediol (b1) or the 2,3-heptanediol (b2) or the mixture comprising 1,2-heptanediol and 2,3-heptanediol (b3) in an amount of 0.01 to 10.0% by weight, based on the total weight of the composition. In a more preferred variant, the 1,2-heptanediol (b1) or 2,3-heptanediol (b2) or the mixture comprising 1,2-heptanediol and 2,3-heptanediol (b3) is advantageously used in the detergent and cleaning composition in an amount of at 0.1 to 5.0% by weight, based on the total weight of the composition. In a still more preferred variant, the 1,2-heptanediol (b1) or 2,3-heptanediol (b2) or the mixture comprising 1,2-heptanediol and 2,3-heptanediol (b3) is advantageously used in the detergent and cleaning composition in an amount of at 0.3 to 3.0% by weight, based on the total weight of the composition. In a most preferred variant, the 1,2-heptanediol (b1) or 2,3-heptanediol (b2) or the mixture comprising 1,2-heptanediol and 2,3-heptanediol (b3) is advantageously used in the detergent and cleaning composition in an amount of at 0.5 to 1.0% by weight, based on the total weight of the composition.

For the heptanediol mixture (b3), the above amounts relate to the total content of the 1,2-heptanediol and the 2,3-heptanediol in the mixture, i.e. the amount is the sum of the content of 1,2-heptanediol and 2,3-heptanediol in the mixture.

The at least one enzyme stabilizing agent (b) according to the present invention is present in the detergent and cleaning composition in an amount of 0.001 to 15.0% by weight, based on the total weight of the composition. In a preferred variant, the detergent and cleaning composition comprises the at least one enzyme stabilizing agent (b) in an amount of 0.01 to 10.0% by weight, based on the total weight of the composition. In a more preferred variant, the at least one enzyme stabilizing agent (b) is advantageously used in the detergent and cleaning composition in an amount of at 0.1 to 5.0% by weight, based on the total weight of the composition. In a still more preferred variant, the at least one enzyme stabilizing agent (b) is advantageously used in the detergent and cleaning composition in an amount of at 0.3 to 3.0% by weight, based on the total weight of the composition. In a most preferred variant, the at least one enzyme stabilizing agent (b) is advantageously used in the detergent and cleaning composition in an amount of at 0.5 to 1.0% by weight, based on the total weight of the composition.

For the alkanediol mixture comprising at least one first linear alkanediol and one or more second linear alkanediol, the above amounts relate to the total content of the first linear alkanediol and the second linear alkanediol(s) in the mixture, i.e. the amount is the sum of the content of the first linear alkanediol and the second linear alkanediol in the mixture.

For an enzyme stabilizing agent mixture comprising two more enzyme stabilizing agents, the above amounts relate to the total content of the enzyme stabilizing agents in the mixture, i.e. the amount is the sum of the content of the single enzyme stabilizing agents in the mixture.

In a particular preferred variant according to the first aspect of the present invention, the detergent and cleaning composition comprises the 2,3-heptanediol or the 2,3-heptanediol of the mixture comprising 1,2-heptanediol and 2,3-heptanediol (b3) in an amount of 0.001 to 15.0% by weight, preferred in an amount of 0.01 to 10.0% by weight, more preferred in an amount of 0.1 to 5.0% by weight, still more preferred in an amount of 0.3 to 3.0% by weight, and most preferred in an amount of 0.5 to 1.0% by weight, based on the total weight of the composition.

Even more preferred, the detergent and cleaning composition comprises the 2,3-heptanediol or the 2,3-heptanediol of the mixture comprising 1,2-heptanediol and 2,3-heptanediol (b3) in an amount of 0.001 to 0.5% by weight, preferably in an amount of 0.005 to 0.1% by weight and most preferably in an amount of 0.01 to 0.075% by weight, based on the total weight of the composition or homecare product.

In a particular preferred variant according to the present invention, the detergent and cleaning composition comprises the 2,3-alkandediol as linear alkanediol or of the mixture comprising at least one first linear alkanediol and one or more second linear alkanediol in an amount of 0.001 to 15.0% by weight, preferably in an amount of 0.01 to 10.0% by weight, more preferred in an amount of 0.1 to 5.0% by weight, still more preferred in an amount of 0.3 to 3.0% by weight, and most preferred in an amount of 0.5 to 1.0% by weight, based on the total weight of the composition or homecare product.

Even more preferred, the detergent and cleaning composition comprises the 2,3-alkanediol as linear alkanediol or of the mixture comprising at least one first linear alkanediol and one or more second linear alkanediol in an amount of 0.001 to 0.5% by weight, preferably in an amount of 0.005 to 0.1% by weight and most preferably in an amount of 0.01 to 0.075% by weight, based on the total weight of the composition or homecare product.

Typically, the at least one surfactant is present in the detergent and cleaning composition according to the present invention in an amount of more than 3% by weight, based on the total weight of the composition. Preferably, the surfactant is present in an amount of 4 to 90% by weight, based on the total weight of the composition. More preferred, the detergent and cleaning composition according to the present invention comprises the surfactant in an amount of 10 to 60% by weight, still more preferred in an amount of 20 to 50% by weight and most preferred in an amount of 30 to 40% by weight, based on the total weight of the composition.

By contrast, light-duty compositions according to the first and second aspect of the present invention comprise the at least one surfactant in an amount of more than 3% by weight to 40% by weight, based on the total weight of the composition. Preferably, the surfactant is present in an amount of 4 to 30% by weight, based on the total weight of the composition. The dish cleaning and/or rinsing composition according to the present invention comprises the surfactant in an amount of 5 to 20% by weight and preferred in an amount of 6 to 15% by weight, based on the total weight of the composition.

The at least one further enzyme stabilizer is present in the detergent and cleaning composition according to the first and second aspect of the present invention in an amount of 0.0001 to 5% by weight, based on the total weight of the composition. Preferably, the further enzyme stabilizer is present in an amount of 0.001 to 4% by weight, based on the total weight of the composition. Most preferred, the detergent and cleaning composition according to the first and second aspect of the present invention includes the further enzyme stabilizer in an amount of 0.01 to 3% by weight, based on the total weight of the composition.

The detergents and cleaning compositions according to the present invention are found, surprisingly, to have a superior enzyme stability. The more stable the enzyme in the compositions is, the longer they are effective in removing soil and stain. As a result, the detergents and cleaning compositions according to the present invention are enzymatical more effective over time compared to detergents and cleaning compositions without the addition of an inventive enzyme stabilizing agent.

In particular, it has been found that the addition of an effective amount of a specific type of an enzyme stabilizing agent, such as alkanediols, glyceryl caprylate, 4-hydroxyacetophenone, ethyl hexyl glycerin, tropolone, or a mixture of said enzyme stabilizing agents, as defined herein in detail, to a detergent and cleaning composition, result in outstanding enzyme stabilizing properties as demonstrated in the following examples, and significantly retard the rate of enzyme inactivation in a detergent and cleaning composition during storage. Such detergent and cleaning compositions show improved cleaning properties in comparison to a detergent and cleaning composition without the addition of such enzyme stabilizing agents.

It is unexpectedly observed that adding an enzyme stabilizing agent or an enzyme stabilizing cocktail as specified above can stabilize an enzyme in a detergent and cleaning composition. Without being bound by theory, it is assumed that with the addition of an enzyme stabilizing agent as specified herein, a protective layer, specially preferred a coating, is created around the enzyme/enzymes to keep it/them stable or resistant against harsh ingredients within the detergent and cleaning composition as it is assumed for the known enzyme stabilizer glycol.

In particular, adding an enzyme stabilizing agent or an enzyme stabilizing cocktail as specified above to a detergent and cleaning composition containing an enzyme can maintain the enzyme's activity for an extended period of time during storage of the composition. The enzyme stabilizing agent according to the present invention has a positive influence on the enzyme performance in that it significantly retards the rate of enzyme deactivation during storage. Hence, the enzymes' activity remains higher than those from a detergent and cleaning composition that do not contain such an inventive enzyme stabilizing agent. The more stable the enzymes are, the longer they are effective in removing soil, protein, starch and fats, etc. As a result, the detergent and cleaning composition disclosed herein shows a better cleaning performance after storage, compared to a detergent and cleaning composition without the enzyme stabilizing agent or enzyme stabilizing cocktail.

Additionally, with the addition of such enzyme stabilizing agents as defined herein, the enzyme stabilizing effect of a further enzyme stabilizer added to the detergent and cleaning composition, can even be improved.

Thus, the enzymatic stabilization allows the detergents and cleaning compositions to be stored without or at least considerably reduced enzymatic degradation and deterioration. Surprisingly, with the enzyme stabilizing agent according to the present invention, the storage life of the detergent and cleaning composition can be extended without no or less enzyme deactivation, in comparison to compositions without the inventive enzyme stabilizing agent.

Beneficially, the enzymatic detergents and cleaning compositions according to the present invention demonstrate storage stability, while retaining enzymatic efficacy compared to detergents and cleaning compositions without an inventive enzyme stabilizing agent.

Further, the enzymatic detergents and cleaning compositions according to the present invention demonstrate improved storage stability, such that they can be stored at temperatures greater than standard room temperature (25 °C), preferably at least 30 °C, more preferably at least 35 °C, for at least 2 weeks, more preferably for at least 4 weeks, still more preferably for at least 6 weeks, most preferably for at least 8 weeks, and most preferred for at least 12 weeks, while retaining enzymatic efficacy, and, thus resulting in a better cleaning performance.

Surprisingly, the enzyme stabilizing agent according to the present invention provides for enzyme stability for detergents and cleaning compositions over a broad pH-range of pH 3 to pH 12. Hence, the inventive enzyme stabilizing agent allows to stabilize enzymes in a variety of detergents and cleaning compositions having different pH-values either in the acidic, basic or neutral pH-range. This is particularly advantageously for detergents and cleaning compositions, having an acidic or basic pH-value, such as bathroom cleaners or kitchen cleaners, in which enzymes tend to be inactive or instable.

Without the use of an enzyme stabilizing agent as specified herein, the enzymatic stability in the detergent and cleaning composition comprising an enzyme as defined herein, would decrease during storage, so that cleaning performance of the detergent and cleaning composition would be reduced upon use.

The enzyme stabilizing effect is demonstrated in the following examples by real washing/cleaning tests. As shown in this disclosure, a use solution produced from the detergent and cleaning composition according to the present invention, stays active for a much longer time, compared to a detergent and cleaning composition without the addition of an inventive enzyme stabilizing agent.

This enzyme stabilizing effect leads to a more effective composition due to a prolonged activity for removing soils or stain.

Beneficially, the stability improvement further allows to reduce use of enzymes, enzyme stabilizers or some other ingredients commonly used in detergents and cleaning compositions. Because of the superior stability of enzymes in the detergent and cleaning composition of the present disclosure, it is possible for the composition to use less enzymes without loss of cleaning performance.

Because of the superior stability of enzymes in the detergent and cleaning composition of the present disclosure, it is possible for the composition to have reduced or to even be free of other enzyme stabilizers, such as glycerol, or other ingredients commonly used in existing detergents and cleaning compositions. Some stabilizers could be difficult to be included in a detergent and cleaning composition or could lead to undesirable reactions with other ingredients. Some stabilizers raise health/safety/labelling concerns in a concentrated composition (e.g. GHS label icon warnings that are not desired). It is an extra advantage that no or a reduced amount of other enzyme stabilizers is used to produce the detergent and cleaning disclosed here.

Thus, in a preferred variant, the detergent and cleaning composition according to the present invention has fewer other components or is even free of further enzyme stabilizers which are different to the enzyme stabilizing agent as specified above, such as a reduced amount of borate including ingredients.

According to a further aspect of the present invention, the detergent and cleaning composition according to the first and second aspect of the present invention is used as such or for the preparation of a detergent and cleaning product.

The enzymatic detergents and cleaning compositions or products as specified herein can be employed in a variety of cleaning methods. As used herein, the term “cleaning” refers to perform, facilitate, or aid in soil removal, bleaching, microbial population reduction, disinfection, etc. Preferably, the enzymatic detergents and cleaning compositions or products are useful for textile cleaning, laundry, dishwashing, fabric care, for household, institutional and industrial hard surfaces cleaning, such as ware or other surfaces, cleaning medical and dental instruments, etc.

Preferably, the enzymatic detergents and cleaning compositions or products can be employed for cleaning, washing, or pre-soaking medical or dental devices, instruments, or equipment, including any of the various medical or dental instruments or devices that can benefit from cleaning with enzyme cleaning composition. Exemplary medical and dental instruments and devices include instruments, devices, tools, appliances, apparatus, and equipment used in medicine or dentistry including those than can be cold sterilized, soaked or washed and then heat sterilized. The medical and/or dental instruments can be soiled with blood, mammalian tissue, including but not limited to human tissue, or other foreign matter.

Suitable examples of detergents and cleaning compositions or products encompass heavy-duty detergents, colour-care detergents, light-duty detergents, all-purpose washing agents, fabric softeners, fabric laundry scents, scent lotions, laundry wipes, stain and/or soil removers (pre spotting, Vanish type), degreasing cleaner, washing machine cleaner, all-purpose cleaners, hand dishwashing detergents, auto dishwashing detergents, hard surface cleaners, glass and mirror cleaners, wet cleaning wipes, kitchen cleaners, cleaners for cooking appliances, oven cleaners, floor cleaners, wood floor cleaners, carpet cleaners, bathroom and shower cleaners, toilet cleaners, grout cleaners, disinfectants, drain unblockers, toilet rim block gels, air fresheners, furniture polish, car shampoo, medical cleaning products, and the like.

The afore-mentioned detergents and cleaning compositions or products refer to compositions or products in the form of a liquid, a solid, tablets, encapsulated, diluted or concentrated form and optionally in two-compartment or multi-compartment form.

As used herein, a liquid includes free-flowing liquids, as well as pastes, gels, foams and mousses. Non-limiting examples of liquids include light-duty and heavy-duty liquid detergents and cleaning compositions, fabric enhancers, detergent gels commonly used for laundry, bleach and laundry additives. Gases, e.g. suspended bubbles, or solids, e.g. particles, may be included within the liquids.

A solid as used herein, includes powders, flakes, granules, pellets, tablets, microcapsules, beads, noodles, pearlized balls, lozenges, pucks, briquettes, bricks, blocks, or another solid form known to those of skill in the art.

A solid detergent and cleaning composition or product can be provided as a pressed solid block, a cast solid block, an extruded pellet or block, or a tablet. Furthermore, a solid detergent composition or product may be provided in the form of a unit dose. A unit dose refers to a solid detergent and cleaning composition unit sized so that the entire unit is used during a single washing cycle.

A solid detergent and cleaning composition or product may also be provided in the form of a multiple use (e.g., multi-use) solid, such as, a block or a plurality of pellets, and can be repeatedly used to generate aqueous use solutions of the detergent composition for multiple cycles or a predetermined number of dispensing cycles. A multiple use solid detergent composition can be repeatedly used to generate an aqueous detergent composition, e.g., use solution, for multiple washing cycles. Pressed solid detergent blocks are made suitable to provide stability such that reactive components in the compositions do not react with each other until a point of dilution and/or use. In some aspects, the order of introducing the components to form the solid are non-limiting as there is minimal and/or no water introduced into the solid compositions. However, in some aspects, pressed solid detergent blocks are made by using a binding system to minimize any damage to the coated granules which may be employed. Beneficially, a pressing process to make the pressed solid detergent blocks generates a pressed solid detergent block and prevents the reaction or mix of the components. In an aspect of the disclosure, the solid detergent composition remains unreacted or unmixed until a point of use, e.g. dilution.

In a pressed solid process, a flowable solid, such as granular solids or other particle solids including binding agents are combined under pressure. In a pressed solid process, flowable solids of the compositions are placed into a form (e.g., a mold or container). The method can include gently pressing the flowable solid in the form to produce the solid cleaning composition.

The enzymatic detergents and cleaning compositions or products can be provided in concentrated form and diluted to a use solution or provided in a use solution. Preferably, the use compositions are diluted to a concentration between about 500 ppm and about 5000 ppm, more preferably between about 750 ppm and about 4500 ppm, most preferably between about 1000 ppm and about 4000 ppm.

The enzymatic detergents and cleaning compositions or products according to the present invention are used for household cleaning, medical cleaning, institutional cleaning, such as cleaning in schools, airports, hospitals, or industrial cleaning.

The enzymatic detergents and cleaning compositions or products according to the present invention can be prepared by combining and mixing the various ingredients according to usual and known methods. Preferably, the enzyme is added last to prevent denaturation or inactivation of the enzyme. Mixing can be performed by any suitable automatic or manual method. For example, automatic or manual stirring can be performed. The enzymatic detergent compositions can be prepared in batch or continuous process.

Based on its afore described advantageously effects, the detergent and cleaning composition according to the present invention, comprising a combination of an enzyme and an enzyme stabilizing agent such as alkanediols, glyceryl caprylate, 4-hydroxyacetophenone, ethyl hexyl glycerin and/or tropolone, is particularly efficient in washing and cleaning processes for efficiently removing stain and/or soil from substrates.

Thus, the present invention relates in a further aspect to a method of treating a stained and/or soiled substrate, comprising the steps of
treating the substrate with the detergent and cleaning composition or product according to the present invention; and
rinsing said substrate in water to remove said composition or product.

Preferably, the method of treating a soiled/stained substrate takes place in a washing containing a wash liquor comprising water and the enzymatic detergent and cleaning composition according to the present invention. The wash liquor may be applied to the substrate or the substrate may be immersed into the wash liquor.

The method may alternatively comprise direct application of the enzymatic detergent and cleaning composition, i.e. undissolved without water on to part or whole of the substrate, so as to directly treat a stain and/or soil on the substrate. Such a process is preferably a pre-treatment and may be followed by treatment with or within a wash liquor.

The method according to the present invention is applied at both higher temperatures and well as lower temperatures. Ware wash applications, for example, clean substrates at temperatures in excess of approximately 60 °C, or in excess of approximately 70 °C, or between approximately 65 °C to 80 °C. Laundry applications, for example, clean laundry at temperatures in excess of approximately 40 °C, or in excess of approximately 50 °C, or between approximately 65 °C to 90 °C.

Preferably, the method is applied at low temperatures where removal of stain and/or soil is more problematic. Preferably, the treatment temperature is less than 50 °C and preferably less than 40 °C and more preferably less than 30 °C.

The enzymatic detergent and cleaning composition according to the present invention is particularly efficient in stain and/or soil removal at said low temperatures.

Thus, the method allows for enzymatic removal of stain and/or soil in a low temperature range, without consideration to the temperature sensitivity of the used enzyme(s).

This is particularly advantageous in the treatment of sensitive substrates such as wool, silk, and synthetic fibers such as polyester, polyacrylic, nylon, which can be washed or cleaned only at low temperatures.

Preferably, the substrate is cotton.

More preferably, the substrate is wool or silk.

Still more preferred, the substrates are blended fabrics such as cotton and polyester, or synthetic fibers, such as polyester, polyacrylic, or nylon.

Based on the advantageously enzyme stabilizing effects, as described above for the enzyme stabilizing agents, the present invention relates in a further aspect to the use of at least one enzyme stabilizing agent selected from the group consisting of
(b^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined herein;
(b^{II}) glyceryl caprylate;
(b^{III}) 4-hydroxyacetophenone;
(b^{IV}) ethyl hexyl glycerin;
(b^{V}) tropolone; and
any mixture thereof; for stabilizing an enzyme in a detergent and cleaning composition.

With respect to the enzyme stabilizing agents and preferred variants thereof, reference is made to the above description in connection with the detergents and cleaning composition according to the present invention, which is equally valid in connection with the use of at least one enzyme stabilizing agent for stabilizing an enzyme in a detergent and cleaning composition, in order to avoid repetition.

With respect to the enzyme and preferred variants thereof, reference is made to the above description of the enzyme(s) in connection with the detergents and cleaning composition according to the present invention, which is equally valid in connection with the use of at least one enzyme stabilizing agent (b) for stabilizing an enzyme in a detergent and cleaning composition, in order to avoid repetition.

Preferably, the enzyme is selected from the group consisting of proteases, amylases, lipases, cellulases, cutinases, gluconases, peroxidases, pectinases, mannanases, esterases, hemicellulases, xylanases, phospholipases, pectate lyases, keratinases, reductases, nucleases (including DNase and/or RNase), phenoloxidases, lipoxygenases, ligninases, pullulanases, tannases, pentosanases, malanases, ß-glucanases, arabinosidases, hyaluronidases, chondroitinases, oxidoreductases, and any mixture thereof.

More preferred, the enzyme is selected from the group consisting of proteases, amylases, lipases, cellulases, mannanases, pectate lyases, and any mixture thereof.

It was surprisingly found that the use of at least one enzyme stabilizing agent, as specified herein, stabilizes an enzyme in a detergent and cleaning composition during storage, resulting in a better cleaning performance, compared to a detergent and cleaning composition without said enzyme stabilizing substances.

Thus, the use of the afore-mentioned substances allows for the stabilization of enzymes in a detergent and cleaning composition, in particular during storage. This superior effect is based on the combination of the enzyme and the enzyme stabilizing agent resulting in a superior enzyme stabilization.

Because of the improved enzyme stabilizing effect, the amount of an enzyme in a detergent and cleaning composition comprising an enzyme can be reduced and the use of further enzyme stabilizers can be almost eliminated or at least reduced while providing for a stabilized enzymatic detergent and cleaning composition.

Furthermore, surprisingly the at least one enzyme stabilizing agent, as specified herein, can be used as enzyme stabilizing agent instead of commercially available enzyme stabilizers (as described as further enzyme stabilizers before); thus it is possible for the composition to use less enzyme stabilizers, such as a reduced amount of for example borate including ingredients.

Based on the advantageously enzyme stabilizing effects, as described above for the enzyme stabilizing agents, the present invention finally relates to a method of stabilizing an enzyme in a detergent and cleaning composition, comprising the steps of
i. providing a detergent and cleaning composition comprising an enzyme; and
ii. adding thereto an effective amount of at least one enzyme stabilizing agent selected from the group consisting of
   (b^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined herein;
   (b^{II}) glyceryl caprylate;
   (b^{III}) 4-hydroxyacetophenone;
   (b^{IV}) ethyl hexyl glycerin;
   (b^{V}) tropolone; and
   any mixture thereof.

With respect to the enzyme stabilizing agents and preferred variants thereof, reference is made to the above description in connection with the detergents and cleaning composition according to the present invention, which is equally valid in connection with the use of at least one enzyme stabilizing agent for stabilizing an enzyme in a detergent and cleaning composition, in order to avoid repetition.

With respect to the enzyme and preferred variants thereof, reference is made to the above description of the enzyme(s) in connection with the detergents and cleaning composition according to the present invention, which is equally valid in connection with the method of stabilizing an enzyme in a detergent and cleaning composition, in order to avoid repetition.

Preferably, the enzyme is selected from the group consisting of proteases, amylases, lipases, cellulases, cutinases, gluconases, peroxidases, pectinases, mannanases, esterases, hemicellulases, xylanases, phospholipases, pectate lyases, keratinases, reductases, nucleases (including DNase and/or RNase), phenoloxidases, lipoxygenases, ligninases, pullulanases, tannases, pentosanases, malanases, ß-glucanases, arabinosidases, hyaluronidases, chondroitinases, oxidoreductases, and any mixture thereof.

More preferred, the enzyme is selected from the group consisting of proteases, amylases, lipases, cellulases, mannanases, pectate lyases, and any mixture thereof.

During storage of detergents and cleaning compositions, the enzyme contained therein are damaged for example, by inactivation, denaturation or disintegration, for example by physical influences such as temperatures above 35 °C, oxidation or proteolytic cleavage. Subsequently, the detergent and cleaning composition loss their enzymatic performance.

Surprisingly, it has been found that the addition of an effective amount of at least one enzyme stabilizing agent, as defined herein, to a detergent and cleaning composition comprising an enzyme, has a positive impact in that they the significantly retard the rate of enzyme deactivation by efficiently stabilizing the enzymes. The enzyme(s) in these detergents and cleaning compositions show(s) a superior stability during storage, thus keeping performance overtime. More specifically, the enzymatic detergents and cleaning compositions demonstrate stability after storage for at least 2 weeks and at temperatures over standard ambient temperature (25 °C), in particular temperatures above 35 °C.

Hence, the addition of one of the afore-mentioned enzyme stabilizing substances to detergents and cleaning compositions is beneficial in a method for the stabilization of enzymes contained therein during storage. The combination of the inventive enzyme stabilizing agents with enzymes contributes to a more effective enzyme stabilization during storage and results in improved cleaning performance of the detergent and cleaning composition, compared to a detergent and cleaning composition without said enzyme stabilizing agents.

Additionally, based on the improved enzymes' stability, in particular during storage, the enzyme can function longer and therefore provide more cleaning efficacy through effective removing of stain and/or soil.

Conversely, also because of the superior stability of the enzyme, the amount of enzyme or of further enzyme stabilizers and other ingredients for increasing the enzyme's stability in these detergents and cleaning compositions can be reduced without loss of cleaning performance.

The present invention relates in a final aspect to an enzyme composition, comprising or consisting of
(A) at least one enzyme;
(B) at least one enzyme stabilizing agent selected from the group consisting of
   (B^{I}) a mixture comprising at least one first linear alkanediol having a carbon chain of 5 to 14 carbon atoms and one or more second linear alkanediol having a carbon chain of 5 to 14 carbon atoms which is different from the first linear alkanediol;
   (B^{II}) glyceryl caprylate;
   (B^{III}) 4-hydroxyacetophenone;
   (B^{IV}) ethyl hexyl glycerin;
   (B^{V}) tropolone; and
   any mixture thereof; and
(C) at least one further enzyme stabilizer which is different from the enzyme stabilizing agent (B).

With respect to the enzyme (A) and preferred variants thereof, reference is made to the above description of the enzyme(s) in connection with the detergents and cleaning composition according to the present invention, which is equally valid in connection with the enzyme composition, in order to avoid repetition.

Preferably, the enzyme (A) in the enzyme composition is selected from the group consisting of proteases, amylases, lipases, cellulases, cutinases, gluconases, peroxidases, pectinases, mannanases, esterases, hemicellulases, xylanases, phospholipases, pectate lyases, keratinases, reductases, nucleases (including DNase and/or RNase), phenoloxidases, lipoxygenases, ligninases, pullulanases, tannases, pentosanases, malanases, ß-glucanases, arabinosidases, hyaluronidases, chondroitinases, oxidoreductases, and any mixture thereof.

With respect to the enzyme stabilizing agent (B) and preferred variants thereof, reference is made to the above description of the enzyme stabilizing agents in connection with the detergents and cleaning composition according to the present invention, which is equally valid in connection with the enzyme composition, in order to avoid repetition.

In a preferred variant, the enzyme stabilizing agent (B) is selected from the group consisting of glyceryl caprylate, 4-hydroxyacetophenone, ethyl hexyl glycerin, tropolone, a mixture comprising a 1,2-alkanediol and a 2,3-alkanedkol, a mixture comprising 1,2-hexanediol and 1,2-octanediol, a mixture comprising 1,2-hexanediol and 1,2-octanediol and tropolone, a mixture comprising 4-hydroxyacetophenone and 1,2-octanediol, and any mixture thereof.

In an advantageously variant, the enzyme composition according to the present invention comprises one of the following combinations of components (A) and (B):
proteases plus one or more of the following enzyme stabilizing agents: (B^{I}) a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above; (B^{II}) glyceryl caprylate; (B^{III}) 4-hydroxyacetophenone; (B^{V}) ethyl hexyl glycerin; or (B^{V}) tropolone; or
lipases plus one or more of the following enzyme stabilizing agents: (B^{I}) a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above; (B^{II}) glyceryl caprylate; (B^{III}) 4-hydroxyacetophenone; (B^{IV}) ethyl hexyl glycerin; or (B^{V}) tropolone; or
amylases plus one or more of the following enzyme stabilizing agents: (B^{I}) a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above; (B^{II}) glyceryl caprylate; (B^{III}) 4-hydroxyacetophenone; (B^{IV}) ethyl hexyl glycerin; or (B^{V}) tropolone; or
cellulases plus one or more of the following enzyme stabilizing agents: (B^{I}) a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above; (B^{II}) glyceryl caprylate; (B^{III}) 4-hydroxyacetophenone; (B^{IV}) ethyl hexyl glycerin; or (B^{V}) tropolone; or
mannanases plus one or more of the following enzyme stabilizing agents: (B^{I}) a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above; (B^{II}) glyceryl caprylate; (B^{III}) 4-hydroxyacetophenone; (B^{IV}) ethyl hexyl glycerin; or (B^{V}) tropolone; or
pectate lyases plus one or more of the following enzyme stabilizing agents: (B^{I}) a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above; (B^{II}) glyceryl caprylate; (B^{III}) 4-hydroxyacetophenone; (B^{IV}) ethyl hexyl glycerin; or (B^{V}) tropolone.

In a more preferred variant, the enzyme composition according to the present invention comprises one of the following combinations of components (A) and (B):
proteases plus glyceryl caprylate;
proteases plus 4-hydroxyacetophenone;
proteases plus ethyl hexyl glycerin;
proteases plus tropolone;
proteases plus a mixture comprising 1,2-hexanediol and 1,2-octanediol;
proteases plus a mixture comprising 1,2-hexanediol and 1,2-octanediol and tropolone;
proteases plus a mixture comprising 4-hydroxyacetophenone and 1,2-octanediol;
amylases plus glyceryl caprylate;
amylases plus 4-hydroxyacetophenone;
amylases plus ethyl hexyl glycerin;
amylases plus tropolone;
amylases plus a mixture comprising 1,2-hexanediol and 1,2-octanediol;
amylases plus a mixture comprising 1,2-hexanediol and 1,2-octanediol and tropolone;
amylases plus a mixture comprising 4-hydroxyacetophenone and 1,2-octanediol;
lipases plus glyceryl caprylate;
lipases plus 4-hydroxyacetophenone;
lipases plus ethyl hexyl glycerin;
lipases plus tropolone;
lipases plus a mixture comprising 1,2-hexanediol and 1,2-octanediol;
lipases plus a mixture comprising 1,2-hexanediol and 1,2-octanediol and tropolone;
lipases plus a mixture comprising 4-hydroxyacetophenone and 1,2-octanediol;
mannanases plus glyceryl caprylate;
mannanases plus 4-hydroxyacetophenone;
mannanases plus ethyl hexyl glycerin;
mannanases plus tropolone;
mannanases plus a mixture comprising 1,2-hexanediol and 1,2-octanediol;
mannanases plus a mixture comprising 1,2-hexanediol and 1,2-octanediol and tropolone;
mannanases plus a mixture comprising 4-hydroxyacetophenone and 1,2-octanediol;
pectate lyases plus glyceryl caprylate;
pectate lyases plus 4-hydroxyacetophenone;
pectate lyases plus ethyl hexyl glycerin;
pectate lyases plus tropolone;
pectate lyases plus a mixture comprising 1,2-hexanediol and 1,2-octanediol;
pectate lyases plus a mixture comprising 1,2-hexanediol and 1,2-octanediol and tropolone; or
pectate lyases plus a mixture comprising 4-hydroxyacetophenone and 1,2-octanediol.

It was found that the above-specified combinations of enzyme (A) and enzyme stabilizing agent (B) result in superior enzyme stability in an enzyme composition/formulation, in particular during storage.

With respect to the further enzyme stabilizer (C) and preferred variants thereof, reference is made to the above description of the further enzyme stabilizer in connection with the detergents and cleaning composition according to the present invention, which is equally valid in connection with the enzyme composition, in order to avoid repetition.

In a preferred variant, the enzyme stabilizing agent (C) is selected from the group consisting of polyols such as glycol, such as monopropylene glycol, glycerine, mannitol, isomaltol, sorbitol, xylitol, threitol, erythritol, arabitol; amino alcohols such as mono-, di-, triethanolamine and -propanolamine; aliphatic carboxylic acids up to C12, such as succinic acid and salts thereof; dicarboxylic acids and salts thereof; end-capped fatty acid amide alkoxylates; salts, preferably calcium and magnesium salts, such as calcium chloride, calcium formate, magnesium chloride, magnesium formate; reversible enzyme inhibitors such as borate-containing compositions, such as 4-FBPA, boron-free inhibitors, such as disubstituted alaninamide, sodium formate; and any mixture thereof.

The present invention shall now be described in detail with reference to the following examples, which are merely illustrative of the present invention, such that the content of the present invention is not limited by or to the following examples.

### EXAMPLES

### Example 1

The following tests are performed to show the stabilizing influence of different enzyme stabilizers according to the present invention on the stability of different enzymes and, thus, cleaning performance of the detergent and cleaning composition according to the present invention.

The detergent and cleaning composition is a laundry detergent, a hand dishwashing detergent and an auto dishwashing detergent.

For this purpose, the detergent and cleaning composition sample according to the present invention, comprising an enzyme or an enzyme mixture and an enzyme stabilizing agent, is stored for 2 weeks, 4 weeks, 6 weeks and 12 weeks.

The enzyme in the detergent and cleaning composition is selected from protease, amylase, lipase, or cellulase for different sensitivities (protease sensitivity, amylase sensitivity, etc.).

The storage of each sample is also conducted at different storage temperatures, namely 4 °C, 20 °C and 35 °C.

In parallel, the same comparative tests under the same conditions are carried out for a detergent and cleaning composition with the same enzyme or enzyme mixture but without the enzyme stabilizing agent.

The cleaning performance of the tested detergent and cleaning composition according to the present invention and the comparative detergent cleaning composition is tested before storage and after storage for 2 weeks, 4 weeks, 6 weeks and 12 weeks as described below.

### Example 1.1: Laundry Detergent

The cleaning performance for the laundry detergent is analysed according to the standard A.I.S.E. (International Association for Soaps, Detergents and Maintenance Products) Laundry Detergent Testing Guidelines.

The cleaning performance test consists of assessing the stain removal efficiency of the tested laundry detergents on 14 stains.
Test conditions: Washing machine, Miele European Household front loader
Water hardness: 2.5 mmol/I
Water temperature: 40 °C
Wash cycle: 6 cycles (Heavy-duty detergent: cotton cycle; light-duty detergent: delicate cycle)
Ballast load: 3 kg, clean white ballast load
Ballast soil: 4 SBL 2004 sheets (100% cotton, approx. 8 g soil/swatch)
Dosage: recommended dosage for normal soil/medium hardness
Drying: in line during one night
Stain sets: Tea, chocolate, coffee, grass, red wine, grass/mud, fruit juice, blood, tomato puree, unused motor oil, salad dressing balsamic, cooked beef fat, French squeezy mustard, and make-up.

The measurements/evaluation are taken on each stain before wash (to verify quality of stains) and after the wash.

The evaluation of the degree of stain removal can either be assessed by
(B) a sensory panel (scale 1 to 10: scale 1: no cleaning; scale 10: complete removal)
(C) spectrophotometer, or digital image analysis system to determine the Stains Removal Index (SRI) whiteness degree W

The results are statistically treated using Tukey's HSD test (HSD=honestly significant difference) with 95% confidence level. The HSD value highlights the significant differences between each pair of products.

### Example 1.2: Hand Dishwashing Detergent

The cleaning performance for the hand dishwashing detergent is analysed according to the IKW Recommendation for the Quality Assessment of the Cleaning Performance of Hand Dishwashing Detergents.

The test consists of measuring the efficiency of the hand dishwashing detergent through the stability of its foam while cleaning plates coated with a representative mixed soil containing liquids, proteins and carbohydrates (suds mileage test; foam duration).
Test Conditions:
Water hardness: 16±2° d
Water temperature: 45±1 °C
Test soil: (1) low fat soil: composition as specified in the IKW Recommendation; and
   (2) normal soil: composition as specified in the IKW Recommendation
The soil is coated onto the centre of the plate by means of an automatic dispenser.
Dishwashing process: as described in the IKW Recommendation

End point identification: When the foam layer has broken up permanently on the surface of the dishwashing soak, the dishwashing soak is deemed to be exhausted and the end point has reached. The number of washed plates per washing test is recorded in the test protocol.

For each type of soil, five washing tests are to be conducted for each test product.

The products are compared on the basis of the number of washed-up plates until foam collapse. Turkey's HSD statistic test with 95% Confidence Level is performed.

### Example 1.3: Machine Dishwashing Detergent

The cleaning performance for the machine dishwashing detergent is analysed according to the IKW Recommendations for the Quality Assessment of the Cleaning Performance of Dishwasher Detergents.

The cleaning performance test consists of assessing the stain removal efficiency of the tested laundry detergents on 14 stains.
Test conditions: Washing machine, Miele dishwasher GSL or Miele GSL 2
Water hardness: for classic products: 1.8 mmol/1 for multifunctional products: 3.5 mmol/1
Water temperature: in main wash cycle: 45 °C
Wash cycle: at least 3 cycles
Dosage: recommended dosage for normal soil/medium hardness
Stain sets: Black tea (bleachable), milk, milk skin (persistent/alkaline-sensitive), starch mix, pasta (starch-containing, amylase sensitive), egg yolk, crème brûlée, minced meat (protein-containing, protease sensitive)
Number of soiled items: 6 of each type

The measurements/evaluation are taken on each stain as described in the IKW Recommendation either by visual evaluation with reference to a photographic catalogue or gravimetric.

The obtained results are statistically treated using Tukey's HSD test (HSD=honestly significant difference) with 95% confidence level. The HSD value highlights the significant differences between each pair of products.

As can be seen from the above tests, the detergents and cleaning compositions according to the present invention show a superior cleaning performance even after storage of 12 weeks, compared to a cleaning performance without an inventive enzyme stabilizing agent. This means conversely, that the enzyme in the detergent and cleaning composition is stabilized by the addition of the inventive enzyme stabilizing agent during storage, whereas in the detergent and cleaning composition without the addition of an enzyme stabilizing agent the enzyme performance decreases over the time.

### Example 2: Evaluation of Enzyme Stability of Enzyme Detergent and Laundry Compositions According to the Present Invention in Terms of Stain Removal Performance

The following tests were performed to show the stabilizing influence of different enzyme stabilizers on the stability of different enzymes in a detergent and cleaning composition before and after a storage time of 1 months at 40 °C in terms of stain removal performance.

For evaluating the laundry stain removal performance, a laundry detergent composition was tested in combination with different enzyme stabilizing agents. The laundry detergent composition was blended with different enzyme stabilizing agents as specified in the following tables and evaluated in accordance with the following described spectro colorimeter measurement in comparison to the laundry detergent composition without the addition of an enzyme stabilizing agent (placebo).

The stain removal efficacy was tested according to the following test protocol:

Principle: The test consists of assessing the stain removal efficiency of the tested detergents on 12 stains. Fabric stains are artificially applied to specified fabric types and allowed to set for the prescribed amount of time. The size of each sample of stain allows for a reproducible reading (50 mm diameter). These stain swatches are washed/soaked with the tested detergents being compared and the relative degree of removal of the stains is evaluated. The test allows for comparing products' stain removal ability under the same condition.

Stains selection: In order to test the effectiveness of the tested detergents, ready-to-use standardized multi-sample and multi-spot monitors were used (selected and manufactured by Warwick Equest and CFT).

### Description of Stains:

C-S-44 Chocolate drink, pure, on cotton,
C-S-07 Grass, pure, on cotton,
PC-05 Blood, Milk, Ink (BMI), on Polyester/cotton,
WE5DASB Double application sheep blood, on knitted cotton,
C-S-68 Chocolate ice cream, aged, on cotton,
E-165 Chocolate pudding, on cotton,
E-161 Starch, on cotton,
C-S-27 Potato starch, coloured, on cotton,
C-S-62 Lard, coloured with Sudan red, on cotton,
C-H126 Vegetable oil, coloured with violet dye, on cotton,
C-H141 Pectin without sugar, on cotton,
C-H147 Jam, forest fruit, on cotton.

The stains are manufactured in a reproducible manner and of consistent quality. The stains are a mix of “natural stains” and “standardized stains”. The stains are homogeneously distributed and coloured before and after washing. Accordingly, 12 different stain formulas can be tested at the same time in one test process. Certain stains are particularly sensitive for the enzymes specified in the following table.

| Stain type | Stain name | Sample ID |
|---|---|---|
| Protease | Chocolate | C-S-44 |
| | Grass | C-S-07 |
| | Blood, Milk, Carbon | E-117 (PC05) |
| | Blood | WE5DASB |
| Mannanase | Chocolate Icecream | C-S-68 |
| | Chocolate pudding | E-165 |
| Amylase | Starch | E161 |
| | Potato Starch | C-S-27 |
| Lipase | Lard with colorant | C-S-62 |
| | Vegetable oil | C-H126 |
| Pectinase | Forrest fruit jam | C-H147 |
| | Pectin with carbon black | C-H141 |

Test conditions: Each test sample group of 12 stains is soaked in a metal washpot containing 833.3 g of the tested laundry detergent solution at a temperature of 40 °C for 30 min.

The 833.3 g of the laundry detergent solution is composed by a dilution as: 3 g of liquid laundry with a hardness of 15° Hf.

The test solutions are stirred using a Rotawash M228B/C.

After the end of the test cycle, the stains are taken out from the washpot and then positioned horizontally for dry.

Measurements/evaluation: Averaged reflectance measurements of the fabric are taken using the Spectro colorimeter Ci62 before the tissue is stained, after it is stained, and again after being treated with the tested laundry detergent and washed. Three measurements are carried out per stain. The performance of the product is evaluated instrumentally in terms of a Stain Removal Index (SRI). The SRI is a scale from 0 to 100, with 0 meaning no stain removal, and 100 meaning complete stain removal.
As describe in ASTM D4265, the SRI is calculated according to the following formula:

$$SRI = \frac{100 \times Δ E * ( U S - U F ) - Δ E * ( W S - U F )}{Δ E * ( U S - U F )}$$

where:
US=unwashed stain area
UF=unwashed (unstained) fabric area
ΔE*(US−UF)=Delta-E colour difference between the unwashed stain and the unwashed fabric
ΔE*(WS−UF)=Delta-E colour difference between the washed stain and the unwashed fabric.
The value ΔE (absolute colour difference) is calculated as:

ΔE*=\sqrt{ΔL*²+Δa*²+Δb*²}
where:
L=reflectance
a=redness/greenness
b=yellowness/blueness
The tested laundry detergent compositions are compared to each other as follows: the higher the SRI is, the better is the laundry performance, i.e. stain removal performance.

For testing the stabilizing efficacy of different enzyme stabilizing agents, an enzyme containing laundry detergent formulation was used with the following composition:

| Ingredients | % by weight |
|---|---|
| Water | 58.15 |
| caustic soda | 0.10 |
| caustic soda (30%) | 1.00 |
| MPG or glycerin | 1.00 |
| MIT/BIT | 0.07 |
| Phenoxyethanol | 0.10 |
| SOKALAN CP 5 Acrylic Copolymer (40%) | 0.38 |
| Na lauryl ether sulfate (28%) | 15.00 |
| SDBS (55%) | 10.73 |
| cocoate potassium (38%) NANSA PC38/F | 5.53 |
| Alcohol, C12-14, ethoxylated 7OE | 3.30 |
| DEA coprah empilan 2502 | 2.50 |
| HEDP | 1.00 |
| DSBP Tinopal ® CBS-X | 0.15 |
| Medley pure 300L *) | 1.00 |

*) Medley pure 300L is a blend of protease, amylase, pectate lyase, mannanase and lipase enzymes.

To said laundry detergent formulation, different enzyme stabilizing agents according to the present invention were added and the stain removal performance was evaluated according to the test method described above and as specified in the following tables.

The stain removal performance for each test sample was measured before storage (t=0) and after a period of storage for 1 month (t=1 month). The tested samples were stored at a temperature of 40 °C in an oven (dark).

For the evaluation of the enzyme stabilizing effect: the lower the delta SRI between the SRI (t=0) and SRI (t=1 month) the better the enzyme stabilizing effect of the tested enzyme stabilizing agent.

In the following tables, the following abbreviations are used:
C5=1,2-pentanediol
C6=1,2-hexanediol
C7=1,2-heptanediol
C8=1,2-octanediol
C10=1,2-decanediol
4HAP=4-hydroxyacetophenone

### 2.1 Stain Removal Performance of Different 1,2-Alkanediols on Amylase Sensitive Stains

TABLE 1

| | | SRI sum | SRI sum | Delta SRI |
|---|---|---|---|---|
| | Enzyme | on amylase | on amylase | sum on |
| | stabilizing | sensitive | sensitive | amylase |
| Laundry | agent | stains | stains | sensitive |
| No. | (% by weight) | (t = 0) | (t = 40 d) | stains |
| L8 | C10 1.0 | 141.19 | 116.43 | −24.76 |
| L22 | C7 0.5 | 137.00 | 123.30 | −13.70 |
| L4 | C5 0.5 | 126.64 | 92.37 | −34.28 |
| L20 | C6 1.0 | 125.36 | 105.68 | −19.68 |
| L19 | C6 0.5 | 118.92 | 117.65 | −1.27 |
| L2_2 | Enzyme (without | 124.65 | 82.88 | −41.76 |
| | enzyme | | | |
| | stabilizing | | | |
| | agent) | | | |

As can be seen from Table 1, the addition of a 1,2-alkanediol to a detergent and laundry composition results in an improved enzyme stability on amylase sensitive stains compared to a detergent and laundry composition without the enzyme stabilizing agent. Surprisingly, the addition of 1,2-hexanediol, 1,2-heptanediol, and 1,2-decanediol result in a better stabilizing effect compared to 1,2-pentanediol. Hence, by adding 1,2-hexanediol, 1,2-heptanediol or 1,2-decanediol to a detergent or laundry formulation, the stability of an enzyme containing detergent and cleaning composition can considerably be improved. The best enzyme stabilizing effect in terms of stain removal efficacy shows 1l2-hexanediol on amylase sensitive stain.

### 2.2 Stain Removal Performance of Different 1,2-Alkanediols on Lipase Sensitive Stains

TABLE 2

| | | SRI sum | SRI sum | |
|---|---|---|---|---|
| | Enzyme | on lipase | on lipase | Delta SRI sum |
| | stabilizing | sensitive | sensitive | on lipase |
| Laundry | agent | stains | stains | sensitive |
| No. | (% by weight) | (t = 0) | (t = 40 d) | stains |
| L35 | C8 1.0 | 113.90 | 101.23 | −12.67 |
| L3 | C5 0.25 | 109.29 | 84.71 | −24.59 |
| L19 | C6 0.5 | 104.56 | 89.27 | −15.29 |
| L21 | C7 0.25 | 96.97 | 90.55 | −6.42 |
| L2_2 | Enzyme (without | 111.11 | 84.74 | −26.37 |
| | enzyme | | | |
| | stabilizing agent) | | | |

As can be seen from Table 2, the addition of a 1,2-alkanediol to a detergent and laundry composition results in an improved enzyme stability on protease sensitive stains compared to a detergent and laundry composition without the enzyme stabilizing agent. Surprisingly, the addition of 1,2-hexanediol, 1,2-heptanediol, and 1,2-octanediol result in a better stabilizing effect compared to 1,2-pentanediol. Hence, by adding 1,2-hexanediol, 1,2-heptanediol or 1,2-octanediol to a detergent or laundry formulation, the stability of an enzyme containing detergent and cleaning composition can considerably be improved.

### 2.3 Stain Removal Performance of Mixtures of 4-HAP and a 1,2-Alkanediol on Lipase Sensitive Stains

TABLE 3

| | | SRI sum | SRI sum | Delta SRI |
|---|---|---|---|---|
| | | on lipase | on lipase | sum on |
| | | sensitive | sensitive | lipase |
| Laundry | Enzyme stabilizing agent | stains | stains | sensitive |
| No. | (% by weight) | (t = 0) | (t = 40 d) | stains |
| L2_2 | Enzyme (without enzyme | 111.11 | 84.74 | −26.37 |
| | stabilizing agent) | | | |
| L6 | C10 0.25 | 107.78 | 83.16 | −24.62 |
| L20 | C6 1.0 | 106.49 | 87.94 | −18.55 |
| L10 | 4HAP 0.5 | 99.64 | 84.25 | −15.39 |
| L24 | 4HAP 0.25 plus C6 0.25 | 102.29 | 92.18 | −10.11 |
| L32 | 4HAP 0.75 plus C10 0.75 | 118.25 | 108.69 | −9.56 |

As can be gathered from Table 3, the addition of either 4-hydroxyacetophenone alone or a mixture of 4-hydroxyacetophenone and an 1,2-alkanediol to a detergent and cleaning composition result in an enzyme stabilizing effect compared to a detergent and cleaning composition with the addition of any enzyme stabilizing effect.

### 2.4 Stain Removal Performance of 1,2-Alkanediols or Mixtures of 1,2-Alkanediols on Protease Sensitive Stains

TABLE 4

| | | SRI sum | SRI sum | Delta SRI |
|---|---|---|---|---|
| | Enzyme | on protease | on protease | sum on |
| | stabilizing | sensitive | sensitive | protease |
| Laundry | agent (% by | stains | stains | sensitive |
| No. | weight) | (t = 0) | (t = 40 d) | stains |
| L2_2 | Enzyme (without | 150.62 | 114,.91 | −35.72 |
| | enzyme | | | |
| | stabilizing agent) | | | |
| L4 | C5 0.5 | 150.44 | 117.39 | −33.06 |
| L8 | C10 1.0 | 170.95 | 139.54 | −31.41 |
| L22 | C7 0.5 | 172.73 | 142.25 | −30.47 |
| L38 | C5 0.25 plus C7 0.25 | 173.11 | 151.31 | −21.80 |
| L39 | C10 0.25 plus C7 0.25 | 148.70 | 127.79 | −20.91 |

As can be seen from Table 4, the addition of a 1,2-alkanediol to a detergent and laundry composition results in an improved enzyme stability on protease sensitive stains compared to a detergent and laundry composition without the enzyme stabilizing agent. Surprisingly, the addition of 1,2-heptanediol or 1,2-decanediol result in a better stabilizing effect compared to 1,2-pentanediol. Hence, by adding 1,2-heptanediol or 1,2-decanediol to a detergent or laundry formulation, the stability of an enzyme containing detergent and cleaning composition can considerably be improved.

Surprisingly, a mixture of two different 1,2-alkanediol such as a mixture of 1,2-pentanediol and 1,2-heptanediol or a mixture of 1,2-decanediol and 1,2-heptanediol has a synergistic enzyme stabilizing effect compared to the use of the single 1,2-alkanediols.

### 2.5 Stain Removal Performance of a Mixture of 4-HAP and a 1,2-Alkanediol on Protease Sensitive Stains

TABLE 5

| | | SRI sum | SRI sum | |
|---|---|---|---|---|
| | | on protease | on protease | Delta SRI sum |
| | | sensitive | sensitive | on protease |
| Laundry | Enzyme stabilizing | stains | stains | sensitive |
| No. | agent (% by weight) | (t = 0) | (t = 40 d) | stains |
| L2_2 | Enzyme (without enzyme | 150.62 | 114.91 | −35.72 |
| | stabilizing agent) | | | |
| L4 | C5 0.5 | 150.44 | 117.39 | −33.06 |
| L8 | C10 1.0 | 170.95 | 139.54 | −31.41 |
| L22 | C7 0.5 | 172.73 | 142.25 | −30.47 |
| L11 | 4HAP 1.0 | 160.29 | 131.67 | −28.62 |
| L29 | 4HAP 0.75 plus C7 0.75 | 156.48 | 133.27 | −23.21 |
| L34 | C8 0.5 | 154.60 | 135.31 | −19.29 |
| L20 | C6 1.0 | 155.40 | 136.45 | −18.95 |
| L32 | 4HAP 0.75 plus C10 0.75 | 166.48 | 150.02 | −16.46 |
| L25 | 4HAP 0.5 plus C6 0.5 | 139.28 | 136.46 | −2.81 |
| L17 | 4HAP 0.75 plus C8 0.75 | 139.13 | 137.17 | −1.96 |

As can be gathered from Table 5, the addition of either 4-hydroxyacetophenon alone or a mixture of 4-hydroxyacetophenon and a 1,2-alkanediol to a detergent and cleaning composition result in an enzyme stabilizing effect compared to a detergent and cleaning composition with the addition of any enzyme stabilizing agent. The enzyme stabilizing effect of a mixture of 4-hydroxyacetophenone and a 1,2-alkanediol is even better, i.e. synergistic, compared to the enzyme stabilizing effect of the use of the single substances.

As can be seen from the above results, the addition of an enzyme stabilizing agent as specified in the present application to an enzyme detergent and cleaning composition either alone or in a mixture of two boosting agents results in a considerable improvement in enzyme stability. The detergents and cleaning compositions show even at a low rate of addition of the enzyme stabilizing agent or a mixture thereof excellent enzyme stability after storage. Due to the minor enzyme deactivation after storage, the detergent and cleaning composition according to the present invention show low to no deterioration in cleaning performance compared to a detergent and cleaning composition without the addition of such an enzyme stabilizing agent.

### Example 3: Analytical Enzyme Stability

The effect of different enzyme stabilizers and their concentrations on enzyme stability are evaluated by an enzyme assay.

Enzyme assays are standardized experimental protocols, which are established in order to measure the activity or concentration of enzymes in biochemical systems. Mostly enzymatic assays are based upon the detection of fluorescent, luminescent, or spectrophotometric endpoint signal.

The enzyme stabilizers according to the present invention and an enzyme as specified herein are tested in a suitable puffer.

Three different enzymes are tested, namely a protease, an amylase, and a lipase.

Enzyme compositions are prepared varying the concentration of the enzyme stabilizers. The amount of enzyme in the buffer system were kept constant.

The samples are analysed for enzyme stability by a suitable enzyme assay. The stability results for each of the enzymes tested are collected.

The formulation samples are then stored at different storage temperatures, namely 4 °C, 20 °C and 35 °C over a period of 2 weeks, 4 weeks, 6 weeks and 12 weeks. Samples of each of the tested formulations were then collected and analysed by enzyme assay.

As can be seen from the results, the tested enzymes retained enzyme performance even after storages of 12 weeks. These results demonstrate that the inventive enzyme stabilizing agents provide retention of enzyme performance.

### Example 4: Formulation Examples

TABLE F1
All-purpose cleaner

| No | Ingredients | Amount (%) |
|---|---|---|
| 1 | Fatty alcohol ethoxylated | 4.4 |
| 2 | Sulfonic acid, C 13-17-sec-Alkyl-, Sodium salt | 3.6 |
| 3 | Methylisothiazolinone | 0.01 |
| 4 | Fragrance | 0.9 |
| 5 | 1,2-heptanediol | 1 |
| 6 | Protease (Subtilisin) | 0.7 |
| 7 | Amylase | 0.4 |
| 8 | Aqua | add to 100 |

TABLE F2
APC alkaline

| No | Ingredients | Amount (%) |
|---|---|---|
| 1 | Coco-Glycoside | 1 |
| 2 | Benzalkonium Chloride | 0.2 |
| 3 | Sodium bicarbonate | 0.1 |
| 4 | Tri-sodium citrate-dihydrate | 0.1 |
| 5 | Methyl glycine diacetic acid | 0.1 |
| 6 | 1,2-Benzisothiazol-3(2H)-on | 0.1 |
| 7 | Fragrance | 0.1 |
| 8 | 1,2-heptanediol | 0.5 |
| 9 | Amylase | 0.3 |
| 10 | Aqua | add to 100 |

TABLE F3
Cleaner, liquid, citric acid

| No | Ingredient | Amount (%) |
|---|---|---|
| 1 | Sulfonic acid, C 13-17-sec-Alkyl-, Sodium salt | 1 |
| 2 | Citric Acid | 5 |
| 3 | Xanthan Gum | 0.5 |
| 4 | 1,2-heptanediol/2,3-heptanediol 90:10 | 0.5 |
| 5 | Fragrance | 0.3 |
| 6 | Protease (Subtilisin) | 0.3 |
| 7 | Aqua | add 100 |

TABLE F4
Detergent liquid light duty

| No | Ingredients | Amount (%) |
|---|---|---|
| 1 | Cocos fatty acid | 0.85 |
| 2 | potassium hydroxide | 0.45 |
| 3 | 2-octyl-2H-isothiazol-3-one | 0.2 |
| 4 | Sulfonic acid, C 13-17-sec-Alkyl-, Sodium salt | 20 |
| 5 | Sodium Laureth Sulfate | 3 |
| 6 | Trideceth-9 | 5 |
| 7 | Sodium Chloride | 1.3 |
| 8 | 2,3-octanediol | 0.1 |
| 9 | 1,2-heptanediol | 0.9 |
| 10 | Fragrance | 0.5 |
| 11 | Protease (Subtilisin) | 0.6 |
| 12 | Amylase | 0.3 |
| 13 | Aqua | add to 100 |

TABLE F5
Dishwash liquid manual

| No | Ingredients | Amount (%) |
|---|---|---|
| 1 | Sodium Laureth Sulfate | add 100 |
| 2 | Ethanol | 2.9 |
| 3 | lauramine oxide | 7.7 |
| 4 | propylene glycol | 1.9 |
| 5 | Phenoxyethanol | 0.1 |
| 6 | Benzisothiazolinone, Methylisothiazolinone, | 0.1 |
| | Laurylamine Dipropylenediamine | |
| 7 | 1,2-heptanediol | 0.5 |
| 8 | sodium chloride | 3.85 |
| 9 | Fragrance | 0.3 |
| 10 | Amylase | 0.4 |

TABLE F6
Fabric softener

| No | Ingredients | Amount (%) |
|---|---|---|
| 1 | Di-(Talg Carboxyethyl) Hydroxyethyl | 5.5 |
| | methylammonium-methosulfate | |
| 2 | Simethicone | 0.3 |
| 3 | 2-octyl-2H-isothiazol-3-one | 0.1 |
| 4 | 1,2-heptanediol | 0.5 |
| 5 | Fragrance | 0.2 |
| 6 | Cellulase | 0.3 |
| 7 | Aqua | add 100 |

TABLE F7
Hand soap, liquid

| No | Ingredients | Amount (%) |
|---|---|---|
| 1 | Sodium Laureth Sulfate | 18 |
| 2 | Cocoamidopropylbetaine | 6 |
| 3 | Cocamide DEA | 3 |
| 4 | citric acid | 0.5 |
| 5 | sodium chloride | 1.9 |
| 6 | Glycerol | 2 |
| 7 | Fragrance | 0.2 |
| 8 | 1,2-heptanediol | 0.25 |
| 9 | Amylase | 0.2 |
| 10 | Aqua | add 100 |

TABLE F8
Rim block gel

| No | Ingredients | Amount (%) |
|---|---|---|
| 1 | Sodium Laureth Sulfate | 11 |
| 2 | Trideceth-9 | 2 |
| 3 | Xanthan gum | 2 |
| 4 | Hydroxyethylcellulose | 0.5 |
| 5 | Citric Acid | 0.4 |
| 6 | Ethanol | 6 |
| 7 | Fragrance | 5 |
| 8 | 1,2-heptanediol | 0.5 |
| 9 | Protease (Subtilisin) | 0.5 |
| 10 | Aqua | add 100 |

TABLE F9
ADW (Auto Dish Washing) gel

| No. | Raw material | Amount (%) |
|---|---|---|
| 1 | Water | add 100 |
| 2 | Glutamic acid, N,N-diacetic acid, tetrasodium salt | 17 |
| 3 | Glycerin | 15 |
| 4 | Citric acid | 3 |
| 5 | Acrylic copolymer | 2 |
| 6 | Fatty alcohol alkoxylated | 1 |
| 7 | Sodium cumene sulfonate | 1 |
| 8 | Xanthan Gum | 0.5 |
| 9 | 1,2-heptanediol | 1.2 |
| 10 | Protease (Subtilisin) | 1.5 |
| 11 | Amylase | 0.5 |

1. A detergent and cleaning composition, comprising
(a) at least one enzyme;
(b) at least one enzyme stabilizing agent selected from the group consisting of
(b^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol;
(b^{II}) glyceryl caprylate;
(b^{III}) 4-hydroxyacetophenone;
(b^{IV}) ethyl hexyl glycerin;
(b^{V}) tropolone; and
any mixture thereof;
(c) more than 3% by weight of a surfactant, based on the total weight of the composition; and
(d) at least one further enzyme stabilizer which is different from the enzyme stabilizing agent (b).

2. The detergent and cleaning composition according to claim 1, wherein the at least one enzyme is selected from the group consisting of proteases, amylases, lipases, cellulases, cutinases, gluconases, peroxidases, pectinases, mannanases, esterases, hemicellulases, xylanases, phospholipases, pectate lyases, keratinases, reductases, nucleases, phenoloxidases, lipoxygenases, ligninases, pullulanases, tannases, pentosanases, malanases, ß-glucanases, arabinosidases, hyaluronidases, chondroitinases, oxidoreductases, and any mixture thereof.

3. The detergent and cleaning composition according to claim 1, wherein the at least one linear alkanediol or the first linear alkanediol is selected from the group consisting of 1,2-pentanediol, 2,3-pentanediol, 1,2-hexanediol, 2,3-hexanediol, 1,2-heptanediol, 2,3-heptanediol, 1,2-octanediol, 2,3-octanediol, 1,2-nonanediol, 2,3-nonanediol, 1,2-decanediol, 2,3-decanediol, 1,2-undecanediol, 2,3-undecanediol, 1,2-dodecanediol, 2,3-dodecanediol, 1,2-tridecanediol, 2,3-tridecanediol, 1,2-tetradecanediol, 2,3-tetradecanediol, and any mixture thereof; and/or
the second linear alkanediol is selected from the group consisting of 1,2-pentanediol, 2,3-pentanediol, 1,2-hexanediol, 2,3-hexanediol, 1,2-heptanediol, 2,3-heptanediol, 1,2-octanediol, 2,3-octanediol, 1,2-nonanediol, 2,3-nonanediol, 1,2-decanediol, 2,3-decanediol, 1,2-undecanediol, 2,3-undecanediol, 1,2-dodecanediol, 2,3-dodecanediol, 1,2-tridecanediol, 2,3-tridecanediol, 1,2-tetradecanediol, 2,3-tetradecanediol, and any mixture thereof.

4. The detergent and cleaning composition according to claim 3, wherein the at least one linear alkanediol is selected from the group consisting of 1,2-pentanediol, 1,2-hexanediol, 1,2-heptanediol, 1,2-octanediol, 1,2-nonanediol, 1,2-decanediol, 1,2-undecanediol, 1,2-dodecanediol, 1,2-tridecanediol, 1,2-tetradecanediol, and any mixture thereof;
or
wherein the linear alkanediol is selected from the group consisting of 2,3-pentanediol, 2,3-hexanediol, 2,3-heptanediol, 2,3-octanediol, 2,3-nonanediol, 2,3-decanediol, 2,-3-undecanediol, 2,3-dodecanediol, 2,3-tridecanediol, 2,3-tetradecanediol and any mixture thereof;
or
wherein the mixture comprising at least one first linear alkanediol and one or more second linear alkanediol is selected from the group consisting of
a mixture comprising 1,2-pentanediol and 2,3-pentanediol;
a mixture comprising 1,2-hexanediol and 2,3-hexanediol;
a mixture comprising 1,2-heptanediol and 2,3-heptanediol;
a mixture comprising 1,2-octanediol and 2,3-octanediol;
a mixture comprising 1,2-nonanediol and 2,3-nonanediol;
a mixture comprising 1,2-decanediol and 2,3-decanediol;
a mixture comprising 1,2-undecanediol and 2,3-undecanediol;
a mixture comprising 1,2-dodecanediol and 2,3-dodecanediol;
a mixture comprising 1,2-tridecanediol and 2,3-tridecanediol;
a mixture comprising 1,2-tetradecanediol and 2,3-tetradecanediol;
a mixture comprising 1,2-hexanediol and 1,2-octanediol;
a mixture comprising 1,2-hexanediol and 2,3-octanediol;
a mixture comprising 1,2-octanediol and 2,3-hexanediol;
a mixture comprising 1,2-octanediol and 2,3-heptanediol;
a mixture comprising 1,2-pentanediol and 2,3-hexanediol;
a mixture comprising 1,2-pentanediol and 2,3-heptanediol;
a mixture comprising 1,2-pentanediol and 2,3-octanediol;
a mixture comprising 1,2-pentanediol and 1,2-nonanediol;
a mixture comprising 1,2-pentanediol and 2,3-nonanediol
a mixture comprising 1,2-heptanediol and 1,2-pentanediol;
a mixture comprising 1,2-heptanediol and 1,2-hexanediol;
a mixture comprising 1,2-heptanediol and 1,2-octanediol;
a mixture comprising 1,2-heptanediol and 2,3-octanediol;
a mixture comprising 1,2-heptanediol and 1,2-nonanediol;
a mixture comprising 1,2-heptanediol and 2,3-nonanediol;
a mixture comprising 1,2-heptanediol and 1,2-decanediol;
a mixture comprising 1,2-heptanediol and 1,2-undecanediol;
a mixture comprising 1,2-heptanediol and 1,2-dodecanediol; and
a mixture comprising 1,2-heptanediol and 1,2-tridecanediol.

5. The detergent and cleaning composition according to claim 1 wherein the mixture comprising at least one first linear alkanediol and one or more second linear alkanediol comprises the first linear alkanediol and the second alkanediol in a ratio in a range of 50:50 to 99.9:0.1.

6. The detergent and cleaning composition according to claim 1, wherein the at least one surfactant is selected from the group consisting of anionic surfactants, cationic surfactants, nonionic surfactants, amphoteric/zwitterionic surfactants, and any mixture thereof.

7. The detergent and cleaning composition according to claim 1, wherein the at least one further enzyme stabilizer is selected from the group consisting of polyols such as glycol, such as monopropylene glycol, glycerine, mannitol, isomaltol, sorbitol, xylitol, threitol, erythritol, arabitol; amino alcohols such as mono-, di-, triethanolamine and -propanolamine; aliphatic carboxylic acids up to C12, such as succinic acid and salts thereof; dicarboxylic acids and salts thereof; end-capped fatty acid amide alkoxylates; salts, preferably calcium and magnesium salts, such as calcium chloride, calcium formate, magnesium chloride, magnesium formate; reversible enzyme inhibitors such as borate-containing compositions, such as 4-FBPA, boron-free inhibitors, such as disubstituted alaninamide, sodium formate; and any mixture thereof; preferably wherein the at least further enzyme stabilizer is calcium chloride or sodium formate.

8. The detergent and cleaning composition according to claim 1, further comprising active substances and/or additives selected from the group consisting of solvents, builders, bleaching agents, soil release agents, dispersing agents, foam inhibitors, sequestrant agents, chelating agents, anti-redeposition agents, dye transfer inhibition/colour protection agents, dye scavengers, dyes, greying inhibitors, optical brighteners, ultraviolet light absorbers, thickeners or rheology modifiers, hydrotropes, solubility modifiers, pH-adjusting agents, buffers, solvents, anti-static agents, anti-wrinkling agents, antimicrobial agents, odor removal/odor capturing agents, ultraviolet light protection agents, fragrances, sanitizing agents, disinfecting agents, water repellency agents, insect repellency agents, anti-pilling agents, souring agents, mildew removing agents, allergicide agents, and any mixture thereof.

9. The detergent and cleaning composition according to claim 8, wherein the chelating agent is selected from the group consisting of ethylene-diamine-tetra-acetic acid (EDTA), diethylene triamine pentamethylene phosphonic acid (DTMPA, DTPMP), hydroxy-ethane diphosphonic acid (HEDP), ethylenediamine N,N-disuccinic acid (EDDS), methyl glycine di-acetic acid (MGDA), diethylene triamine penta acetic acid (DTPA), propylene diamine tetraacetic acid (PDTA), 2-hydroxypyridine-N-oxide (HPNO), methyl glycine diacetic acid (MGDA), glutamic acid N,N-diacetic acid (N,N-dicarboxymethyl glutamic acid tetrasodium salt (GLDA), nitrilotriacetic acid (NTA), citrate, and mixtures thereof; and/or
the antimicrobial agent is selected from the group consisting of benzyl alcohol, methylbenzyl alcohol, phenoxyethanol, and any mixture thereof.

10. The detergent and cleaning composition according to claim 1, comprising the enzyme in an amount of 0.0001 to 5% by weight, based on the total weight of the composition; and/or
comprising the at least one enzyme stability boosting agent (b) in an amount of 0.001 to 15.0% by weight, based on the total weight of the composition; and/or
comprising the at least one surfactant in an amount of 4 to 90% by weight, based on the total weight of the composition; and/or
comprising the at least one further enzyme stabilizer in an amount of 0.0001 to 5% by weight, based on the total weight of the composition.

11. A method of preparing a detergent and cleaning product comprising formulating the product with the detergent and cleaning composition of claim 1.

12. A detergent and cleaning product comprising the detergent and cleaning composition according to claim 1, wherein the detergent and cleaning composition or product is a heavy-duty detergent, colour-care detergent, light duty detergent, all-purpose washing agent, fabric softener, fabric laundry scent, scent lotion, laundry wipe, stain and/or soil remover (pre-spotter, Vanish type), degreasing cleaner, washing machine cleaner, homecare products, all-purpose cleaner, hand dishwashing detergent, auto dishwashing detergent, hard surface cleaner, glass and mirror cleaner, wet cleaning wipe, kitchen cleaner, cleaner for cooking appliances, oven cleaner, floor cleaner, wood floor cleaner, carpet cleaner, bathroom and shower cleaner, toilet cleaner, grout cleaner, disinfectant, drain unblocker, toilet rim block gel, air fresheners, furniture polish, car shampoo; medical cleaning products,
wherein the product is in liquid, solid, gelled, bar, paste, spray, tablet, encapsulated, diluted or concentrated form and optionally in two-compartment or multi-compartment form;
and the product is for household, medical, institutional, or industrial applications.

13. (canceled)

14. A method of stabilizing an enzyme in a detergent and cleaning composition, comprising the steps of
(i) providing a detergent and cleaning composition comprising an enzyme; and
(ii) adding thereto an effective amount of 1,2-heptanediol or 2,3-heptanediol or a mixture comprising 1,2-heptanediol and 2,3-heptanediol or at least one enzyme stabilizing agent (b) selected from the group consisting of
(b^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol;
(b^{II}) glyceryl caprylate;
(b^{III}) 4-hydroxyacetophenone;
(b^{IV}) ethyl hexyl glycerin;
(b^{V}) tropolone; and
any mixture thereof.

15. An enzyme composition, comprising or consisting of
(A) at least one enzyme;
(B) at least one enzyme stabilizing agent selected from the group consisting of
(B^{I}) a mixture comprising at least one first linear alkanediol having a carbon chain of 5 to 14 carbon atoms and one or more second linear alkanediol having a carbon chain of 5 to 14 carbon atoms which is different from the first linear alkanediol;
(B^{II}) glyceryl caprylate;
(B^{III}) 4-hydroxyacetophenone;
(B^{IV}) ethyl hexyl glycerin;
(B^{V}) tropolone; and
any mixture thereof; and
(C) at least one further enzyme stabilizer which is different from the enzyme stabilizing agent (B).

16. The detergent and cleaning composition of claim 2 wherein the nucleases are DNases and/or RNases.

17. The detergent and cleaning composition according to claim 5, wherein the mixture comprising at least one first linear alkanediol and one or more second linear alkanediol comprises the first linear alkanediol and the second alkanediol in a ratio in a range of 90:10 to 95:5.

18. The detergent and cleaning composition according to claim 6, wherein
the anionic surfactant is selected from the group consisting of
C10 to C18 alkyl benzene sulfonates;
C10 to C18 alkyl sulfates;
C10 to C18 alkyl sulfates, ethoxylated with 1 to 3 moles ethylene oxide;
C10 to C18 alpha-olefin sulfonates;
C8 to C18 alkyl carboxylates, ethoxylated with 1 to 10 moles ethylene oxide;
and any mixture thereof;
the cationic surfactant is selected from the group consisting of
quaternary C8 to C18 alkyl ethanolamines;
quaternary C8 to C18 alkyl ammonium compounds;
C8 to C18 alkyl ammonium methosulfates;
and any mixture thereof;
the non-ionic surfactant is selected from the group consisting of
C6 to C18 fatty alcohols, ethoxylated with 1 to 12 moles ethylene oxide;
alkoxylated C6 to C18 fatty alcohols such as
C6 to C18 fatty alcohols, ethoxylated with 1 to 25 moles ethylene oxide,
C6 to C18 fatty alcohols, propoxylated with 1 to 15 moles propylene oxide,
C6 to C18 fatty alcohols, butoxylated with 1 to 10 moles butylene oxide,
and combinations thereof;
C6 to C18 sophorolipids;
C6 to C18 rhamnolipids;
C5 to C18 alkyl polyglycosides;
C6 to C18 alkanolamides;
C6 to C18 fatty acid ester alkoxylates;
and any mixture thereof; and
the amphoteric/zwitterionic surfactant is selected from the group consisting of
C10 to C18 N-(alkyl)-N,N-dimethylamine oxide;
C10 to C18 N-(alkyl)-N,N-bis(2-hydroxyethyl)amine oxide;
C10 to C18 alkyl amido propyl dimethyl amine oxide;
C10 to C18 alkylbetaines;
C10 to C18 alkylamidobetaines;
C10 to C18 sulfobetaines;
and any mixture thereof;
and any mixture of the above specified cationic, anionic, non-ionic and amphoteric/zwitterionic surfactants.

19. The detergent and cleaning composition according to claim 9, wherein the chelating agent is hydroxy-ethane diphosphonic acid (HEDP).

20. The detergent and cleaning composition according to claim 10, comprising the enzyme in an amount of 0.05 to 2% by weight, based on the total weight of the composition; and/or
comprising the at least one enzyme stability boosting agent (b) in an amount of 0.5 to 1.0% by weight, based on the total weight of the composition; and/or
comprising the at least one surfactant in an amount of 30% by weight to 40% by weight, based on the total weight of the composition; and/or
comprising the at least one further enzyme stabilizer in an amount of 0.01 to 3% by weight, based on the total weight of the composition.

21. The method of preparing a detergent and cleaning product according to claim 11, wherein the detergent and cleaning product is formulated for use in textile cleaning, laundry, fabric care, dishwashing, household, institutional and industrial hard surface cleaning, and cleaning medical and dental instruments.
